(19) United States
(12) Patent Application Publication
(10) Pub. No.: US 2014/0039871 A1
(43) Pub. Date: Feb. 6, 2014

(54) Synchronous Texts

(71) Applicant: Richard Henry Dana Crawford, Denver, CO (US)

(72) Inventor: Richard Henry Dana Crawford, Denver, CO (US)

(21) Appl. No.: 13/565,791

(22) Filed: Aug. 2, 2012

(51) Int. Cl. G06F 17/28

(52) U.S. Cl. CPC G06F 17/28
USPC 704/2

(57) ABSTRACT

A method and apparatus to synchronize segments of text with timed vocalizations. Plain text captions present syllabic timings visually while their vocalization is heard. Captions in standard formats are optionally used. Synchronous playback speeds are controlled. Syllabic segments are aligned with timing points in a custom format. Verified constant timings are variably assembled into component segments. Outputs include styled custom caption and HTML presentations. Related texts are aligned with segments and controlled in plain text row sets. Translations, synonyms, structures, pictures and other context rows are aligned. Pictures in sets are aligned and linked in tiered sorting carousels. Alignment of row set contents is constant with variable display width wraps. Sorting enables users to rank aligned contexts where segments are used. Personalized contexts are compared with group sorted links. Variable means to express constant messages are compared. Vocal language is heard in sound, seen in pictures and animated text. The methods are used to learn language.

### CROSS-REFERENCE TO RELATED PATENT APPLICATION

This application relates to U.S. Provisional Patent Application No. 61/574,464 filed on Aug. 2, 2011, entitled SYNCHRONOUS SEGMENT ALIGNMENT, which is hereby incorporated herein in its entirety by this reference.

### FIELD OF THE INVENTION

The present invention relates to education; particularly relating to tools and techniques to learn language.

### BACKGROUND OF THE INVENTION

Learning a language can be experienced as difficult. Language methods can be difficult to experience. People want to learn language, but are bored with grammar rules and dull studies. Using the Internet, mobile computers and audio visual tools, people can converse about things that interest them. As the conversation grows multilingual, what is needed are methods to make new words used within the conversation more comprehensible.

Written language can be made more comprehensible. Application of previously disclosed methods, including a “Bifocal, bitextual language learning system” and “Aligning chunk translations” can make new words and phrases comprehensible. However, without directly experiencing the sounds of the new language, the new words are not easily learned.

Language is acoustic. As Dr. Paul Sulzberger states, “in evolutionary terms, reading was only invented yesterday, learning language via one's ears however has a much longer pedigree.” The experience of comprehending the meaning of written words is helpful to a language learner. To truly know the words, their sounds must be experienced, directly.

Language is not easy to hear at first. Too much information can cause confusion. Resulting anxiety can block learning. Doubts divert mental resources. These doubts can be methodically removed. Repeated experiences of language sounds synchronized with segmented text makes it easy to know the proper sounds of the language.

Language rhythm can be known. Attention to language rhythm increases the comprehensibility. Fingers tapping synchronously while language rhythm is heard provides an engaging and instructive experience. Rhythmic comprehension is directly and objectively measurable, which allows a learner to quantify the growth of their language skills, confidently.

Language is often visual. New language can also be directly experienced when related to pictures. While not all language is readily made visual in a single picture, multiple pictures can be used to amplify visual renditions of words and phrases.

Language is structured. Segments of new language can be further segmented and classified with formal grammatical or alternative structures. Experience of the classifications helps a learner to compare related parts of expressions.

Prior inventions include widely known systems which control synchronous timings in text and vocalization. Closed captioning, Audio Visual language and karaoke methods are well known. Same Language Subtitling is known. Aligned translations are not yet synchronized in time. More precise and easily accessed timing controls are not yet known. Methods to align sortable picture sets with text segments are not yet known. Methods to align structural classifications with text segments are not known. No known file format controls the variable segmentations and alignments in a text.

Aligned bifocal bitext does not explicitly relate sounds with text. While the present invention discloses improvements in aligning editable chunk translations, simple translation alignment falls short: sound is missing; pictures are missing; structure is missing. With sound, and optionally pictures and structure aligned, new text is made far more comprehensible.

No known technique aligns variable text segmentations with sortable audio, visual and text data. What is need is an easily manipulated plain text file format to control alignment of various segmentations in a text; to align syllabic segments with timing points; to align phrasal segments with restatements; to align separate segments with pictures where possible, and also to personally sort pictures; to align structural classifications with segments; to include and exclude these and other segment alignments within rowSets, and to wrap such rowSets in variable widths of horizontal display. What is needed is a simple method to quickly assign syllabic timing points synchronous in both text and vocalization; where syllables of vocalization are synchronous with a transcription, separate segmentations are optionally needed to align restatements, translations, comments, structures, pictures and other forms of information which can make the language comprehensible and experienced directly; what is needed is a means for a user to control the experience with rhythmic applications of touch input.

### SUMMARY OF THE INVENTION

Accordingly, the objective of the present invention is to make a vocalization and text comprehensible; to control various segmentations to first align timing points with syllabic sound segments; to then optionally align pictures with a separate set of segments in the text; to align structural guides with a separate set of segments in the text; to align restatements with a separate set of segments in the text; to control the various alignments within a file format manipulated in common plain text editing environments; to wrap select sets of aligned rows within variable textarea widths; to control experiences of the aligned texts and sounds; to control the synchronous playback speeds in vocalized text; to evaluate, validated and sort existing synchronizations; to make new synchronizations; to present the synchronizations in outputs ranging from standard captions to full pages of styled text; to compare text segments, vocalizations and aligned synchronizations used in various contexts and to so comprehensibly experience aligned segments in meaningful contexts. A further objective of the invention is to control the segmentation and synchronization experience with enhanced touch controls applied in common computing environments.

### DETAILED DESCRIPTION OF THE PREFERRED EMBODIMENTS

briefly,

A computer is used to precisely synchronize vocalizations with texts. Audio recordings with vocalized language segments and text transcriptions with correlating text segment are precisely synchronized, reproduced at variables speeds, and output in various presentations.

Audio is recorded. Either pre-existing recorded audio vocalization is transcribed, or an existing text is vocalized and digitally recorded in an audio format.

Plain text is controlled. Within the text editing process, and also within select presentations using standard captioning systems, plain text is used to show syllables in text, precisely while they are heard. A plain text transcription of the recorded audio is controlled.

Text is segmented. Customized segmentation interfaces are provided. A monospace type plain text transcription is variably segmented into characters, vowels/consonants, syllables, morphemes, words, chunks, phrases and other groups of characters, preferably representing sound segments. Segmentations are saved and referred to future automatic segmentation productions.

Audio playback speed is controlled. When timing pre-recorded audio vocalizations, recordings are played back at variable speeds. Sufficient time is provided to hear and react to vocal modulations. Slow speeds enable accurate synchronous timing definitions to be made.

Timings are defined. Segmented text is arranged in a sequential series of actionable links shown on the computers display. While the vocalization of each segment is heard, the user synchronously clicks or taps to advance the syllables.

Two or more fingers may be used to define segment timings. Fast timing points are preferably tapped with two or more fingers, applied to a keyboard, touchpad or touch display. Accurate timings for each segment result quickly.

Synchronous playback is viewed. Timed text with audio vocalization synchronizations are displayed in variable presentation outputs. For standard caption presentation systems, multiple copies of each line are timed; in each copy, separate segments are distinguished.

Nested segments appear. While a vocal text phrase appears in time, within the phrase a synchronously timed series of nested segments also appears. Nested segments within phrases may be smaller phrases, single words, characters or preferably syllabic segments.

Uppercase characters distinguish nested segments. Made distinctly visible with capitalized font case, each nesting segment appears in uppercase letters while the synchronous vocalization is heard. Form changing syllables are easily experienced.

A custom file format is provided. To control timings for multiple text segments nested within a single line, a customized file format horizontally arrays the timings and segments. Plain monospace text controls the format in common textareas.

RowSets are aligned in limited widths. Multiple rowSet wrapping controls the file format within variable widths of horizontal display. RowSet returns and backspaces are controlled. Saved timings convert to multiple formats.

Synchronous playback speed is regulated. Where synchronization maintained, playback speed may vary. Users easily access selections and replay them, synchronously. Speed controlled review of select synchronizations prepares a user to accurately define correct timings.

Tap input rate can control the length of sound segment playback. Within special configurations, maintaining touch upon an input mechanism extends pitch adjusted reproduction of the vowel sound; a user can directly control timing of synchronous playback in each sound segment.

Editing is simplified. Textarea scrolling improved. Keyboard controls are used to easily manipulate timing points while viewed in plain text environments; a related graphical user interface allows timings to be controlled from small computer displays such as cellular phones. Timings are adjusted with minimal effort.

Corrected timing errors are easily confirmed. Where edits are made, the system replays the edited synchronization so a user can confirm review the correction. Where no further correction is made, the resulting synchronization is implicitly verifiable.

Verified timing definitions are made. Where one user defines a synchronous timing point, the definition is verifiable. Where a multiple users agree, timing points are explicitly verified.

Timed segments are assembled. Constantly synchronous timings are controlled in variable assemblies. Unsegmentable character timings are found, assembled and segmented variably. Segments are assembled in single characters, character groups, vowels, consonants, syllables, morphemes, words, chunks, phrases, lines, paragraphs, lyric refrains, full texts.

Synchronization is constant. Variable segmentations and assemblies are synchronized. In each case, the timings are constant. Variable outputs enable the synchronizations to be experienced by users in multiple presentation environments.

Outputs are various. Various assemblies are presented variable outputs. Output options include single line caption and also in full page formats. Output options also include plain text and/or graphically formatted text. In all variations of assembly and output, the timings are constant.

Captions display single lines. Subtitle and caption formats typically located below video contents and contained within one line. Synchronous vocal text is presented both in standard and customized caption display environments.

Pages display multiple lines. Within widely used formats, such as HTML webpages, text typically fills displays with multiple lines, paragraphs, lyric refrains and other elements. The precise timing definitions captured in this system are also used to synchronize audio vocalizations with text segments in full page digital texts.

Plain text inputs and outputs are applied. Used to control data in synchronous alignment systems, plain text is easily manipulated in common text editing environments, such as textarea inputs. Plain text is also easily output into existing standard captioning formats and systems. Plain text is used to style texts.

Styled text outputs apply further methods. HTML styles, color, links and elements allow inclusion of many more comprehensible and synchronous alignments with transcription segments. Multiple nesting segments are controlled and synchronized.

Variable segmentations alignments are controlled. The row of sound segments is first aligned with a row timing points. Additional rows can be aligned. Aligned row segmentations can be used to define multiple sets of separate segmentations in the original transcription text. Multiple alignments and segmentations are controlled in a single easily edited text.

Synodic or translated contexts are aligned. Synonyms, translations and various contextual texts are aligned with segments. The aligned contexts are used to understand the meanings of the words seen and heard in synchronous vocal text. Perception of vocalization is enhanced while the intended meanings of the sounds are clearly comprehended.

Syllabic stress and emphasis can be defined. An additional aligned row can accent normally stressed syllables, and also control the styling of atypically emphasizes syllables. Stress and emphasis can then be included in output presentations.

Parts of speech can be aligned. Within a single chunk of text and aligned translation, further alignment between related parts of speech and meaning can be made. The relations can then be included in output presentations.

Text parts can be categorized and colorized. Parts of words, words and phrases can be separately colorized to group related language forms and meanings. The relations can then be included in output presentations.

Questions can classify text segmentations. Categories of meaning framed with question words can be aligned with parts or words, words and phrase. Related question categories can then be included in output presentations.

Pictures can be aligned. Sortable sets of pictures, including video, can be aligned with text transcription segments. Associated pictures can then be linked with related words and phrases, accessed from output presentations and interacted with.

Variable vocalizers can alternate vocalization. Where multiple vocalizations and vocalizers of constant text are recorded in memory, the records can be aligned with specific segments of the text transcription. Altered timing points are controlled.

A text can have multiple vocalizations. Where alternative vocal interpretations of a constant text are available, a user compares between the variations. Evaluation of seminaries and differences in separate vocalizations of a constant text is an instructive experience.

Constant segments are found in variable vocal texts. Where a constant text segment is used in variable vocal texts, the segment identified is easily found and reproduced. Thus, a user can easily experience one segmented component of language as it is used in multiple contexts.

Segments are compared. Seeing and hearing a specific segment used in variable contexts, a user quickly gains experience with it and knowledge of it. The knowledge is multisensory: visual text symbols are synchronized with aural vocalization; where applicable, visual pictures and aligned contexts illustrate and define the segment.

Vocalizations are compared. Where auditory language is synchronized with written language, the vocal expression conducts a high volume of relevant information. A single segment, word or phrase when variably voiced may communicate a wide range of intentions. Experience with such variations is instructive.

Meanings are compared. How a language segment is vocally expressed is significant. What is actually said and intended by the words used is also significant. Where contexts interlinearly aligned with segments, intended meanings in the language used can be clearly conveyed. Experience with the many variable meanings which used words have is instructive.

Structures are analyzed. Grammatical forms and question-classifications can be aligned with separately controlled segmentations. Where literal restatements or translations are aligned with segments, parts of speech can be clearly related, even while not naturally appearing in a matching linear sequence. Where novice users can attempt to define structures, corrections made by experts are made more relevant.

Pictures are linked with segments. Visual information including drawings, charts, photographs, animations and/or video recordings are linked with segments. A user can select and sort personalized visual definitions of words, and compare their selections with default visualizations selected by larger groups of users.

Vocalizations are linked with pictures. Variable vocalizations of constant text segments help a user to experience and compare expressive pronunciations. Variable vocalizations are represented in thumbnail pictures, which are sorted using tiered carousels.

A user is tested. A previously synchronized text provides verified timings which a user can actively attempt to match. Feedback is immediate: mistimed syllables appear in red, while accurately timed syllables appear in green.

Two finger tapping is applied. Synchronous finger tapping to match known timings differs little from the process of timing new texts. Playback speeds are controlled, allowing a user to carefully practice.

A game is played. Increasing levels of challenge are provided. Beginners match slow vocalizations at slow playback speeds. Experts match fast vocalizations and normal playback speeds.

Social groups are formed. Records of achievement are shared online. Users can prove their skill to enter exclusive groups. Language skills form a user's identity.

Language rhythm is made comprehensible. Kinesthetic touch applied to synchronize visually animated text with vocalization sounds hear engage key forms of user perception. Practice occurs in a game, which is rewarded by social validation.

Vocalizations are made comprehensible. Where one recorded vocalization and correlated transcription exist, a single set of synchronous timings are variably segmented, assembled and output. Output format permitting, optional context alignments define forms meaning structures intended in the vocal text.

New language is made comprehensible. Written and vocal expressions are synchronized. Synchronous playback varies in speed. Syllabic segments appear while as they are vocalized in sound. Variable segmentations, assemblies and outputs are presented with constant, synchronous and precise timing. Variable vocalizations in constant text segments are easily created and accessed. Repeated experience viewing and listening to synchronous vocal text removes doubt about the proper sounds of language. The sounds are made comprehensible. Context information aligned with segments communicates the intended meaning of words and phrases. Context information optionally includes pictured image data. Context information optionally includes other grammatical or meaning structures. The meanings are made comprehensible. New language is made meaningful. Language is made personal.

Experience instructs. While the validity of various language instruction theories may be debated, there is no doubt that repeated experience of synchronous vocalizations is instructive; when synchronized with a text, vocalizations train the observer to associate sounds with the text; when synchronized with meanings, vocalization trains the observer to associate sounds with meaning; when pictures are aligned with segments, visual imagery is associated with segments; when language structures are aligned with segments, means to analyze the formal construction and meanings are associated with segments. While the meaning intended by words written in a language may be uncertain, the sounds vocalized leave little room for doubt; they are highly communicative and instructive direct experiences.

Considered in more detail, the present invention comprises a system which enables a user to teach and to learn language; the user experiences synchronous presentations which combine audible vocalizations and visible text segments; even in cases of fast speech, timed text syllables and character segments synchronize precisely with corresponding segments of audio encoded vocalization; controlling synchronous playback speeds, the user gets sufficient time required to hear the sounds while seeing the synchronous parts of text. Larger text segments such as complete words and phrases may have contextual texts interlinearly aligned; the user can know what words say while used in context with other words. Other segments may be aligned with forms of information to increase their comprehensibility. Still, the primary function of the present invention is to clearly relate the sounds of vocalization with the appearance of text: the user hears how words sound in vocalized expressions; the user sees segments of text appear to respond precisely while vocalizations are heard. Where the user grows familiar with meanings and experienced with sounds synchronously represented in written words, the user learns new language.

The system presents synchronous vocal text to the user. Vocal segments of an audio recording are synchronized with a transcription. Methods are used to precisely define timing points to synchronize the presentation of text transcription with the timing of the vocalizations. Segmentations, assemblies and outputs may vary, while the timing points are constant and precise. Corrections to errors in timing definitions are easily saved in computer memory. A customized file format aligns timing points with text segments within controlled sets of rows or plain text rowSets. Wrapping the twin line array to present the data within horizontal page width restrictions is controlled. The synchronous timing points are easily defined and corrected using plain text within HTML textarea inputs commonly used on the Internet. A provided graphical user interface enables a user to control the timings with minimal effort. The timings are easily presented and viewed in standard plain text captioning environments. The provided file format is converted to standard caption formats. Smaller segments such as syllables are individually timed and nested within larger segments such as phrases. The nested syllabic segments preferably appear in uppercase letters while the phrase segment appears in lowercase. Synchronous vocal text is also presented in full pages with complete paragraphs. In standard technologies and publication methods, a user can access instances of synchronous vocalized text created by other users. The user can compare variable instances of vocalization in constant components of text. The system can collect a sufficient volume data which are used to train machine learning systems. Analysis of variable pronunciations correlating with constant segments of text can result in increasingly accurate automatic production of syllabic synchronization between audio and text.

Key words and terms are used to describe, in full detail, the preferred embodiments of the present invention. These key words are defined as follows:

“Audio” means digitally recorded sounds in formats including video formats such as television

“Vocal” means like sounds of human language heard in ears and made in vocal chords

“Text” means any written language encoded for use on a computer, for example Unicode

“Timed” means measured in milliseconds, seconds, minutes and hours.

“Caption” means line of plain text presented in sync with audio recorded vocalization

“File format” means a system to order data which includes a conventional extension name

“Syllable” means phonetic part of transcription or transliteration into phonetic character set

“Segment” means character, syllable, word, chunk, line or other recombinable component

“Playback” means replay of the audio recording; playback may also include timed text.

“Synchronous” means happening at the same time in the same instant of presentation

“Speed” means percentage of normal in audio recording and vocal text synchronization

“Control” means to apply a method or manipulate to obtain a predictable result

“Experience” means to sense through the senses as sensations felt and known to be true.

“Know” means to have no experience of doubt as the truth of synchronous alignment.

“Valid” means confirmed as known.

“Meaning” means a significance which is variably expressed or put into context.

“Alignment” means segment meaning variably expressed and graphically aligned.

“Agreement” means the means by which the meaning is verified and shared.

“Computer” means system to view and manipulate plain text contents

“User” means an agent using the system to acquire language knowledge

“Synchronous vocal text” means text segments timed to appear with vocalizations in audio recordings

“System” means the integrated use of processes disclosed

“Plain text” means ordinary sequential file readable as textual material

“Timing point” means either timing in point or timing outpoint

“Wrap” means to continue a line of text or dual-line array upon subsequent lines below

“See” means see it with your eyes as a known experience

“Hear” means hear it with your ears as a known experience

“Thing” means anything, including nothing

“Audio visual” means presentation which a user can see and hear

“Correct” means to remove an error, or exist as knowledge known and true

“Repeat” means to occur more than once, sequenced by smart.fm

“Train” means instruct by repeating correct audio visual timings synchronously

“Data” means binary encodings stored in and retrieved from computer memory

“Save” means store data in computer memory, typically within a database management system

“Statistical analysis” means to sort data, identify patterns and make accurate predictions.

“Machine learning” means robots can appear to learn language, but can they feel?

“RowSet” means a set of two or more plain text rows; segments within separate rows may be aligned

“WrapMeHere” means a textarea column number at which a text row or rowSet is wrapped.

“Raw wrap” means to wrap a rowSet with WrapMeHere points defined in textarea column numbers

“Segment wrap” means to wrap a rowSet with WrapMeHere points set before aligned segments

“Context” is often used to refer to segments of text, numbers, or links which are aligned with specific segments of text in a transcription; in such cases, “context” may refer to aligned segments of translation, restatement, commentary, structural and linguistic alignment codes, and links to picture sets.

“Aligned context” is used to refer to segmented context alignments as described above.

The method requires the use of a computer. The computer must include a text display and audio playback. Timed presentation of segments within the text is required, so that the segments appear to be synchronized with audible vocalizations rendered in audio playback. Minimal processing power and presentation capacities are required to render the text segments synchronous with the audio playback. More powerful computers can be used to create instances of synchronous vocal text, review presentations of the synchronizations and easily correct errors in the synchronous timing of any segment. Various types of computers are used to apply the method.

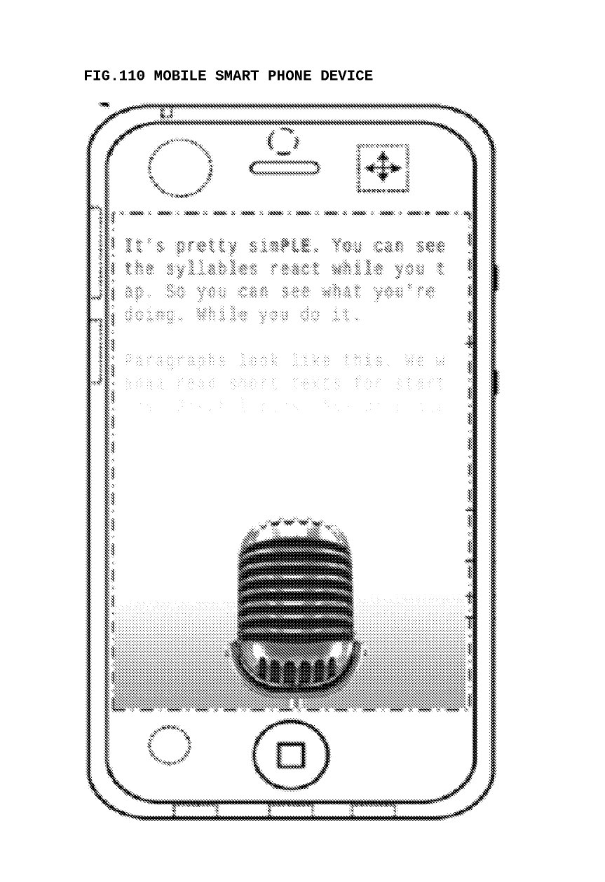

Smart phones and tablets are used to apply the methods. FIG. 110 represents a mobile device and computer system capable of implementing all methods described in the present disclosure. The mobile device can include memory interface, one or more data processors, image processors and/or central processing units, and peripherals interface. Memory interface, one or more processors and/or peripherals interface can be separate components or can be integrated in one or more integrated circuits. The various components in the mobile device can be coupled by one or more communication buses or signal lines.

Camera subsystem and an optical sensor, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems, which can include radio frequency receivers and transmitters and/or optical (e.g., infrared) receivers and transmitters. The specific design and implementation of the communication subsystem can depend on the communication network(s) over which a mobile device is intended to operate. For example, a mobile device can include communication subsystems designed to operate over a GSM network, a GPRS network, an EDGE network, a Wi-Fi or WiMax network, and a Bluetooth network. In particular, the wireless communication subsystems can include hosting protocols such that the mobile device can be configured as a base station for other wireless devices.

Audio subsystem can be coupled to a speaker and a microphone to facilitate voice-enabled functions, such as voice recognition, voice replication, digital recording, and telephony functions.

I/O subsystem can include touch screen controller and/or other input controller(s). Touch-screen controller can be coupled to a touch screen or pad. Touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen.

Other input controller(s) can be coupled to other input/control devices, such as one or more buttons, rocker switches, thumb-wheel, infrared port, USB port, and/or a pointer device such as a stylus. The one or more buttons (not shown) can include an up/down button for volume control of speaker and/or microphone.

Memory interface can be coupled to memory. Memory can include high-speed random access memory and/or non-volatile memory, such as one or more magnetic disk storage devices, one or more optical storage devices, and/or flash memory (e.g., NAND, NOR). Memory can store operating system, such as Darwin, RTXC, LINUX, UNIX, OS X, WINDOWS, or an embedded operating system such as VxWorks. Operating system may include instructions for handling basic system services and for performing hardware dependent tasks. In some implementations, operating system can include a kernel (e.g., UNIX kernel).

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

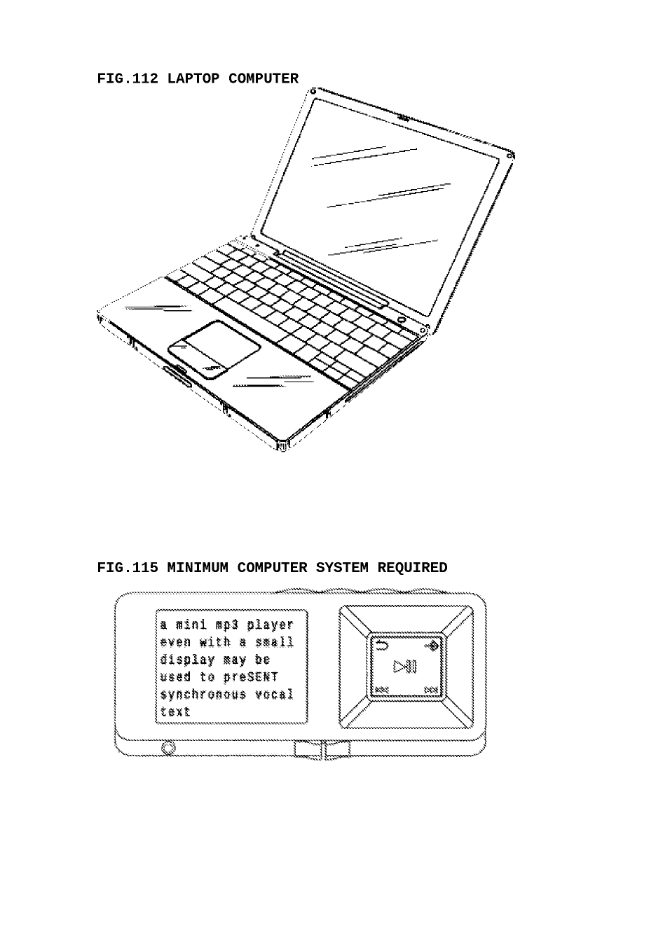

Laptop computers can be used to apply the methods. Referring to FIG. 112, inside base assembly 11220, there may be all the essential and well known electronic circuitry 11265 for the operation of portable computer 11200, such as a central processing unit (CPU), memory, hard disk drive, floppy disk drive, flash memory drive, input/output circuitry, and power supply. Such electronic circuitry for a portable computer is well known in the art. Keyboard 11222 and touchpad 11224 occupy almost all of top surface 11232 of base assembly 11220. In one particular embodiment, portable computer 200 may have a display screen size of about 12 inches. In one embodiment, keyboard 11222 may be a full-size keyboard (i.e., a keyboard layout having dimensions similar to those of conventional desktop computer keyboards) having a conventional “QWERTY” layout, which also includes a large, elongated space bar key in the bottom row of the keyboard. The specific type of the keyboard (e.g., a “QWERTY” keyboard) that is used is not critical to the present invention. A touchpad 12224 is incorporated. In an alternative embodiment, portable computer 200 may have a display screen size of about 17 inches.

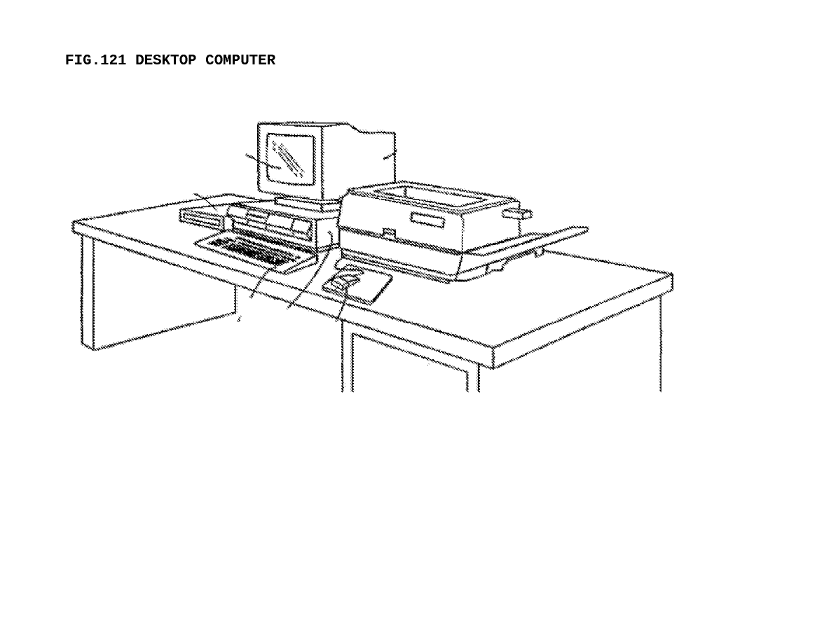

Desktop computers can be used to apply the methods. An implementation of a computer system currently used to access the computer program in accordance with one embodiment of the present invention is generally indicated by the numeral 12101 shown in FIG. 121. The computer system 12101 typically comprises computer software executed on a computer 12108, as shown in FIG. 121. The computer system 12101 in accordance with one exemplary implementation is typically a 32-bit or 64-bit application compatible with a GNU/Linux operating system available from a variety of sources on the Internet, or compatible with a Microsoft Windows 95, 98, XP, Vista, 7 or later operating system available from Microsoft, Inc. located in Redmond, Wash, or an Apple Macintosh operating system available from Apple Computer, Inc. located in Cupertino, Calif. The computer 12102 typically comprises a minimum of 16 MB of random access memory (RAM) and may include backwards compatible minimal memory (RAM), but preferably includes 2 GB of RAM. The computer 12108 also comprises a hard disk drive having 500 MB of free storage space available. The computer 12108 is also preferably provided with an Internet connection, such as a modem, network card, or wireless connection to connect with web sites of other entities.

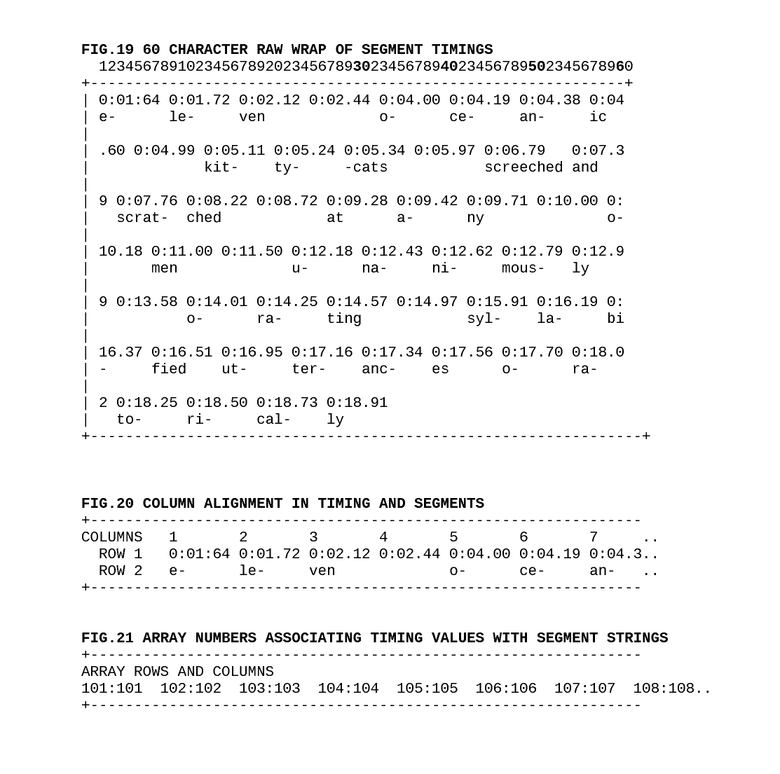

Means for displaying information typically in the form of a monitor 12104 connected to the computer 12108 is also provided. The monitor 12104 can be a 640.times.480, 8-bit (256 colors) VGA monitor and is preferably a 1280. times.800, 24-bit (16 million colors) SVGA monitor. The computer 12108 is also preferably connected to a CD-ROM drive 12109. As shown in FIG. 19, a mouse 2106 is provided for mouse-driven navigation between screens or windows. The mouse 12106 also enables students or translators to review an aligned text presentation and print the presentation using a printer 12114 onto paper or directly onto an article. Where

Means for displaying synchronous vocal text and aligned associations and links, in accordance with the present invention, may include voice controlled portable tablets and/or cell phones equipped with Pico projectors, such as is shown in FIG. 12122. The mobile device 12210 may operate on future extensions of a variety of current operating systems, such as Google's Android, Windows 7 mobile, Apple's iTunes and GNU/Linux systems. The mobile device can be equipped with a microphone 12260 and accept user input via voice commands 12222, enabling the user to access existing chunk translation alignments, edit them and/or create new instances of chunk translation alignment. Alternatively, the mobile device 12210 may accept user input from the user's finger 12220 and a touch screen 12230. Upon creating or locating a specific aligned chunk translation, the user may then proceed to print copies wirelessly, for example using Bluetooth technology.

Simple computers such as MP3 players apply the method. FIG. 115 shows an exemplary minimal computer system required to present the invention. A processor access a memory interface and computer memory containing audio data and text data, and uses a visual display to present text segments synchronously with the audio vocalization segments. While minimal computer system shown in FIG. 115 is not used to produce new iterations of synchronous vocal text and/or aligned restatements, structures and picture links, it may, depending upon the capacities of processing and display, include such output for a user.

The synchronization process requires recorded audio data. The audio data may be recorded in uncompressed audio formats, such as WAV, AIFF, AU or raw header-less PCM; the audio data may be recorded in lossless formats, such as FLAG, APE, WV, Shorten, TTA, ATRAC, M4A, MPEG-4 DST, WMA Lossless; the audio data may be recorded in lossy formats, such as Vorbis, Muspack, AAC, ATRAC, WMA lossy and MP3. Where audio formats such as 3gp, AMR, AMR-WB, AMR-WB+, ACT, AIFF, AAC, ADTS, ADIF, ALAC, AMR, ATRAC, AU, AWB, DCT, DSS, DVF, GSM, IKLAX, IVS, M4P, MMF, MPC, MSV, MXP4, OGG, RA, RM, VOX, and other such formats contain a timing data, correlating timing data are used to synchronize the timing of characters and syllables of text with the audio data.

The audio data may be included in video data formats, such as 3GP, 3G2, ASF, WMA, WMV, AVI, DivX, EVO, F4V, FLV, Matroska, MCF, MP4, MPEG, MPEG-2, MXF, Ogg, Quicktime, RMVB, VOB+IFO, WebM, and other such video encoding formats.

The audio data must contain vocalization such as speech, singing, utterance, mumbling, or other such pronunciations of words and expressions of human language which are rendered textually. FIG. 6 shows a link to an audio recording located on the Internet; the link is representative of any audio encoded data file which includes vocalization in a human language which can be transcribed into written language, and in accordance with the present invention, synchronized as vocal text. The link is not required to be publicly accessible on the internet: a path to access a locally stored audio or audio video recording may be used.

The audio data may optionally be produced live. While a user is reading a text out loud, and while a user is using a microphone equipped computer and audio software to record the vocalization, the text can be timed live. In such an instance, the text exists before the vocalization is created. Where the vocalization is recorded and able to be reproduced, it may be synchronized with segmented text, in accordance with the present disclosure.

A text of the language used in the audio data is required. A transcription of each word vocalized within the audio recording is needed; the transcribed text is used to visually represent the sounds of language which are recorded within the audio file. An existing transcription may be copied and pasted into system, or the transcription is created directly from the audio recording: either automatically through speech recognition technology or manually. The transcription in text must precisely match the vocalizations recorded in the audio data. FIG. 7 shows an example of a transcription. Written in a human language, in this case English, the transcription renders in text the exact words expressed in an audio vocalization. In the representative FIG. 7 example, the transcription text is derived from the audio recording in the video file linked at the representative URL shown in FIG. 6.

The text is segmented into parts of sound, such as phonetic syllables. Whether achieved through software reference to existing data which defines syllabic separation points, or whether achieved by direct manipulation of the text within a common text editing environment, each syllable must be separated from all the other syllables contained within the text.

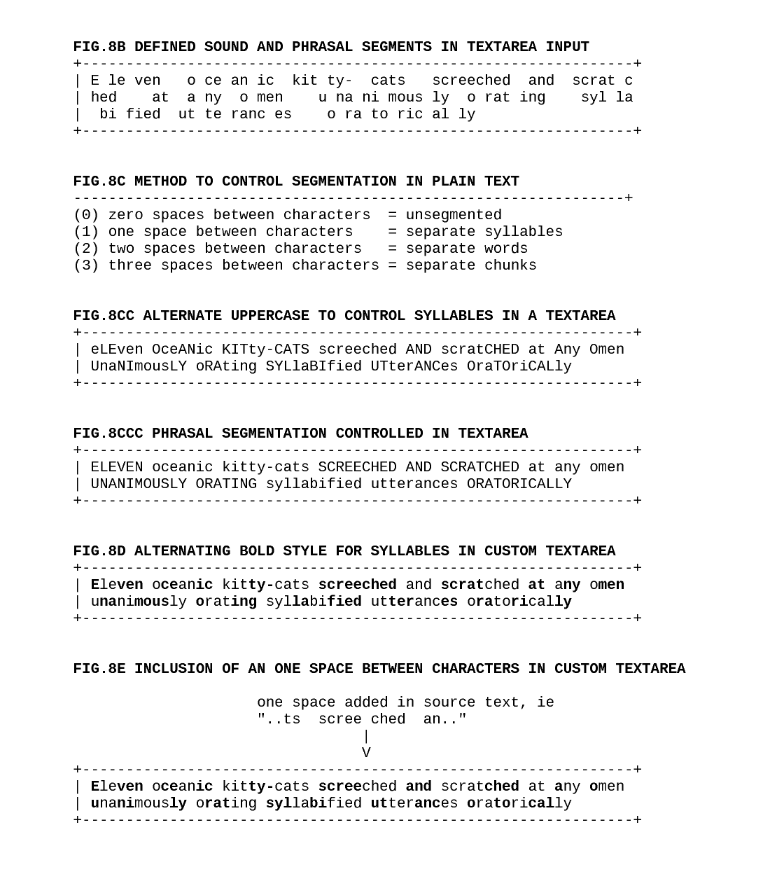

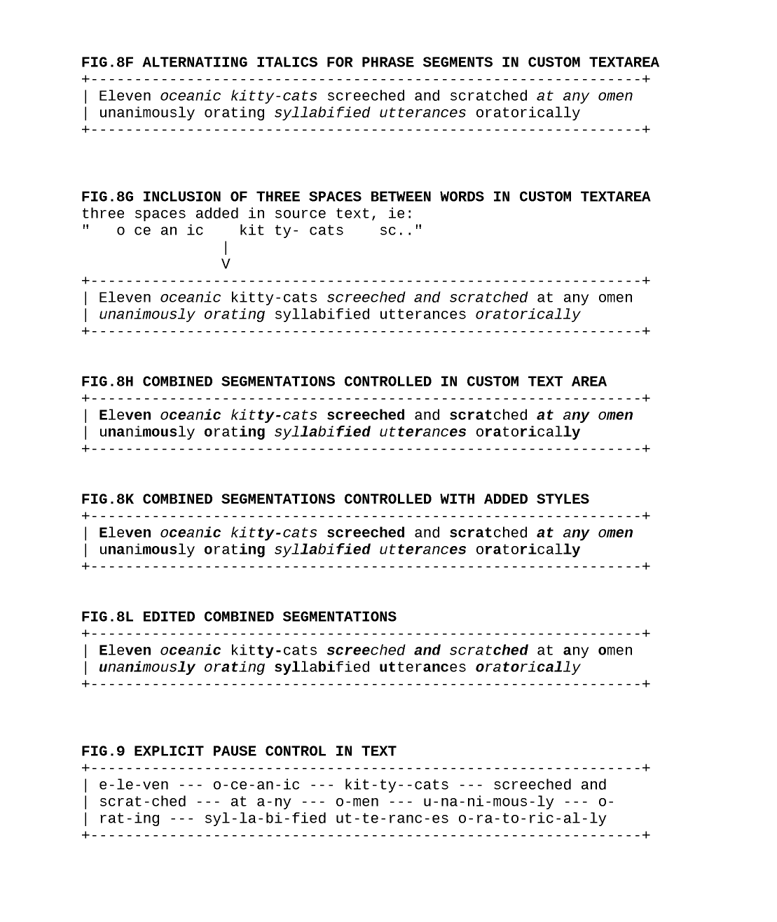

Segmentation interfaces are provided. A simple method is optionally used to specify separate sound segments within the text. As seen in FIG. 8C, where no space is included between characters, there is no segmentation. Where one single empty space is inserted between characters, a syllable is defined. Where two empty spaces are inserted between characters, separate words are defined. Where three spaces are inserted between characters, separate chunks, groups of words and/or phrases are defined.

Multiple segment ions are optionally controlled in common textarea inputs. The segmentation method shown in FIG. 8C is easily controlled without the need for special characters or formatting. While other specialized text interfaces are also used to control the segmentations, the same method of controlling the spaces between characters, as is illustrated in the FIG. 8B example, is used.

Segmentation of text is controlled in simple mobile devices. Keyboards in mobile devices are often simplified, and thus require extra user actions to insert special characters such as slashes or dashes. While special characters are commonly used to segment syllables, the present method eliminates the need to use them: controlled spaces achieve the same function.

Syllabification is also controlled in a customized segmentation editor. A customized text editor is provided, which interprets the variable segmentations defined by one, two and three empty spaces between characters, and formats the information as seen in FIG. 8D. Each sound segment in the FIG. 8D example is alternately rendered in either bold or not bold text. In the example, all of the odd-numbered syllabic sound segments are shown in bold, while the even numbered segments are shown in normal text. Thus, the syllabic segmentation is communicated to a viewer more efficiently than the example shown in FIG. 8B: less space is required to show the information.

The customized segmentation editor is also text based. The FIG. 8D example is produced from the FIG. 8B source text. The syllabic segmentation information in the FIG. 8B source text exactly matches the syllabic segmentations seen in the FIG. 8D example. Within this customized editor, as described above, any extra spaces are interpreted by the rules defined in FIG. 8C. Thus, as illustrated in the FIG. 8E example, where an extra space is represented to be added within the word “screeched”, the alternating bold and unbold sound segments shift one position after the extra space is added. For example, the word immediately following the newly segmented word “and” appears in bold in the FIG. 8E example, in variance to the FIG. 8D example. In the edited FIG. 8E example, the syllabic segmentations continue to alternate as specified: odd segments appear in bold, while even segments do not.

The customized editor controls both syllabic and phrasal segmentations. FIG. 8F illustrates defined phrasal segments, groups of words or “chunks”, which are alternately rendered in a separate style, such as styled with italic typeface. In the FIG. 8F example, the even numbered phrasal segments are not italicized, while the odd numbered phrasal segments are italicized. Thus, a user can distinguish and control the grouping of chunks or words.

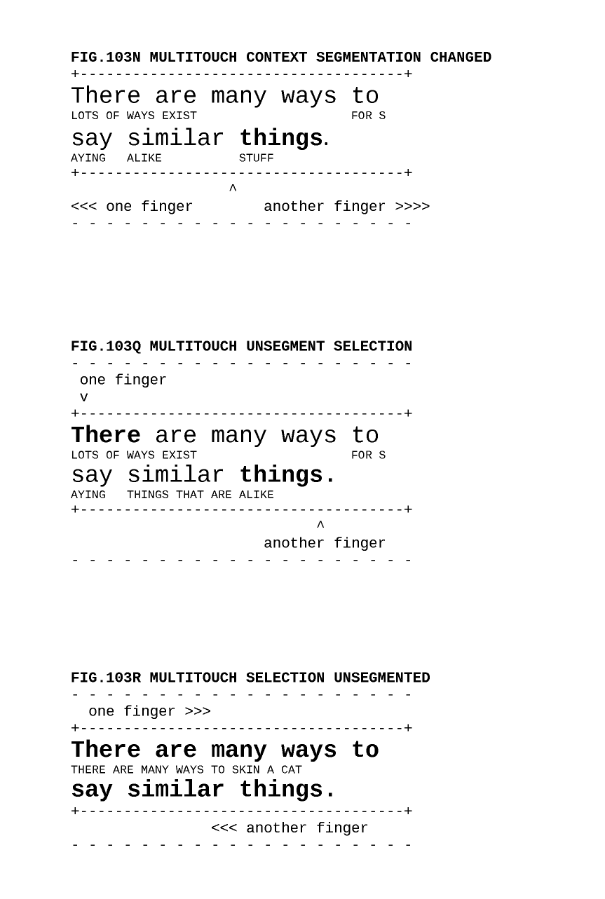

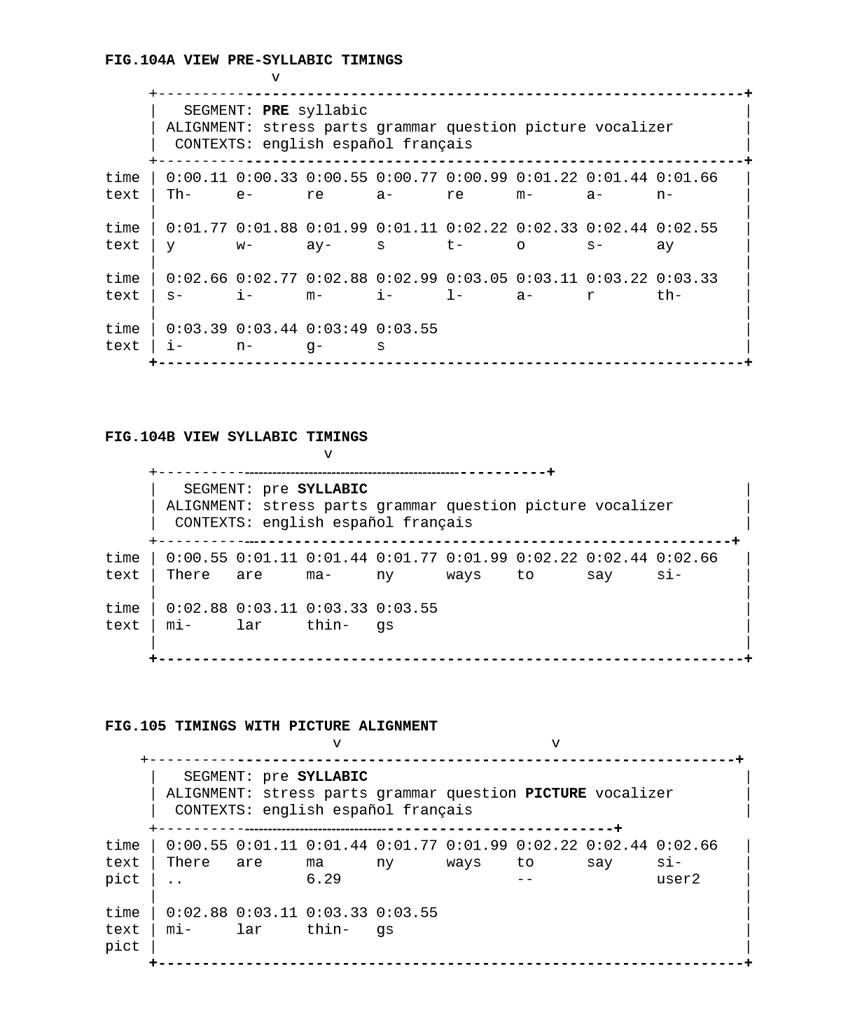

Sound segmentation is preferably syllabic. Syllabic segmentation enables a more humanly readable timed format, as seen by comparison of FIG. 104A and FIG. 104B. Syllabic segments are also more easily timed by a human user in accordance with the preferred embodiments of the present method. To control pre-syllabic or syllabic segmentation of a transcription, prior to application of the disclosed synchronization methods, optional segmentation interfaces are provided.

Sound segmentation is simplified. As represented in FIG. 101 and described above, a simple textarea can optionally be used to view and control syllabic segmentations. The method of including an empty space between syllables and two empty spaces between words produces a result which is easily converted to more customary formats. For example, where the present method syllabifies the string “many ways” as “ma ny ways”, the result can be presented as “ma-ny ways” or “ma/ny ways”. Obviating the need for special characters within the original input, however, considerable enhances a user's control of adjustments, especially while using a mobile device to apply the present methods.

Sound segmentations can be viewed efficiently. A problem with using spaces and double spaces to separate segments and words is that words are less distinguishable from one another than in normal views. Methods to efficiently view the segmentations are provided. While dual sets of segmentations can be controlled in a customized textarea, as shown in FIG. 8H and described in this disclosure, it is simpler to control the sounds segments first with time, and then align variable rows with variable syllabic segments as described below. FIG. 102A shows the described alternating capitalization of separate segments: this allows the each segment to be seen a controlled without visible extra spaces shown in the view. The extra spaces are controlled in the actual source text 101, but interpreted in the customized segmentation editor to alternate in form and/or style, as seen in FIG. 102A and FIG. 102B.

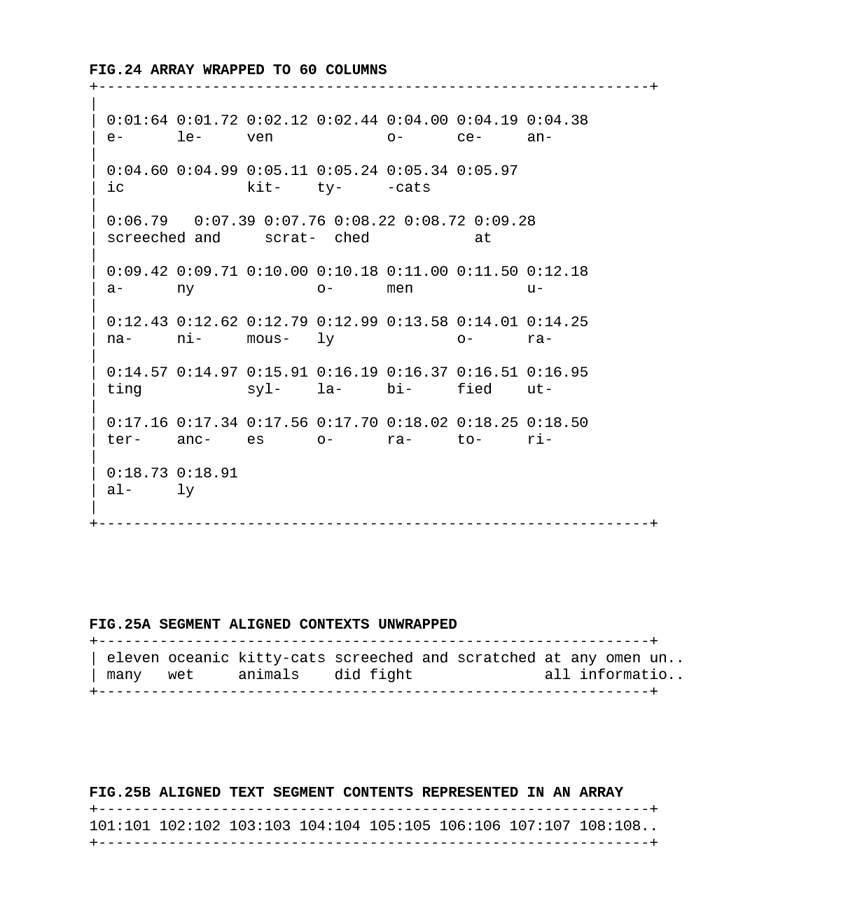

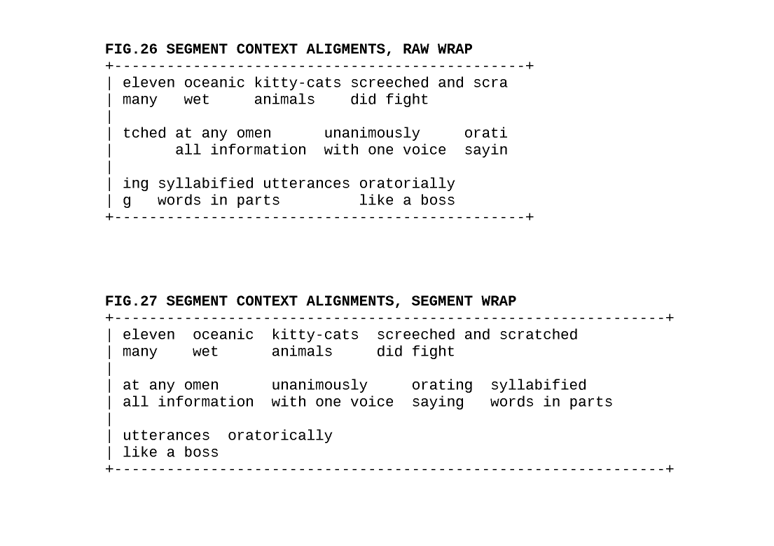

Dashes show syllabification in the timing format. FIG. 8A shows the FIG. 7 text with dashes inserted within most of the words. While dashes may be inserted in syllabic segmentation points, this is not strictly required. As seen in the FIG. 8A representative example, the word “any” is syllabified in two parts; the word “scratched” is syllabified in two parts; the beginning of the word “oratorically” could properly syllabified as “or-a-to.” but is instead segmented as “o-ra”. The segmentations are derived from the sounds in the recorded audio vocalization. FIG. 8A also shows a double hyphenation where the word “kitty-cat” is rendered as “kit-ty--cat”; double hyphens are returned back to single hyphens when the segmentation views are removed, as seen in FIG. 24, FIG. 25A, FIG. 26 and other figures.

Segmentations are optionally defined using empty spaces; FIG. 8B shows the FIG. 8A text segmented using a preferred method, which controls the empty spaces between various sets of segmentations, including, in this example, syllabic sound segments, words, and phrasal chunk segments.

Two or more orders of segmentation are controlled. FIG. 8C shows a preferred method of controlling the empty spaces between characters: where there is no space between characters, no segmentations is made; where there is one space between characters, syllabic sound segments are separated; where there are two spaces between characters, words are separated; where there are three spaces between characters, chunks or phrasal segments are separated. The 8C illustration is representative; in another configuration, one space separates vowels and consonants; two spaces separate syllables; three spaces separate words; four spaces separate chunks; five spaces separate sentences; ten spaces separate paragraphs. In both representations, empty spaces are used to define multiple orders of segmentation.

Alternating case is optionally used to view segmentations efficiently. FIG. 8CC shows a method to view an example of a segmentation applied to a representative text; what is represented is a plain text within a common textarea input. A program controls the text to show the complete segmentation while requiring neither special characters, nor apparent extra spacing between words in the text. The FIG. 8CC example represents a controlled view of the actual source contents shown in FIG. 8B. The FIG. 8CC result is produced by finding and numbering every instance of two or more spaces between characters, then temporarily rendering the odd numbed instances in uppercase letters while temporarily rendering the even numbered instances in lowercase letters. Then a single space is removed from any instance of one or more spaces. Then any remaining sets of two or more empty spaces are reduced to a single empty space.

Syllabic segmentations are optionally viewed using alternating case. The FIG. 8CC view is used to manage syllabic segmentations. Where a space is added between two characters in a word, it is immediately removed by the software and the pattern of uppercase and lowercase letters after the included space is shifted, in accordance with the changed pattern of odd and even numbed syllabic segments. For example, if a space is added within the word “screeched”, two syllabic sounds are displayed within the same word; the program presents the string “screeCHED”, which is derived from the “scree ched” source string. To remove the syllabification, the cursor is place in the syllabic break point and the backspace key is applied. The software replaces the removed “e” and presents the viewer with the word “screeched”.

Phrasal segmentations are optionally viewed using alternating case. FIG. 8CCC shows a method to view phrasal segments in a textarea. The FIG. 8CCC example represents a controlled view of the actual source contents shown in FIG. 8B. The FIG. 8CCC result is produced by removing one single space from any instance of one or more spaces, so that syllabication within words is no longer visible. Then any group of words separated by two or more spaces is temporarily rendered in uppercase and lowercase letters. As with the FIG. 8CC example, the software numbers each group and assigns the alternating case presentation to odd and even numbered groups in series.

The segmentation textarea is controlled to view space defined segmentations efficiently. The FIG. 8CCC view is used to manage phrasal segmentations. If a space is added after the word “UNANIMOUSLY” then phrasal segmentation and pattern of upper and lowercase representation shifts accordingly. Removal of a space before a phrasal segment joins that segment to the previous segment.

The actual segmentation source is easily accessed. Three views of the same input text are seen in FIG. 8B, FIG. 8CC and FIG. 8CCC. Toggling between the views is effected repeating input on a single keyboard key or a single touchscreen button.

More customized segmentation textareas are optionally applied. FIG. 8D shows a method to represent the syllabic segments: all odd numbered syllabic segments are formatted in bold style, while all even numbered syllabic segments are normally formatted. In the alternation of bold and unfold styles, the syllabic segments are easily seen, while the single spacing between separate words appears to be normal.

A single space added between two letters changes the segmentation. FIG. 8E represents the FIG. 8D text slightly edited within a customized segmentation interface. A space is added within a word, which results in a new syllabic segmentation, which subsequently changes the order of bold and unfold styled syllables. The custom segmentation interface interprets the space controls defined in FIG. 8C and automatically formats the syllabic segmentation sequence.

Customized segmentation textareas optionally apply styling. FIG. 8F shows a method to represent the phrasal segments: all even numbered phrasal segments are styled in italics; all odd numbered phrasal segments are styled normally. In the alternation of italic and non-italic styles, the phrasal segmentations are easily seen, while the single spacing between separate words appears to be normal.

Three spaces between characters optionally defines phrasal segmentation. FIG. 8G represents the FIG. 8F text slightly edited within the customized segmentation interface. A third space is added to the two spaces used to separate words, thereby delineating a new phrasal segment. The subsequent order of italicized segments is shifted. The custom segmentation interface interprets the space controls defined in FIG. 8C and automatically formats the syllabic segmentation sequence.

Syllabic and phrasal segmentations are viewed concurrently. FIG. 8H represents a combination of alternating bold syllabic segments and alternating italic phrasal segments. Multiple segmentations are easily seen, while the single spacings between single words appear to be normal.

Explicit segment styling is optionally applied. FIG. 8K represents additional styling applied to the FIG. 8H example. Yellow highlighting is added to the alternating bold syllabic segments, while the alternating phrasal segments are rendered in blue and purple text.

Segmentation edits are easily seen. FIG. 8L represents a slightly edited version of the FIG. 8K example. Within the customized segmentation interface, the segments appearing after the edits shift in style, as extra segmentations are added or removed. What is consistent is that each even numbed segment is separately styled from the odd numbered segment, so that the segmentations can be seen and controlled, without the inclusion of special characters or visible extras spaces between separate words.

Phrasal segmentations are optionally controlled. Simply by the inclusion of three or more empty spaces between words, the segmentation of distinct phrases is controlled. In the FIG. 8G example, a total of three or more empty spaces are included between the words “oceanic” and “kitty-cats”, which is interpreted by the software as the definition of a separate chunk. Where in the FIG. 8F example, the word “kitty-cats” was included in the phrase “oceanic kitty-cats”, now the words are shown in separate phrases, where “oceanic” is italicized, while “kitty-cats” is not. In both of the FIG. 8F and FIG. 8G examples, however, each even numbered phrase is not italicized, while each odd-numbered phrase is italicized.

Two separate segmentation orders are controlled in a single text. FIG. 8H shows the FIG. 8D and FIG. 8F examples combined within the customized segmentation editor. Syllabic segmentations are alternate with bold style, while phrasal segmentations alternate with italic style. The simple bold and italic shown examples of styling control are not limiting. Nor is the segmentation method and interface limited to syllabic and chunk segmentations; it may be applied with other forms of segmentation, such as visual or variable vocal segmentations which are specified in this disclosure.

Alternative styles are optionally used. The styles shown are representative. Any text styling may optionally be used to communicate the segmentations within the customized segmentation editor. For example, FIG. 8K shows the FIG. 8H text with yellow highlighting behind odd-numbered syllables, to make the segmentations more visible; FIG. 8K also alternates the colors of phrasal segments or chunks: odd numbered chunks are shown in blue text while even numbered chunks are shown in purple text. FIG. 8L shows the FIG. 8K text after the edits represented in FIG. 8E and FIG. 8G are made.

Stylings used to present the segmentations are processed automatically. A user simply controls the spacing between text characters, as described above. The software interprets the number of empty spaces to execute the styling used to easily see the segmentations.

Odd numbered segments are distinguished from even numbed segments. Styling is controlled in basic plain text by alternating upper and lowercase letters between odd and even numbed segments. Where textareas allow further styling controls, multiple options such as italic, bold and colorization are optionally applied.

Multi-touch control is optionally applied. Segmentation is also controlled without a keyboard, where multi-touch controls such as “pinch in” and “pinch out” are applied. First, a cursor input position is defined. Then, two fingers or one finger and one thumb concurrently touch the screen, while the points at which they touch the screen are known. If the known touch points increase in separation, a “pinch out” response is invoked: a space or number of spaces is added to the text where the cursor is located. If the known touch points decrease in separation, a “pinch in” response is invoked: a space or number of spaces is removed from the cursor position. One of three possible levels of pinching is applied: a “narrow pinch” is defined by one centimeter; a “medium pinch” defined by at least two centimeters; a “wide pinch” is defined by at least three centimeters. As with the other custom segmentation editors, the extra spaces are not displayed to the user; the extra spaces are used to style the segmentations so the user can see them and control them.

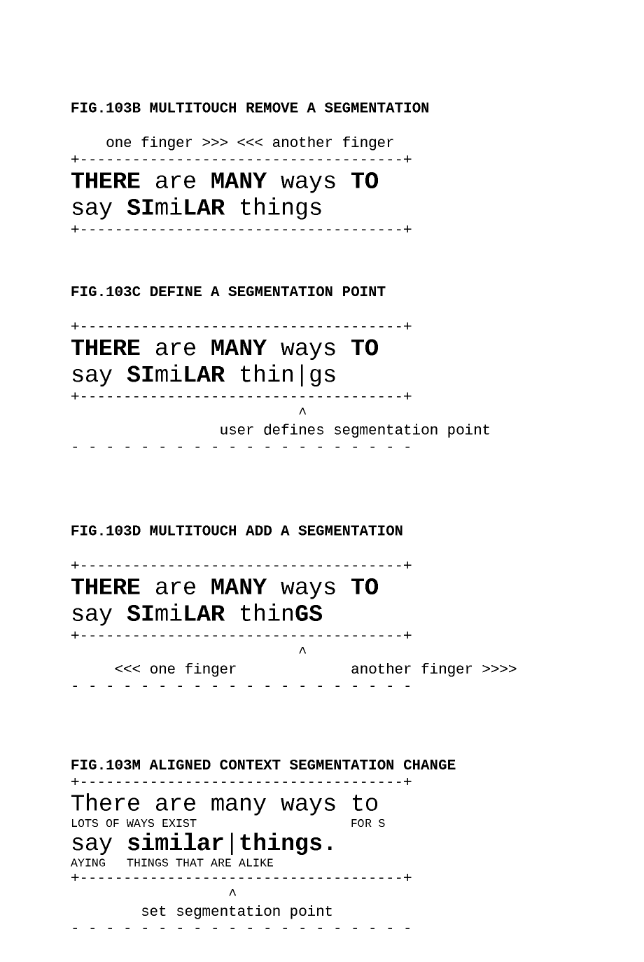

Sound segmentations are manipulated by hand. As an option applicable in multitouch input interfaces, sound segmentations are controlled by hand. FIG. 103A shows and efficiently viewed syllabic segmentation which is represented to appear within a multitouch enabled user interface. Odd numbered syllables are presented in uppercase letters and in bold, while even numbered syllables are presented without such styling enhancements.

A cursor position is defined. Within the customized textarea represented in FIG. 103A, a user defines a segmentation point by inserting the cursor between two characters of a single word. With the cursor position established, the user may then join a segment by squeezing opposing fingers toward the defined segmentation point, or separate a segment by pulling opposing fingers away from the defined segmentation point.

An existing segmentation can be removed. FIG. 103B represents the joining of previously segmented syllables into a single segment. The cursor position was established as previously described and shown in FIG. 103A. The cursor position is now known to be between the syllables “ma-” and “ny” within the word “many”. Opposing finger then bring the segments toward each other. Interpreted as a command to remove the segmentation separating the syllables, the syllabic source text is changed from “ma ny” to “many”. Where the 103A example had eleven syllables, the 103B example now shows ten syllables. The order of odd and even numbered syllables has also been shifted. For example, the fourth syllable in FIG. 103A is “ny” while the fourth syllable in FIG. 103B is “ways”. The alternating styles have been adjusted accordingly.

A new segmentation can be created. FIG. 103C represents the FIG. 103B illustration with a new cursor position defined. The cursor now defines a segmentation point within the word “things”. The cursor is positioned between the characters “n” and “g”. FIG. 103D represents the presentation after opposing fingers have been drawn away from the defined cursor position; a space is added into the underlying source text, which would now read as “thin gs”; a new segmentation now appears within the word “things; where there were ten syllables in FIG. 103C, FIG. 103D now shows eleven syllables.

Pauses between vocalization of segments are optionally predefined. Typically within an audio recording containing vocalized human language, there are pauses between words, phrases, sentences, and even syllables or phonemes. Such pauses are optionally identified by a text symbol such as “---”, which are inserted within the text to coincide with pauses contained within the audio recording. The textual pause symbols are made actionable within the series of separately actionable syllables as described below. Thus, the timing in-points and out-points of any pauses within the audio recording are accurately defined, as can the timing in-point of the next syllable of synchronizable text and audio recording. Within a preferred embodiment of the present invention, most pauses are controlled when timing each syllabic segment while using a touch interface, which allows input from multiple fingers to be applied more quickly than is possible with single mouse clicks.

Pauses are optionally prepared. FIG. 9 shows a triple hyphenation “---” character group which is used to represent a pause. When defining the segment timings, the provision to manage the timing of pauses between vocalized syllables and words is extremely useful; with pauses precisely timed, each syllable or sound segment is highlighted, made bold or shown in uppercase letters only while it is heard. The triple hyphenation could be any character string, so long as it can be linked to the next syllabic sound segment rendered in actionable text.

Segmentations are made with minimal user effort. Equipped with a multitouch interface, a user directly applies segmentation definitions to a text without requiring the use of a keyboard. If preferred, the user may use a mobile keyboard, without any need to hunt for special characters: the segmentations are simple controlled with number of empty spaces between characters. If viewed in the custom segmentation interface, the segmentations are shown with maximum efficiency. If viewed in a common textarea, the segmentations are easily seen and manipulated within a most simple editing environment.

Segmentations are stored in memory. Every word a user segments is stored in a reference system, which is accessible while producing mechanical or automatic segmentations of future texts. Variable segmentations of a single word are controlled statistically. For example the word “many” may be syllabically segmented 80% of the time as “ma ny” and 20% of the time as “man y”. When production automatic segmentations, the system refers to stored reference and fetches the most probable segmentation.

Errors are corrected. If, while automatically producing segmentation, the system applies an invalid result due to an incorrect segmentation record, the methods disclosed enable a user to easily correct the error. Each instance the error is corrected increases the likelihood of accurate automatic segmentation in the future. For example if the word “segment” is improperly known in the reference as “se gment” due to a single instance of user applied segmentation, two future corrections to the properly syllabic “seg ment” then define the proper segmentation of the word with 66% probability.

Automatic segmentation is produced. Syllabic and pre-syllabic (consonant/vowel) segmentation are automatically produced by referring to records which contain the average segmentation applied to specific words. For example, if the word “many” is syllabically segmented as “ma ny” more often than it is left unsegmented, where the word is encountered in a new text to segment, the more frequent segmentation is applied. Where a word or group of words has not been syllabically segmented and is then segmented, then a record of the segmentation is made and stored in the syllabic segmentation reference library. Where an existing record is in error, repeated corrections confirm a commonly agreed to syllabification point. While other rule-based metrics may optionally be used, statistical records of segmentations for all methods named and numbered is the preferred method of segmentation.

Adjustments are easily made. Each transcription is based upon the vocalization recorded in an audio file. In certain instances, such as in heavily accented and/or fast speech, not all syllables may be properly enunciated. For example, automatic segmentation in FIG. 103A refers to the library of known syllabic segmentations to thus segment the word “many” into two syllables: “ma” and “ny”. However, if the recorded vocalization verbalizes the word hastily, only one sound is heard. Thus, a user can adjust the segmentation as needed.

Each syllabic segment is made separately actionable. In order for the user to define the timing in points and outpoints of each textual syllable to synchronize with each vocalized syllable contained in the audio recording, the textual syllables must respond to user input. An impractical method is to define the timing points by directly typing the timing numbers. It's easier to use HTML <a href> tags to make each syllable a hyperlink. Easier still is to make most or all of the display screen actionable, so a user can easily apply the action required to timing the active segment and advance the presentation to the next segment. In modern HTML, an <element> is manipulated to proceed while controlling the style of each sequential syllable.

The separately actionable segments are arranged in a series. For example, when using the HTML method to make each syllable actionable, each actionable syllable is linked to the next syllable, which is made actionable only after the HTML hyperlink within the previous syllable is clicked, touched or otherwise invoked. Invoking of the currently actionable syllable does four things at once: 1) it defines the timing out-point of the current syllable; 2) it defines the timing in-point for the next syllable; 3) it terminates the actionability of the current syllable: 4) it makes the next syllable actionable.

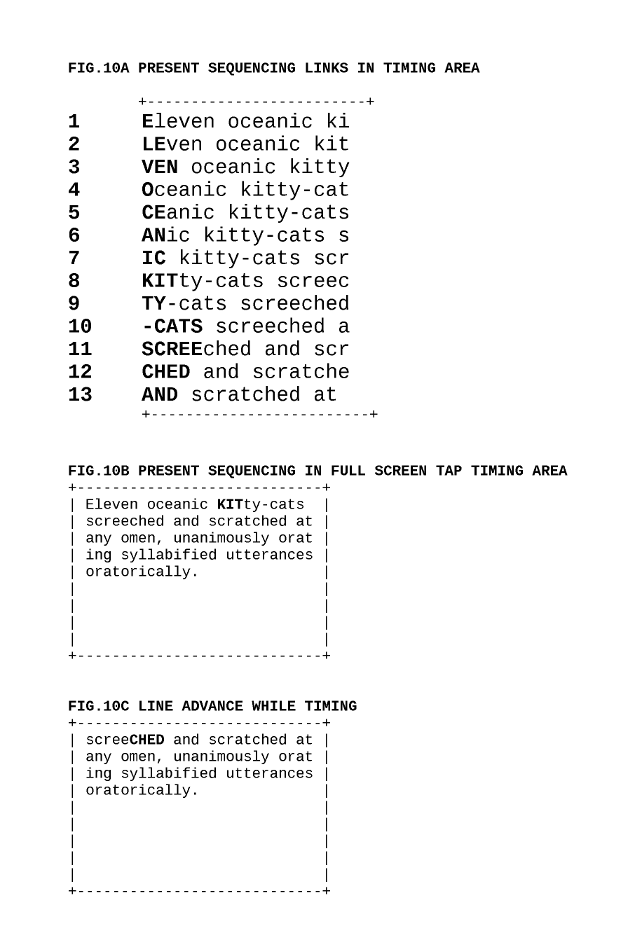

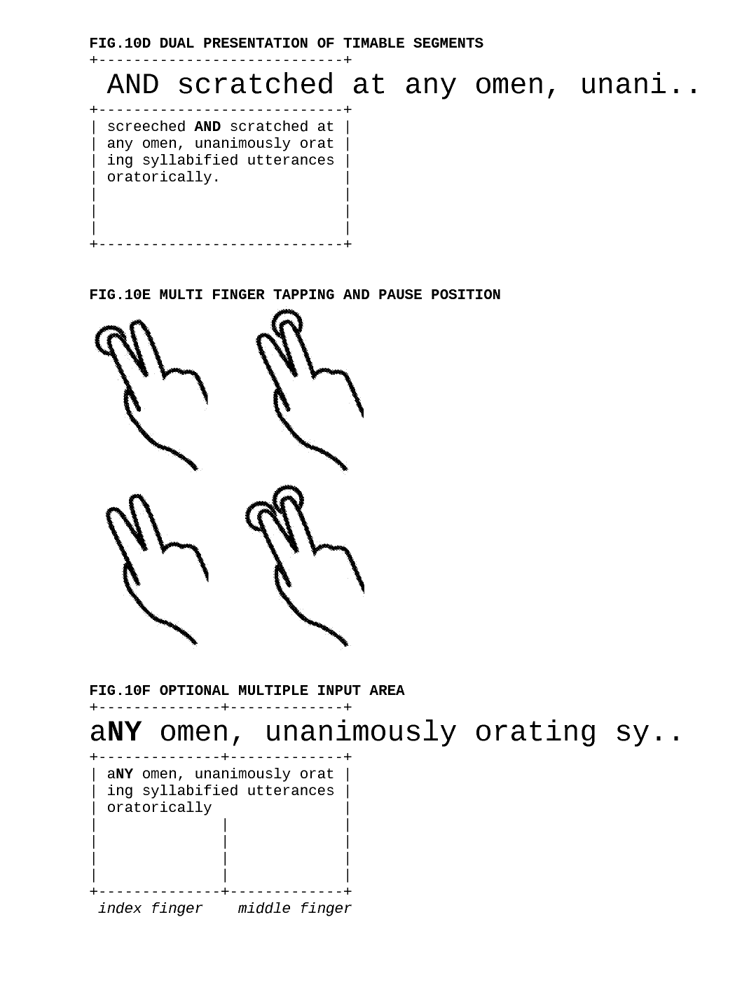

Minimal user effort invokes the actionable segment sequence. The series segments is optionally arranged to be presented within a static area. The link location is easily predictable. In one embodiment, keys on a keyboard are used to advance the sequence of linked segments. In another embodiment, as illustrated in FIG. 10A, the actionable syllable is prepared to appear in the same location; when a user invokes and thus times the syllable, the next syllable appears in the exact same location.

Minimal user effort is required to capture accurate timings. No errors occur due to delays caused by line breaks, which require human reaction time to move the finger, stylus or mouse controlled input from the far right end of one line to the far left end of the next line below. More accurate timings result with less effort required.

FIG. 10A represents the syllabic sound segments and pauses defined in the previous figures now presented in a sequential series of links; the currently active link, as represented in FIG. 10A, is the first segment “E-” rendered in bold black text. When touched, clicked or otherwise invoked, the line is replaced with the contents from the next line down, in which the first segment is rendered in lowercase as “e-”, while the next segment “LE-” will be bold and black and actively linked to the following segment, which when clicked will appear in precisely the same area, in uppercase bold and black with a link to the following segment. Each time that a link is clicked, all the text appears to shift toward the left. Thus, the next segment of text appears in precisely the same location. All linked segments are clicked and timed. Thus, a human user can simply time each syllable and pause without any need to correct for cumbersome line breaks: the timing information is defined in one single area, preferably most or all of the touchscreen. Thus, the user is presented with sequenced syllables or sound segments to click; clicking the links defines the timing points; clicking the links in sync with the audio vocalizations defines synchronous timing points.

A more inclusive view of the text is optionally presented. Multiple lines of the syllabic text are optionally viewed while the timing points are being defined. FIG. 10B shows the example text within a representative display area. Upon the first line of text, the syllable “kit” is shown capitalized and in bold, to represent its correspondence with a recorded segment of audio vocalization which is presently being synchronized. The viewing of multiple lines in a text being timed allows a reader to prepare, often pre-consciously, to assign the timings and also optionally to vocalize the upcoming text segments.

FIG. 10B represents the text segmented in the FIG. 8H segmentation interface example shown in five lines within a relatively small touch input display area, such as the display found in a mobile smart phone for example. One syllable is shown capitalized in uppercase and bold letters, to represent a syllabic segment which is being timed in sync with a concurrent audio vocalization reproduction. All or most of the display area responds to touch input from a user; each touch advances the capitalized and bold styling to the subsequent syllable.

FIG. 10C represents the FIG. 10B example after four touch inputs are invoked; the first line has been touch timed and has moved up and out of view, leaving only four lines visible. The capitalized and bold syllabic sound segment represents the syllable being synchronized with the concurrent audio vocalization reproduction.

Combined views of the timable segments are optionally used. As seen in FIG. 10D, a dual view of both the horizontally scrolling view of few segments styled in large type is combined with the inclusive view which, as described above and shown in the figures, presents multiple lines. In a combined view, at the cost of some potential distraction, a user can focus on either view. When reading from a distance while using a small device, the user or users can more easily see the larger segments. When reading from less distance while using a larger device, the inclusive multiple line view may be preferred.

FIG. 10D represents a combined view of the horizontally advancing view of sequenced segments shown in FIG. 10A, together with the vertically advancing view of the same sequenced segments shown in FIG. 10B and FIG. 10C.

While recording live, the text preferably appears near the camera. Where possible, when a computer has camera which can record video of a user who is looking at the screen, the text is ideally located near the camera. Thus, while reading the text and recording vocalization, the eyes of the user appear to be reading a text that is located in between the vocalizer and the end user of the instance of synchronous vocal text being produced.

A user timing input method is defined. As described above, each segment of text is timed while it is heard. Syllabic segments in vocalized recordings often occur at very fast speeds, which due to human limitations of required perception and reaction time, are not easily timed while using a mouse. It can be done, but the playback speed typically must be reduced considerably. Further, while using a legacy mouse, typically a mouse click is registered as a single event. Ideally, two timing points are defined with each touch a user inputs: one timing when the touch starts, and another when the touch stops.

Tapping a touch area with two or more fingers is preferred. Touch interfaces, such as keys on a keyboard, the track pad on laptops, modern mice and especially touch screens, allow two or more fingers to be used to tap upon an input area more quickly and more efficiently. Fingers from two separate hands may optionally be used, or two fingers on a single hand may be used. FIG. 10E represents four simple states of fingers on a human hand controlling a touch input mechanism within a computer system.

FIG. 10E represents four separate input positions using two fingers. Input mechanisms optionally include a keyboard, a track pad and/or a touch screen display. Either finger alone provides the input required to invoke a sequentially linked text segment. When, between the timing of two segments in sequence, neither finger touches the input area for a period of 100 milliseconds a greater, the timing of this untapped period is captured and a timed pause is automatically inserted into the timing of the text; the pause continues until the next finger strikes the input area, to thus advance the presentation to the next segment in sequence.

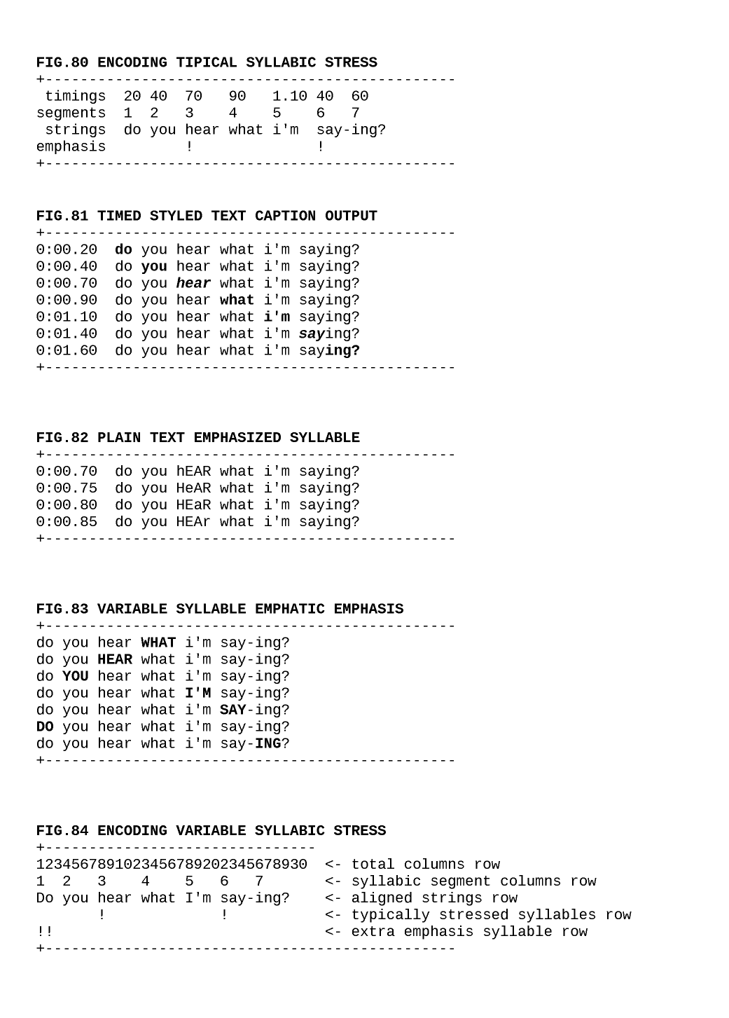

Within multitouch capable displays, and/or while inputting two keyboard keys simultaneously, or the left and right click mouse buttons, when two fingers provide input at the same time for more than 100 milliseconds in duration, the timed segments is marked as stressed or emphasized and is recorded in alignment with the text segments as shown in FIG. 80

Any finger is used to invoke the sequential links. Whether the thumb, index finger, middle finger, ring finger or little finger is used, so long as the link is invoked, the system advances to the next link in the sequence. Multiple fingers may be used in sequence. In the FIG. 10E example, the index and middle finger are used.

A separate touch area for separate fingers is optionally defined. In the simplest iteration, one large area is actioned with input from a finger, whether to keyboard keys, a track pad or to a touch screen interface. Optionally, a separate target area is defined for separate fingers: for example, two separate keys on a keyboard. Optionally, the left and right mouse click buttons are used as input mechanisms. Another example is illustrated in FIG. 10F, where a touch screen area is represented split vertically in half, with the left half dedicated to host input from one finger or thumb, while the right half is dedicated to host input from another finger or thumb. In certain instances, separate touch areas allow for more precise timings, as conflicting input from both fingers is resolved.

FIG. 10F represents an optional split touch area, which is used to minimize conflicting input accidentally occurring while two separate fingers control timings and segment advance within a single input area.

Multitouch is not required. Where an input area allows concurrent input from multiple fingers, additional controls may be applied while timing a text: a mouse with left and right click options, or separate keys on a keyboard are optionally used. Separate fingers may optionally tap a touchpad. At the minimum requirement, each sequenced link is invoked by a single user input, regardless of which finger delivers it.

Multitouch may be used. Where actual multitouch interfaces are able to distinguish variable force with which a finger touches the input mechanism, a far more effective means is provided for a user to assign common stress to syllables and/or uncommon emphasis to a particular syllable or word.

Pauses are controlled while using the touch interface. A defined pause initiation interval, such as 100 milliseconds is set. If neither of a user's fingers invokes the touch input for the defined pause interval, the system interprets this as a defined pause. In such an instance, the actual pause timing is measured by the addition of the paused time with the interval timing of, in this case, 100 milliseconds. So, for example, if neither finger touches the input mechanism for 200 milliseconds after the pause initiation interval passes, then the pause timing is defined as 300 milliseconds. In another example, if the timing separation between the segment timing inputs is 80 milliseconds, then no pause is added between the two segments timed.

Stressed syllabic segments are optionally controlled. For example, within multi-touch environments, including as defined above, a mouse equipped with left and right click buttons, a track pad configured to differentiate input in separate areas of the track pad, and/or the use of two separate keyboard keys, where two fingers touch the input area for a defined minimum stressed segment initiation interval, such as, for example, 100 milliseconds, then the segment which coincides with the vocalization is emphasized; the emphasis of the segment is recorded and in the segmentation and alignment method shown in FIG. 80.

Sequential segment links are prepared and means to invoke the links are defined. Segmentation is controlled and the segments are prepared to be presented to a user in a sequence of actionable links. Variable means to invoke the actionable links are defined. According to the capacities of the computer being used, whether a small mobile device or a desktop with a full keyboard and large display, a user controls the means to most easily, accurately and quickly defined the timings for each segment arranged.

The segments of text are thus prepared to be synchronized with an audio recording. When the first pause or syllable is invoked, its timing end-point is defined, as is the timing in point for the next pause or syllable, which only then is made actionable. Thus, each pause and syllable is prepared to be timed and assembled into a series that accurately synchronizes the parts of the text with the correlated parts of the audio recording.

Text segments may be previously synchronized with existing recording and/or while recording live audio. Vocalization of the segmented text already exists in pre-recorded audio data, or the vocalization is recorded while the segmented text is timed. Either process has advantages and disadvantages. Pre-recorded vocalizations are more natural or authentic, and may contain very fast speech. However, pre-recorded vocalization may be relatively less easy to synchronize with segmented text. Recording vocalization while timing text segments is a relatively easy process. However, the vocal reading of a pre-existing text may sound less natural, and the accurate timing fast speech is less practical.

The audio recording may be produced live. When synchronizing live vocalization, a user vocalizes the text segments while reading them, and also while assigning timing definitions to each segment, simply by clicking on the segment or hitting the right arrow key. Where the segmentations are broad, such as in the case of full phrases or full lines of lyrics, the vocalization may flow more naturally. Where segmentation is to the syllabic level, the vocalizations may flow less evenly, particularly when a faster rate of vocalization is attempted. However, the live recording of required audio while timing synchronous text segments has several important benefits, including ease of production and thus, the ease of producing variable vocalizations which are easily compared.

Both audio recording and timable text segments are started at once. Synchronized at precisely the same time, the audio recording and also the first segment of the actionable sequence of links are both initialized. Where the initial synchronization is staggered, or where the audio element is initialized before or after the timable text segment sequence is initialized, the initialization timing difference is corrected after the timings of vocalizations and synchronous text segments are captured. Thus, the starting points for both the recorded audio vocalization and also the segmented text timing points are precisely synchronized.

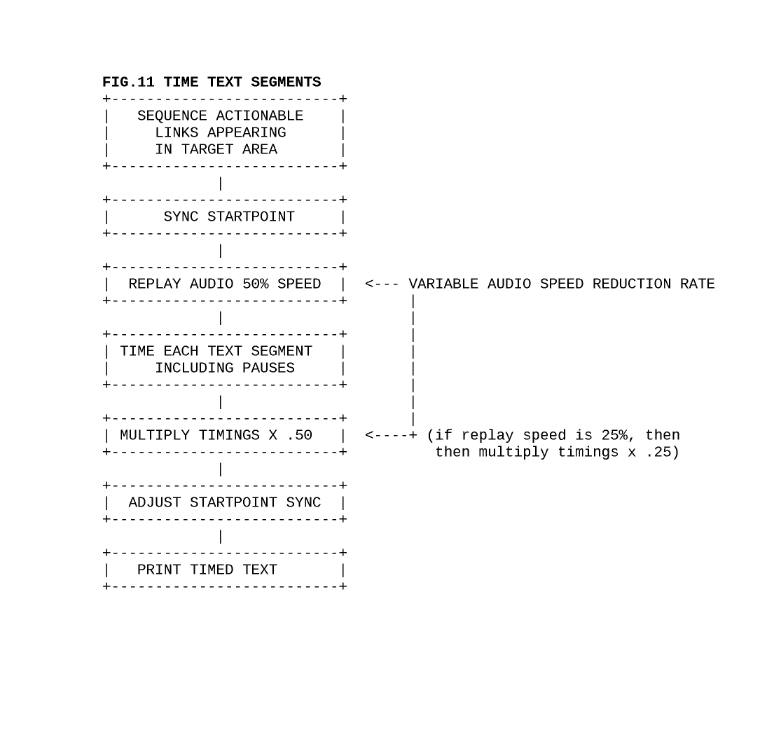

FIG. 11 shows a flow chart to represent and describe a method to synchronize audio vocalizations with segmented text; first the segments must appear as actionable text as described in FIGS. 10A, 10B, 10C, 10D, 10E, 10F. Next, the start point for both the audio and timing data should be synchronized as precisely as possible. Next, control of variable playback speed provides the time required for a human user to hear and react by clicking on text segments while hearing them vocalized. Next, every segment is clicked in sequence and synchronized in time with the audio vocalization. Next, the timings are divided by the exact factor by which the audio playback speed was reduced, so that when played back at normal speeds, the segments of text will synchronize precisely with the audio vocalization. Finally, the starting point for both the text segments and audio data are precisely synchronized, typically by adding or subtracting a number of milliseconds to all of the text timing points.

Each segment of text is timed in sync with the vocalization being recorded. Where segmented text prepared and arranged into an actionable series of links, and where the appearance of the first actionable segment linked and the initialization of the audio vocalization recording are synchronized, the live synchronous vocal text recording process begins. Each text segment is appears while it is being vocalized and recorded in audio; when the segment has been completely vocalized, the link is invoked, which causes the next linked text segment to appear, so it can be read out loud, vocalized and recorded. Each invoked text segment link records timing data. Thus, each segment of text is timed while it is concurrently vocalized.

All arranged text segments are vocalized and timed in sync with an audio recording. Every text segment is read aloud and recorded in audio data, and every text segment is timed in sync the corresponding segment of audio recording. Upon completion of vocalization of the final text segment and concurrent invoking of the final text segment link, all of the required timing data corresponding to the text segments and also the audio vocalization is known.

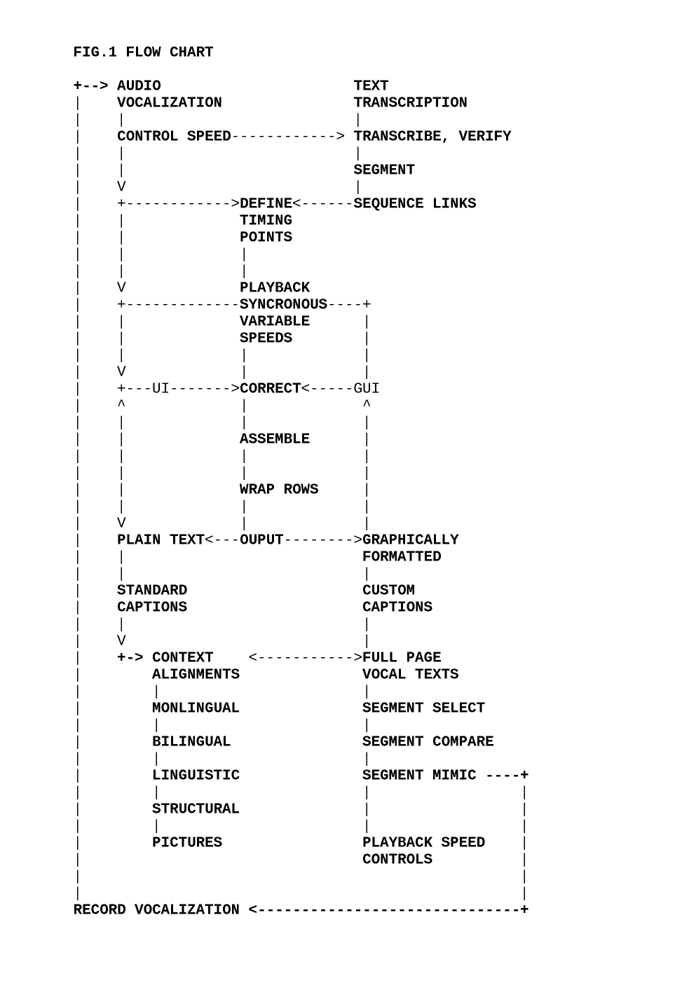

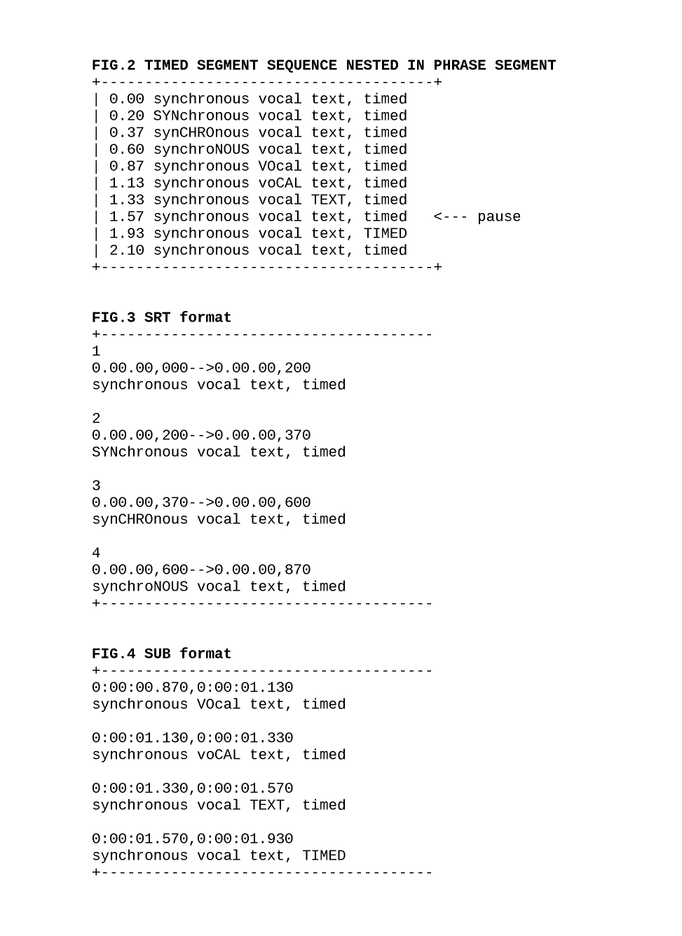

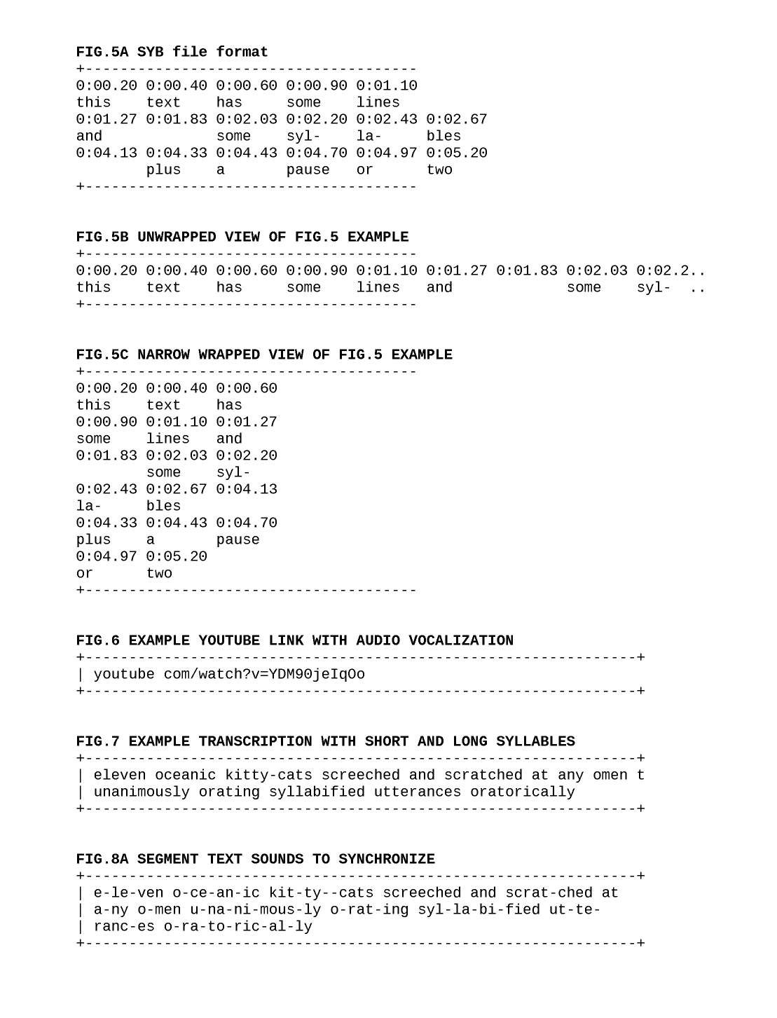

The recorded vocalization and the timed text segments are saved. With an audio recorded vocalization, and a set of text segments, and the individual timings for each text segment, and the corresponding timings within the audio recording, the basic data required for a synchronous vocal text presentation is known. Where this known data is stored in computer memory, it can be retrieved and processed into a wide variety of caption and text timing formats, including but not limited to the text timing formats illustrated in FIG. 2, FIG. 3, FIG. 4, FIG. 5A and FIG. 5B.

A customized file format is used to save the data. FIG. 5A shows an example of the customized format. Aligned above each text segment seen in the example, a variable timing data number is defined. The customized format allows multiple timings and corresponding text segments to be defined in two rows or lines of text, which are controlled in accordance with the preferred embodiments of the present invention.

Timing fields in the custom format are representative. The FIG. 14 represented format includes a field for minutes, another field for seconds, and another field for milliseconds. Ten millisecond accuracy is required to capture vocalization in fast speech. The formats as shown here are representative: they can be extended to include tens of minutes and hour timing information; they can be extended to include actual millisecond or one one-thousandth of a second numbers. What is relevant is that the timings and text segment information are aligned while placed on two rows of text; the two text lines can then be manipulated for human editing in a variety of text input scenarios, as described below.

Multiple lines, sentences and paragraphs are controlled. FIG. 15 shows an example transcription which contains multiple paragraphs, each with one or more sentences. To be synchronized with audio vocalization, the text is segmented, timed, and presented within customized timing format, as is illustrated in previous figures. To control the contents of the timings and text shown in the timing format, various tools are implemented.

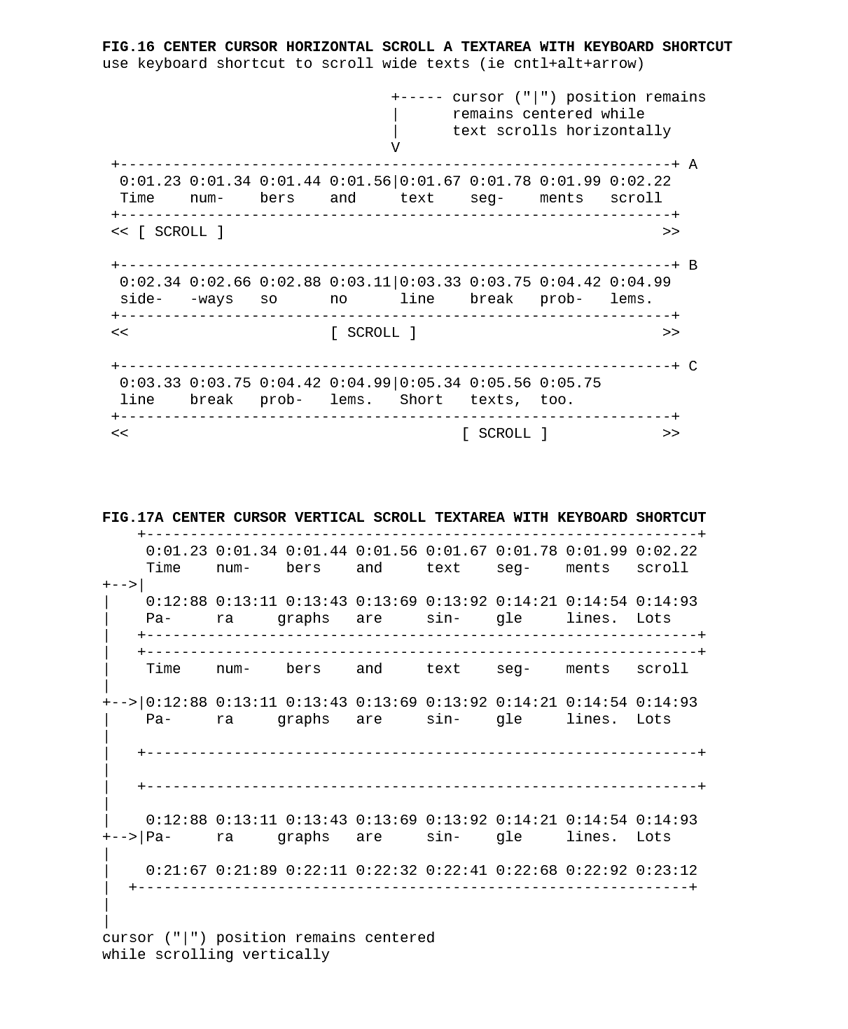

The cursor is centralized while scrolling horizontally. FIG. 16 represents a cursor remaining centered while text scrolls past it horizontally. Within the figure, a single line of text appears within a single textarea; the view of the single textarea is repeated three times to illustrate three separate states of the text contents within the textarea. The text contents are those from FIG. 15, which are now segmented within the textarea representations. Timing points are aligned above each text segment within the textarea representations. The timing format is consistent with that seen in FIG. 5A. Within each horizontally scrolling state of the textarea contents, the cursor, represented by the “I” symbol, remains constantly in the center. Thus, a human user can easily see the contents on each page, and quickly access any contents to edit.

The cursor is optionally centralized while scrolling vertically. FIG. 17A represents a cursor remaining centered while text scrolls past it vertically. Within the figure, a single line of text appears within a single textarea; the view of the single textarea is repeated three times to illustrate three separate states of the text contents within the textarea. The text contents are those from FIG. 15, which are now segmented within the textarea representations.. Timing points are aligned above each text segment within the textarea representations. The timing format is consistent with that seen in FIG. 5A. Within each vertically scrolling state of the textarea contents, the cursor, represented by the “|” symbol, remains constantly in the center. Thus, a human user can easily see the contents on each page, and quickly access any contents to edit.

Selections within a row continue across rowSet wraps and returns. FIG. 40 represents a customized format, where timings and segment context alignments are reduced in size and presented in different colors. The styling enables more information to be aligned with the vocalized text, while differentiating the appearances of the separate rows. Also represented in FIG. 40 is an illustration of another customization not easily achieved in common text areas. Within the timing row which is represented in the first, fourth and seventh lines, the coloration is inversed from the example 0:03.11 timing point through the 0:05.99 timing point. The inverse coloration represents a selected segment of text. In the illustration, it is evident that the selected text starts in the first line and is continued in the fourth line. As the figure represents a set of three rows being wrapped in accordance with the invention, it is clear that the fourth line is a continuation of the timing row information started on the first line.

Normally, within a non-customized textarea, it is not possible to select a row of text in continuation across a broken line, as a normal textarea will typically continue the selection upon the next line of text. Within a normal textarea, the selection show in FIG. 40 which begins at the timing point 0:03.11 would continue to select the next line, which starts with the “If the aligned row . . . ” text segment. Within the customized editor, the selection is controlled in rows, so that, as shown in FIG. 40, the contents of a row are controlled across line breaks.

Controlling row information across line breaks is useful when manipulating a selection of timing points and then adding or subtracting milliseconds to the selection set, as described in FIG. 17B. Controlling row information across line breaks is also useful when manipulating timing, text and context alignment in raw wrapped views show in FIG. 19, FIG. 31, and FIG. 39J. A customized textarea environment is used to control row information across line breaks.

Editable chunk translation control is enhanced. The customized format also allows, as seen in FIG. 40, an enhanced and editable preview of the final text presentation. Where in U.S. patent application Ser. No. 11/557,720 discloses such an editable preview, that previous disclosure required both the source text and the aligned chunk target text to be explicitly segmented. The method of including more than one or at least two (2) spaces between all alignable text segments was required within both rows. While this is useful in certain cases, for example to explicitly view the alignments and to correct errors, it is no longer a requirement.

In accordance with the present invention, the segmentation method of including more than one or at least two spaces between alignable segments can now be applied solely within the context or chunk alignment rows. When applied solely to the chunk alignment row, the segmentations of the original source text row can be easily found by various means, as shown in FIG. 35, FIG. 36, FIG. 37, FIG. 38, FIG. 39, FIG. 39A, FIG. 39NN, FIG. 39P, and FIG. 39Q.

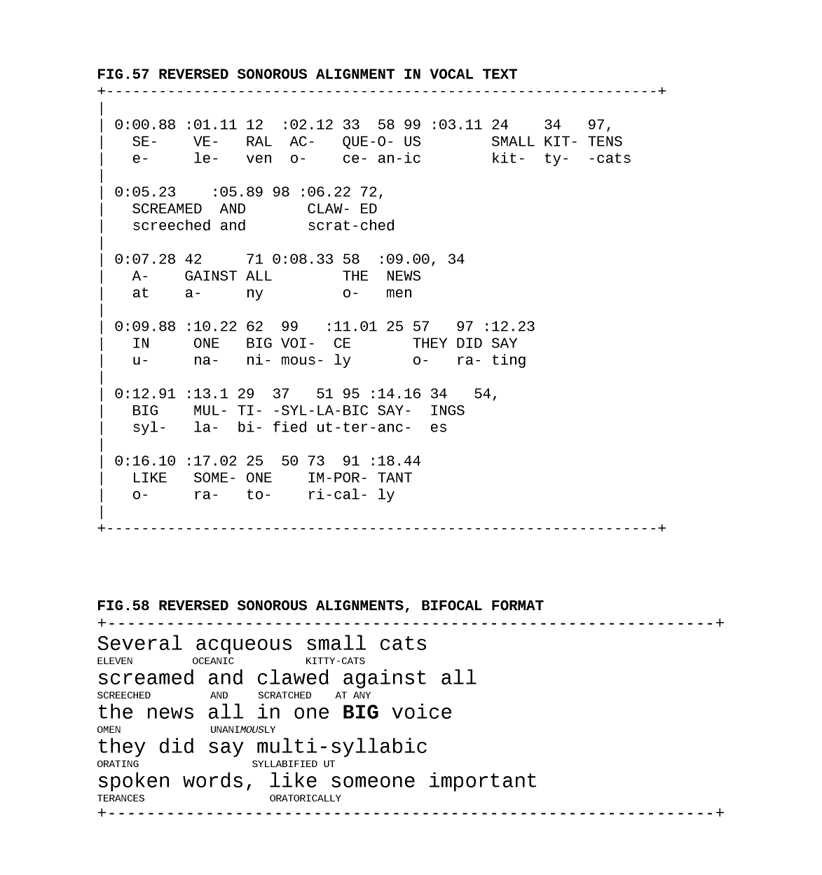

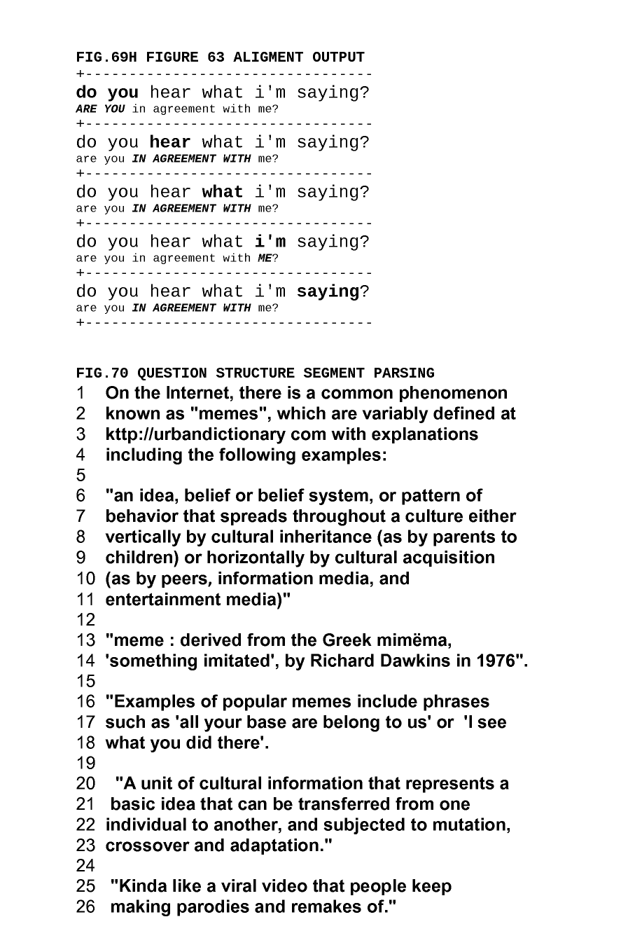

Rich Text and other formats, where styling can control monospace fonts to appear in variable sizes and colors, as is described in U.S. patent application Ser. No. 11/557,720, can now be used to format even more accurate editable previews, as seen in FIG. 39B, FIG. 39QQ, FIG. 40, FIG. 52, FIG. 53, FIG. 56, FIG. 57B, FIG. 58 and FIG. 63, where no unusual extra spaces appear between words in the original source text to which alignments are added. Without explicit addition of extra spaces between segments in the source text, alignable segmentation points within the source text are now known.

Error corrections are easily applied and saved. As described below, control of audio playback speed and also synchronized timed text speed allows timings to be carefully reviewed and precisely corrected. User edits are made with minimal effort. The corrections are saved and applied to be optionally viewed and controlled in the specified customized text timing format.

Further segmentations and synchronization are optionally defined and saved. As stated above, syllabic segmentation and live recording may not result in fluid vocalizations. A user can, however, easily record live synchronous vocal text which is initially segmented into larger chunks, such as phrases, short sentences and/or lyric lines, and then use the resulting pre-recorded audio to precisely specify syllabic segments and timings, as described below.

A recorded audio vocalization is synchronized with segmented text. If the previously recorded vocalization is already synchronized with larger segments of text, then the known timings are optionally applied to present the larger text segments in preview, while the syllabic and finer segmentation points are manually timed. If the previously recording vocalization includes no known timing information, then each segment is arranged in actionable series and synchronously invoked, as described above and below.

The audio recording playback speed is optionally reduced. The flow of vocalized language recorded in the audio data often proceeds at fast rates of speed. For example, an individual audible syllable may be vocalized within a time frame of one tenth of a second or less. The next audible syllable may also be quickly vocalized. It is not uncommon for several syllables to be vocalized within a single second. Human perception and physical reaction times cannot typically keep pace with the flow of vocalized syllables occurring at normal rates of speed. However, when the audio recording is slowed down, there is sufficient time for a human user to perceive the sounds and react to them by invoking the actionable text syllables as described previously.

The rate of reduction in audio playback speed may vary. Where the vocalization of syllables occurs at higher rates of speed, the audio playback speed is reduced by a factor of five to ten times slower. So, for example, a two minute audio recording are stretched to ten or even twenty minutes, to so allow the human to perceive and react to each audible syllable by touching, clicking or otherwise invoking the currently actionable syllable of text. Where vocalization of syllables occurs at slower raters, the audio playback speed is reduced by a factor of two or three times slower. In this case, a two minute audio recording is stretched to either four or six minutes.

Pitch within the reduced audio playback is adjusted accordingly. Reduction of the audio playback speed distorts the pitch of the voice vocalizing the language, resulting in an unusually deep baritone sound. This is corrected by adjusting the pitch in response to the rate of speed reduction. Such correction can make it easier for the human listener to perceive the sounds of each audible syllable vocalized, and then react as described above, to define the timing in-points and out-points for each correlated syllable of text.

The prepared text and audio playback are both started at the same time. Preferably, one single event invoked by the user launches both the display of the first actionable syllable of text, as well as the audio recording. Where this is not possible, synchronization of the mutual launching time can accurately estimated using a timing countdown interface, which delays launch of the actionable text series to coincide with the separate manual launching of the audio element. Where this is not possible, the synchronization are achieved with an external clock: for example the text timing are launched, then approximately five seconds later the audio playback are launched; since in these cases the text timings are out of sync with the actual audio recording timing, a method to adjust and synchronize the global text timings is provided for, and described below.

The controlled speed audio data is listened to. After the audio playback speed is reduced according to rate of text syllables contained per minute of audio data, a human user listens to the flow of audible language and has the time required to measure the timing in-points and out-points of each text syllable, so that the textual syllable can accurately be synchronized with the correlated audible syllable occurring within the time segment of the audio recording.

Each segment of text is timed in sync with corresponding audio data. As described above, with the text prepared into a series of actionable syllables, and with the rate of audio playback speed reduced to account for human perception and reaction times, the human can hear each syllable as it is vocalized, and touches, clicks or otherwise invokes each textual syllable, resulting in a recording of timing in-points and out-points for syllables of text which are synchronized with the timing in-points and out-points of the audible syllables vocalized within the audio recording.

The text timings are then adjusted to fit the normal audio playback speed. The speed reduction rate applied to the audio playback is then applied to the syllabic text timings, to convert the text timings to synchronize with the normal playback speed. For example, if the normal audio playback speed was halved, all of the text timings are halved. Or if the audio playback speed was reduced to 25% of normal, all of the text timings are multiplied by a factor of 0.25, or divided by 4.

Where needed, all text timings are adjusted to synchronize with the audio timings. As explained above, in cases where the text timing is launched separately from the audio playback, all text timings are adjusted to coincide with the audio timings. For example, if the text timings are launched five seconds prior to the start of audio playback, then subtraction of five seconds from all of the text timings will synchronize the text timings with the audio timing. Further controls to precisely synchronize the starting point for synchronous vocal text are provided for, as explained below.

The text syllables are now accurately synchronized with the audio syllables. Depending upon the skill of the human user, the playback speed rate reduction and the number of syllables per minute of audio data, the synchronization of text and audio syllables are quite accurate. Increasing accuracy of their synchronization and error correction are enabled by reviewing the syllabic synchronization of text and audio within an editable preview interface.

The segment and timing definitions are saved. The custom synchronous timing file format shown in FIG. 5 is used to store the segment and timing definitions within computer memory. Any variable DBMS database management system can be used to provide easy retrieval of the defined segments and timings. The data may easily be connected to a computer network, such as the Internet. Easily accessed, the segment and timing definitions are reviewed and easily corrected. Precise timing definitions result.

The saved timing data is variably formatted. To serve in variable captioning and timed text presentations, the defined text segment and corresponding timing data may be converted to standard caption file formats, such as the .SRT or .SUB formats illustrated in FIG. 3 and FIG. 4; a detailed description of the process is provided below. The timing data saved can be translated to any standard or custom timing format.

The synchronized syllables of text and audio are played back at normal speed. Each syllable appears in text while the corresponding vocalization of each syllable is heard within the audio playback.

The initial synchronization of syllabic text with audio is precisely controlled. With the addition or subtraction of tenths or hundredths of seconds to the entire set of text timings, the synchronization of text with sound is very precise. Further, by adding or subtracting fractions of seconds the all of the text timings, the text syllables are made to appear slightly before or after the actual vocalization of the corresponding syllable vocalized in the audio track.

The synchronized text and audio are played back at reduced speeds. To identify any errors made during the execution of interaction with the actionable series of text syllables, or the timing of the text, slower playback of the syllabic synchronization is helpful. The speed reduction rate may be less than the original speed reduction rate originally used to define the syllabic timings. For example, the playback of the syllabic synchronization of both text and audio are set to 50% or 75% or 80% of normal 100% playback speed. The speed reduction rate applies equally to both the text and audio timings. Thus, a human user can more easily identify and correct errors made in the original timing, and increase the precision of syllabic synchronization of captions.

Tap input rate can control reproduction length of each sound segment. Within special configurations, multiple finger user input described above can also be used to control the length of reproduction of each syllable. In such instances, segmentations are more precise; vowels and consonants are segmented within syllables; thus, while a finger maintains touch input upon an input mechanism, the vowel sound is extended. Thus, a user can control the experience of each sound.

Text timings are easily edited. As seen in FIG. 5A, the timing in-points for each syllable are presented within a simple text file, and manipulated in any common text editor, including the common HTML textarea input form used widely on the Internet. Each timing in-point also serves as the timing out-point for the previous text syllable. Thus, the redundancy of more error prone captions formats show in FIG. 3 and FIG. 4 are avoided.

A plain text file format is defined. FIG. 5A shows an example including six lines of text: three lines have timing numbers and three lines have text contents. Each line with numbers is paired with a line of text segments. The text contents are segmented into syllables. Each syllable is aligned with a corresponding timing definition. Within the sample illustration, a total of fifteen syllables are aligned with corresponding timing points.

Multiple rows with aligned columns are simulated. The alignment of timing points with corresponding text segments represents an array of data, which is contained upon at least two lines. One line contains timings; the other line contains text segments. Each timing field is separated by at least one empty space. The text segments are in alignment with the timing points. FIG. 5B represents the same array seen in FIG. 5A in an unwrapped state, where the complete contents are contained in only two lines. While the complete contents are known and available within the computer memory, they are unable to be completely seen in FIG. 5B due to the limits of horizontal display space.

No special formatting is required. Where data organized in columns and rows within spreadsheets is well known in the art, the alignment is commonly achieved with complex formatting applied to a plain text source file. For example, in HTML the <table>, <tr> and <td> tags are used. The resulting source text requires one view to control the data, and a separate view to review the final output. To include both the final presentation and the editable source in one single text, tables, rows and columns are known in the art. The appearance of rows of data with aligned columns is simulated by the management of empty spaces between row segments. However, there are no known methods to wrap the sets of rows, so that they may be continued in series upon lower lines in the same page.

The multiple rows with aligned columns are variably wrapped. To see and control the contents of the array, the twin lines are variably wrapped. As represented in FIG. 5C, controlled wrapping of the array maintains the alignment of the text segments with corresponding timing points within variable horizontal limits of text display. Thus, the array can be managed within variable widths of HTML textarea input fields, along with many other common text editing environments.

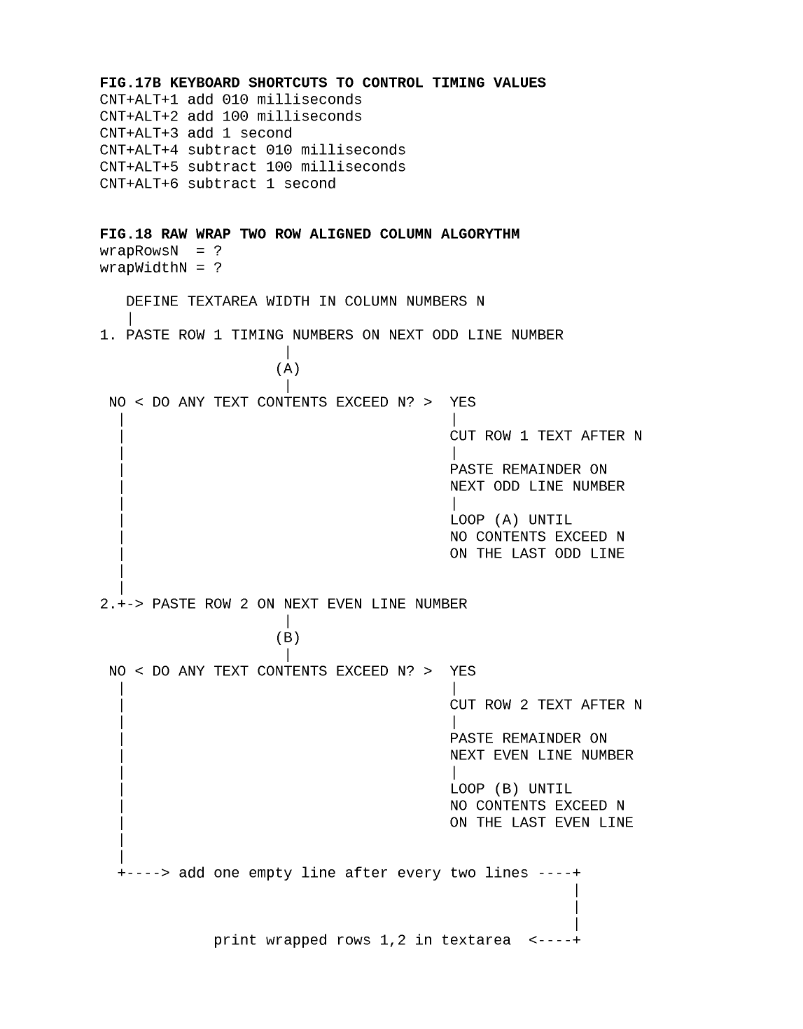

Monospace rowSets are wrapped. FIG. 18 shows a simple algorithm used to wrap two text row contents, in sequence, upon vertically arranged lines; thus, more of their contents may be viewed without the need to scroll horizontally. Within the figure, it is assumed that the font used in the textarea input is a fixed-font or monospace font, where each character has the exact same width. Accordingly, the number of monospace characters is set for the textarea input, and is used to measure and cut the rows if text arranged in aligned formats, such as those seen in FIG. 14, FIG. 25A and other figures showing two rows of aligned data segments. The FIG. 18 example is one of many possible and simple means to achieve the same effect: simple control of two rows of aligned data segments to be “wrapped”, or cut on continued upon subsequent lines.

RowSets are optionally wrapped “raw”. FIG. 19 shows a “raw” wrapped version of the FIG. 14 timing data. “Raw” wrap is used to signify direct interruption of any row at a variably defined number of textarea columns. Within FIG. 19, there is a set of numbers at the top of the figure. The numbers represent textarea column numbers. While using monospace font, exactly one character fits within each textarea column. The certain knowledge of how many monospace rendered text characters, including empty spaces, are contained in any row of information allows that row to be aligned with other rows rendered in monospace characters. The FIG. 19 example results from the FIG. 14 timed segments after processing by the FIG. 18 algorithm. The row of timing information and the row of text information are equally cut and then continued upon lower lines of the presentation. This method to wrap the twin lines is extremely simple and effective. However, there are inconveniences causes, such as the interruption of a timing value. It many cases, it is preferable to alternatively control the points to cut rows and resume them upon subsequent lines.

Columns and rows are aligned in plain monospace text. FIG. 20 shows the FIG. 14 data aligned in columns and rows, as is customary with spreadsheet presentations and other displays of arrayed data. Every segment and corresponding timing value is aligned with a sequentially numbered column. The timing values are sequenced in row one, while the text segment strings are sequenced in row two. An important difference between commonly used spreadsheets and the current example, however, is that the present invention obviates the need for complex table formatting: the use of monospace text, which is predictable in width, and the management of the number of empty spaces between text segments both allow the present method to render rows with columns maintaining alignment when continued in series upon subsequent lines. Where spreadsheets require complex formatting, the present invention controls the alignment of columns and rows using plain text.

RowSet segments are aligned. The FIG. 20 example represents the rows aligned with columns as is customarily done in spreadsheets: the aligned information spreads wide, beyond the horizontal width limitations of the present medium of display. As will be demonstrated below, multiple rows are controlled as a set where, as if a single unit, they are cut at the limit of a variably defined display medium width and continued upon subsequent lines, while insuring that all of the columns remain perfectly aligned.

Aligned segments are numbered in an array. FIG. 21 show the FIG. 20 information represented in a simple one dimensional data array. The column one, row one timing value of “0:01:64” is first represented as the number ‘101’; immediately thereafter, the row two, column one text segment string, “e-”, is also represented as the number ‘101’. The two representative numbers are joined by a colon. The “101:101” array representation of the data is easily referred to and controlled by computer programs and algorithms. The contents each aligned segment are represented by numbers and controlled in an array.

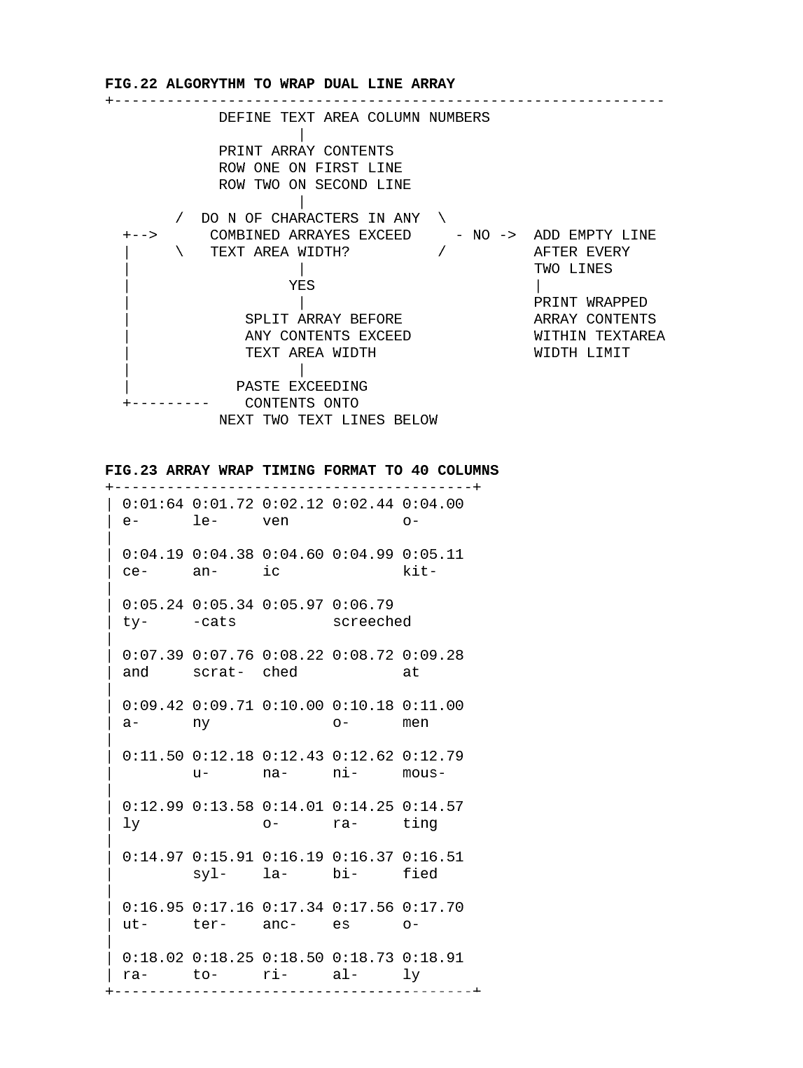

“Segment” wrapping insures no segment contents exceed a defined width. Assembled array contents do not exceed a defined variable width. FIG. 22 shows a representative algorithm to apply the FIG. 21 array to wrap data aligned in two rows. The program performs simple arithmetic to find which, if any, array contents exceeds the specified width limitation. Upon finding such contents, the program simply splits the array at that point, and resumes the display upon subsequent lines beneath. It does not matter which row has contents which, when added to previous row contents contained in the array, sum a total in excess of the character width limit; it could be the text segment row or the timing value row; the program simply starts a new line to resume both rows, in perfect alignment. The same result can be achieved with other algorithms; what matters is that a simple program can be used with an array to interrupt the presentation of aligned columns within rows, and then resume the presentation aligned columns in rows upon subsequent lines.

RowSets are wrapped; columns remain aligned. FIG. 23 shows the FIG. 14 text with both rows wrapped while column alignment is maintained. The timing values and text segment strings are complete; unlike the simplistic multiple row wrapping achieved in FIG. 19, the FIG. 23 strings and values can be seen completely and edited easily. Longer segments such as word “screeched” are easily handled by use of the array; it doesn't matter which row element within a column crosses the textareaWidth limit: both rows are resumed cut at that column number, then resumed on subsequent rows, with alignment maintained.

Aligned rowSets are wrapped in variable widths. FIG. 24 shows the FIG. 23 text rows wrapped to a wider textareaWidth; where with FIG. 23 the rows are cut before any column contents exceed a textareaWidth of 40 characters, in FIG. 24 the textareaWidth is 60 characters. More information can now be seen in less vertical space.

RowSets can be used to align sound segments with timing points. Synchronous alignment of associated text segments, in accordance with the present disclosure, is controlled in sequence upon a series of lines, and within variable widths of horizontal display. While not required in all use cases, the core synchronization is made between timing values and syllabic text segments.

RowSets can be used to align contexts with various transcription segments. FIG. 25A shows another useful form of data alignment: contextual texts are aligned with segmented source text example copy of the same text represented in FIG. 7. Similar to FIG. 14, and FIG. 20, the representative FIG. 25A text shows corresponding data segments visibly aligned within two rows of text; the four separate figures also share the characteristic of representing long lines of text that are unwrapped. However, in FIG. 25A neither row contains numbers of timing data; both rows contain string segments. The first row contains sequential segments identical to the FIG. 7 example text; the second row contains context words aligned with each segment; in this example, the context words are expressed in the same language as the original text and used to convey, with simpler words, the meaning of the segments used upon the first row.

Aligned contexts can be “raw” wrapped within width limits. FIG. 26 shows the result of the FIG. 25A text after application of the FIG. 18 algorithm. Both rows, including the original text segment row and the aligned context row, are presented. Their contents are completely visible. The alignment of the context words with the original text segments is maintained while the rows are interrupted then continued upon multiple lines. However, as in the FIG. 19 illustration, words within the original text and also the aligned contexts may be interrupted; corrected spelling errors or changing the contents, in such cases, in not convenient.

Aligned contexts can be “segment” wrapped within width limits. FIG. 27 shows the FIG. 26 text wrapped without words in either row being cut or otherwise unusually interrupted. The segments are presented completely upon single text lines and are thus easily edited. The two rows of aligned segments are broken normally, as one would expect with line breaks in text, and continued upon the next lines, while maintaining alignment. The result seen in FIG. 27 is achieved with the exact same methods described in FIG. 20, FIG. 21 and FIG. 22.

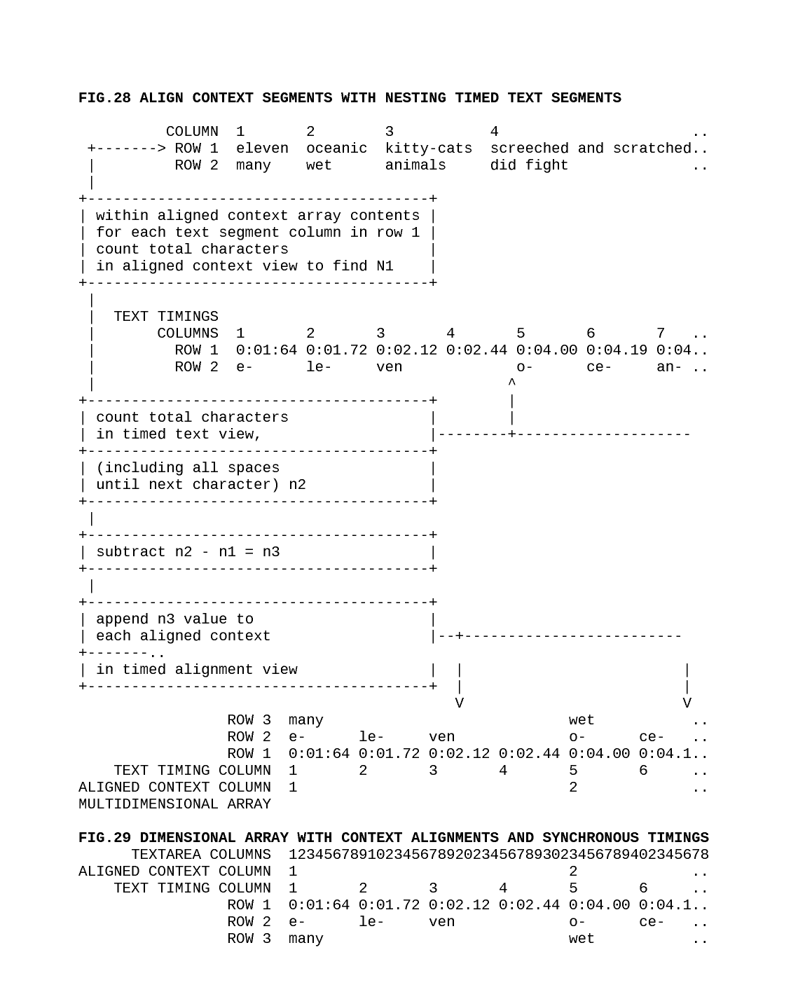

Syllabic timings and phrasal contexts can be concurrently aligned. FIG. 28 shows one method to align both syllabic timings and also segment contexts; in this case, the segment contexts are not represented as same-language syllables, but rather as analogous translations in another language; the segment contexts are aligned with larger text segments in the original texts, while the syllabic segments are aligned with timing points. At certain positions, all three rows have aligned columns. This can be achieved simply by counting the extra spaces and syllabification characters added to each segment, then subtracting the sum of characters used to normally represent the segment, then adding the resulting number of empty spaces after the segment. This can be useful in cases where the combined timing and context rows are manually edited.

Numbers of syllabic, phrasal and textarea columns are controlled. Three sets of segmentation numbers are controlled. FIG. 29 shows a representation of an array that is similar to the array represented in FIG. 20 and FIG. 21. But the FIG. 29 has an added dimension of a separate set of alignment columns, as well as an extra row. The extra set of alignment columns define larger text segments, within which syllables are timed to appear nested within larger words and phrase, and also within which context segments such as synonyms, pithy commentary or translations are aligned.

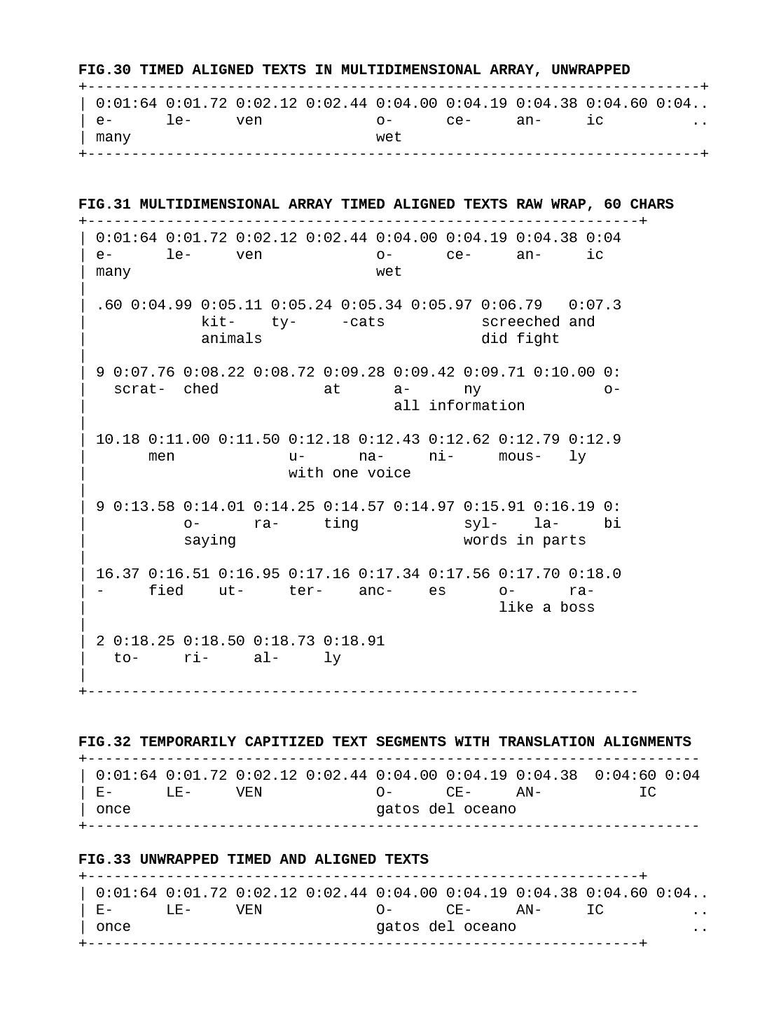

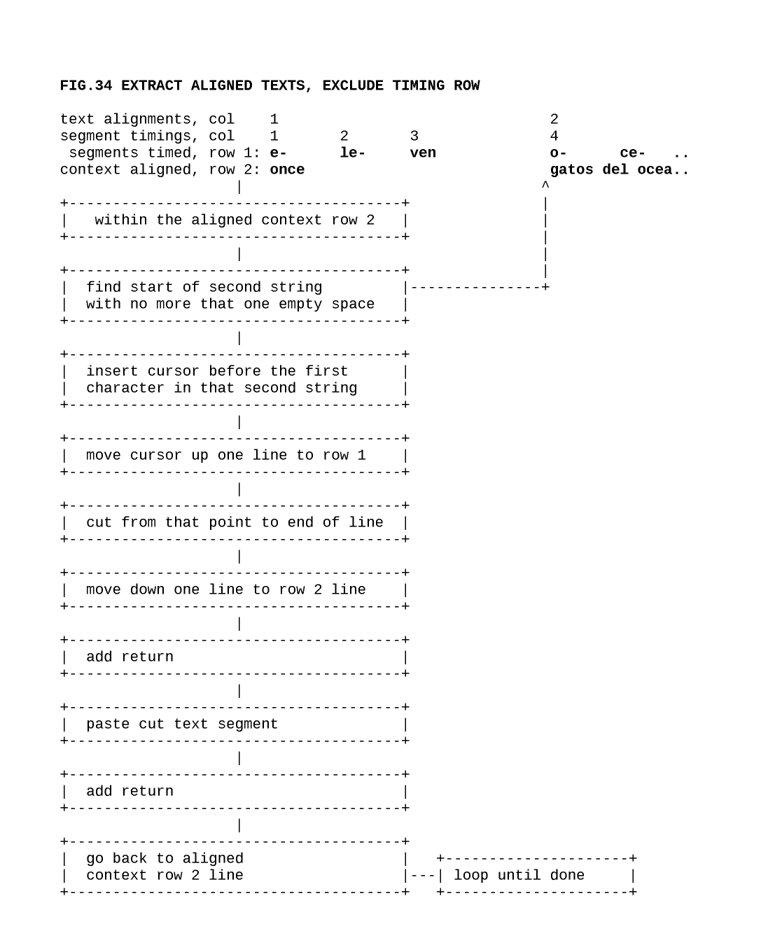

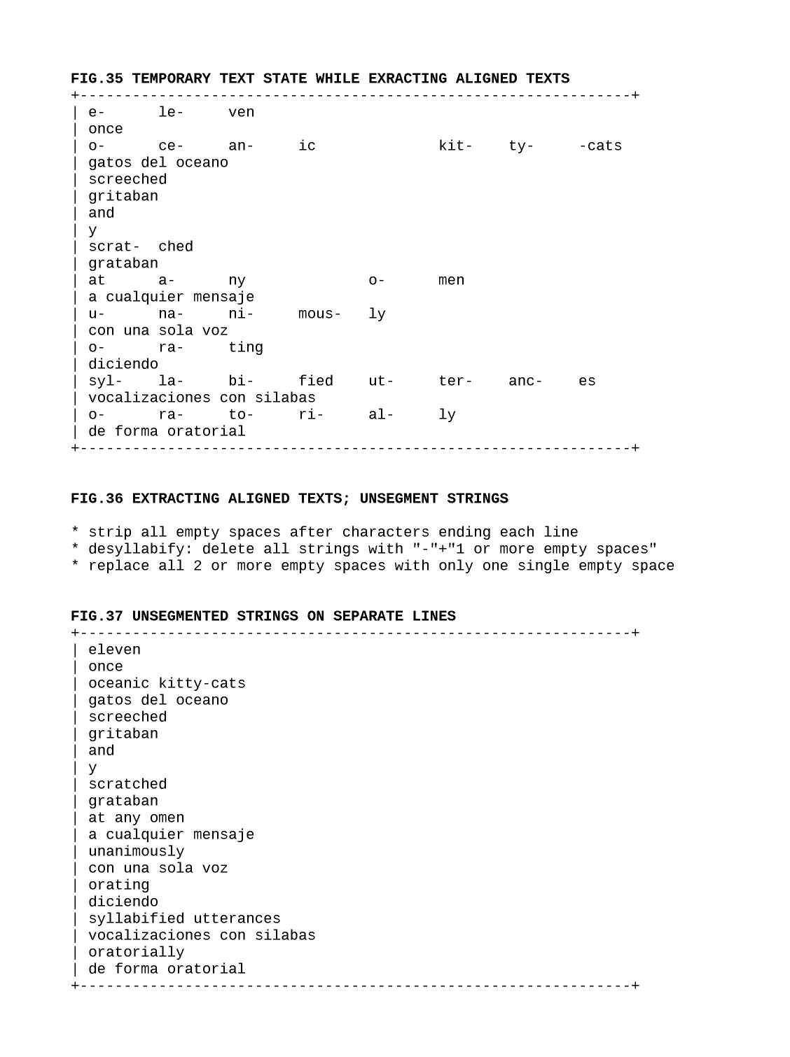

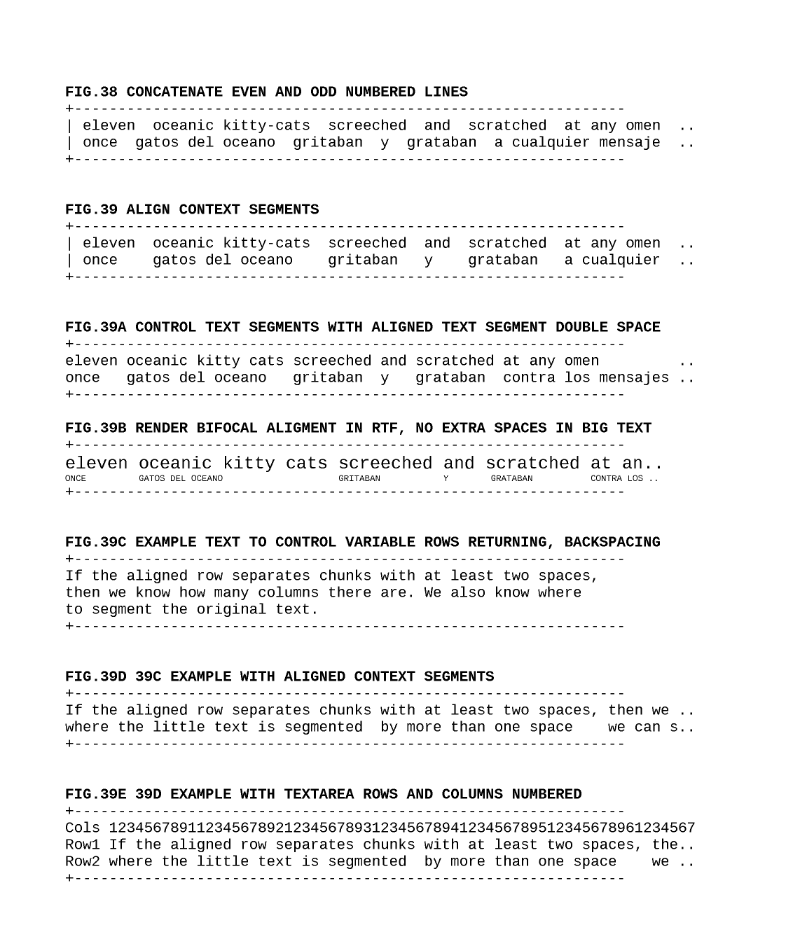

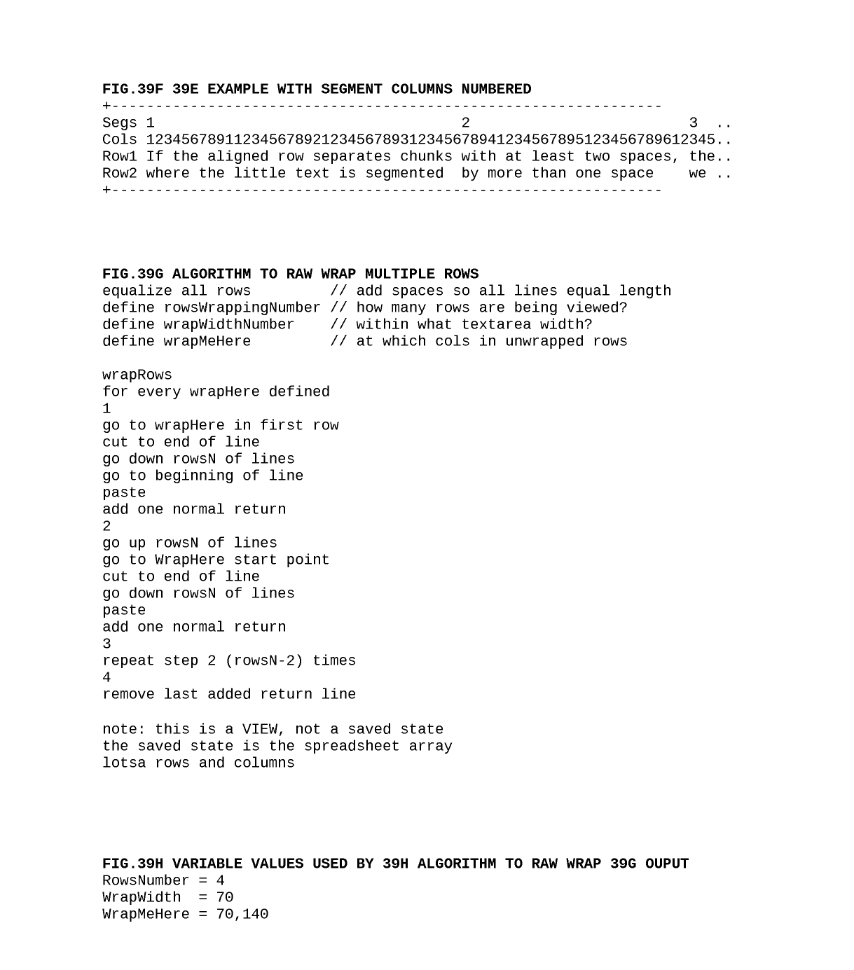

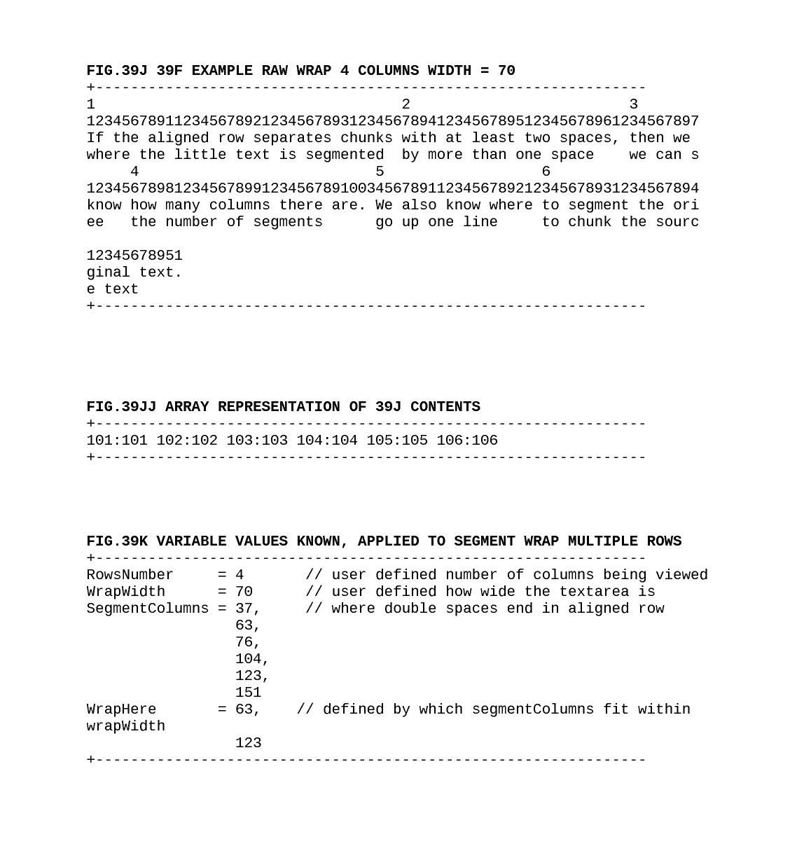

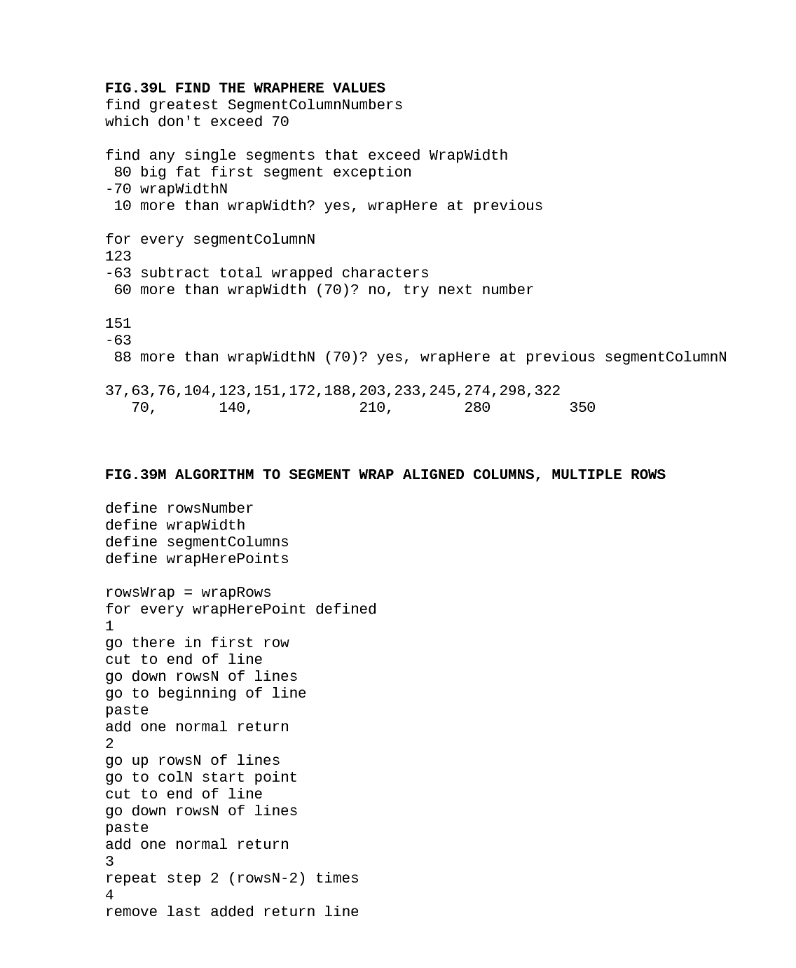

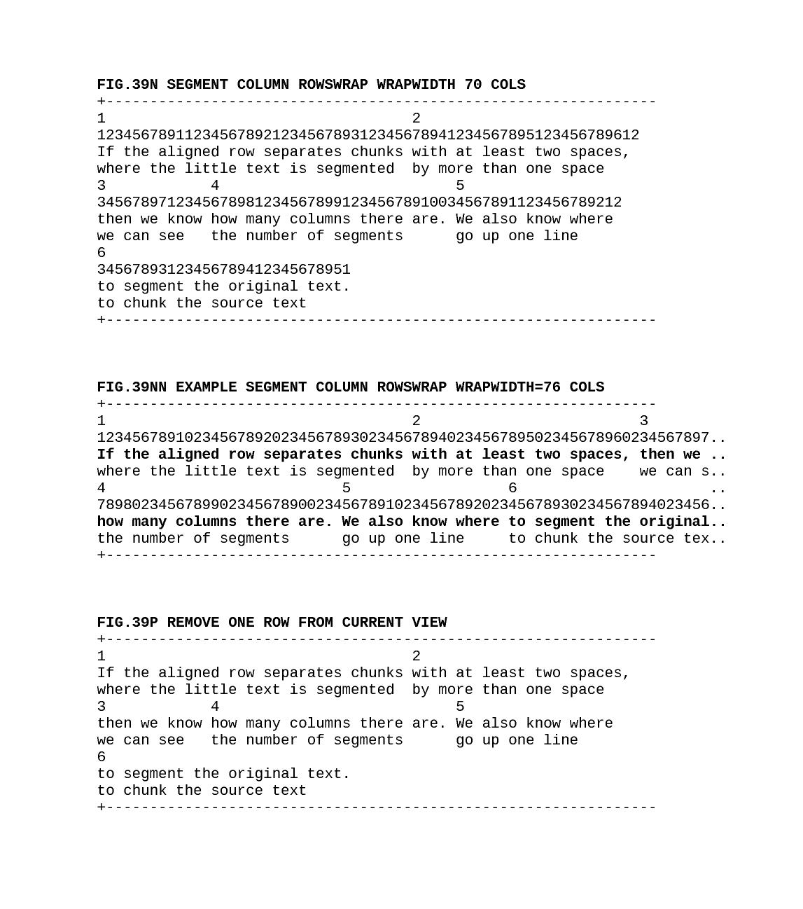

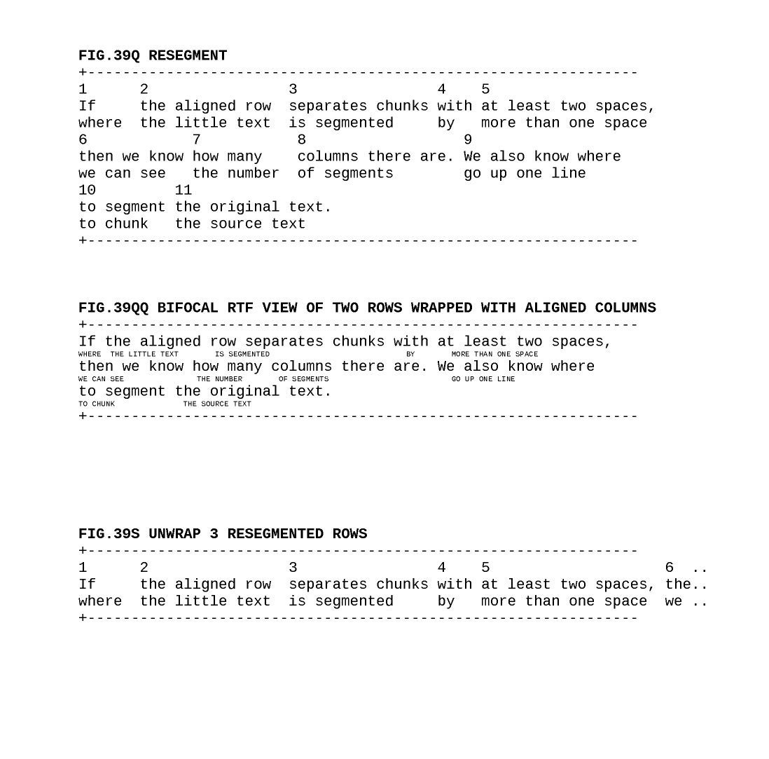

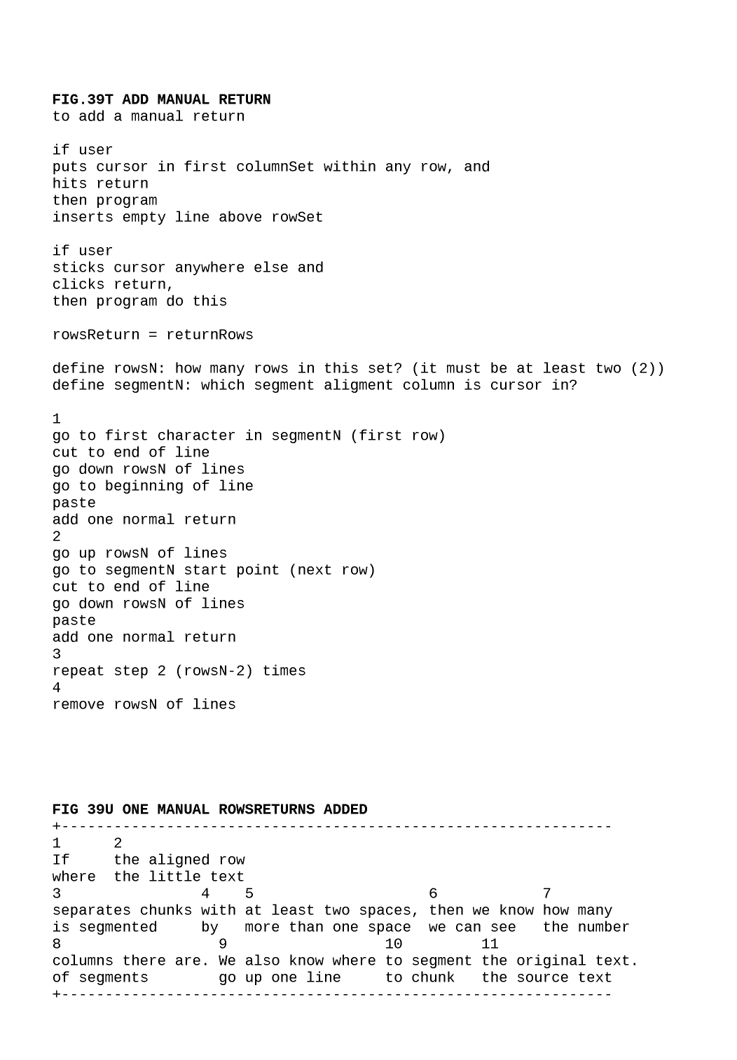

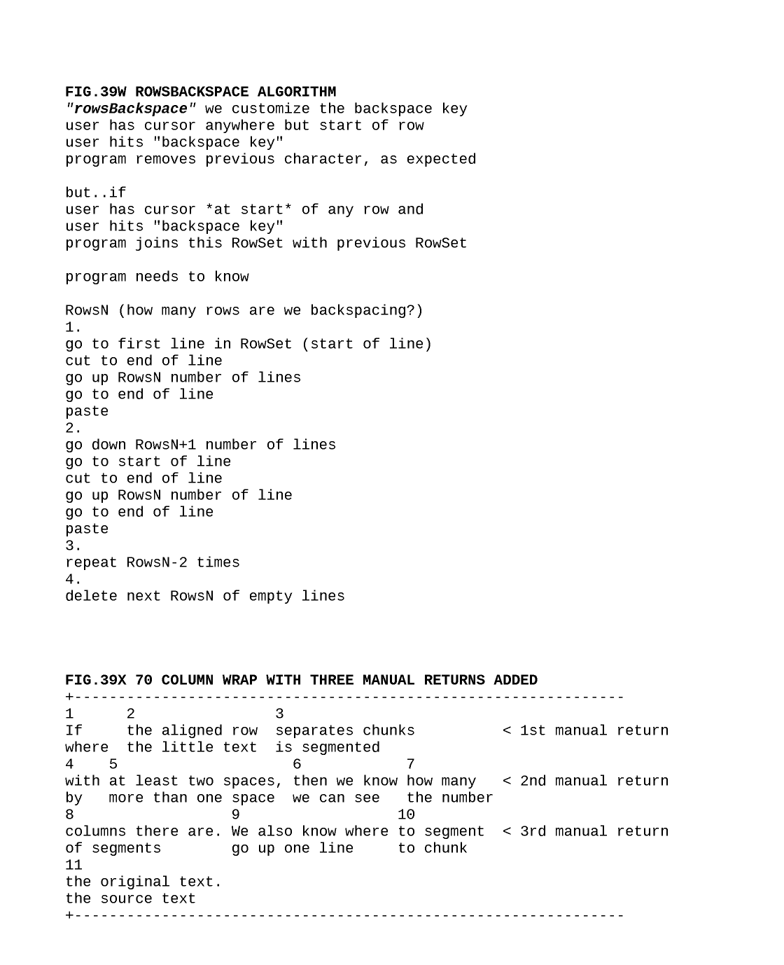

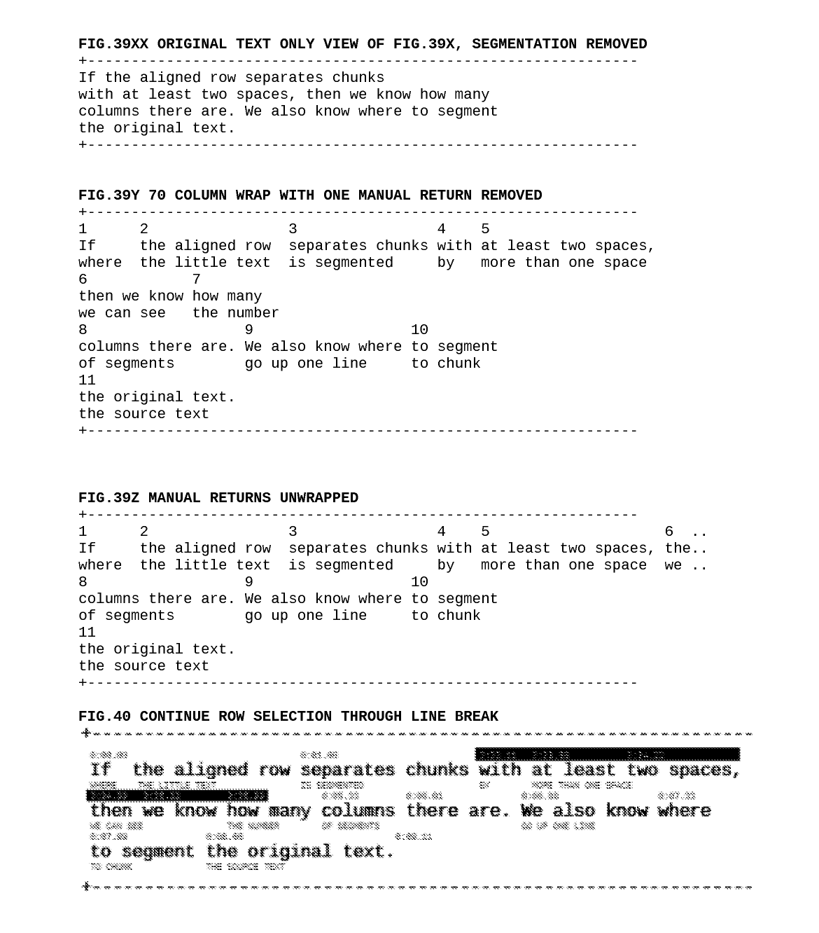

Multiple rows may be included in a rowSet. Timings are aligned with transcription syllables; transcription phrases are aligned with context segments. FIG. 30 shows the multidimensional array from FIG. 29 represented in text, without explicit identification of arrayed rows and columns. The three lines of text are not wrapped. As with all other representations of unwrapped text illustrated within the drawings, the entire contents held within the line are unable to be shown. While the contents can be effectively managed within textarea inputs using controls defined in FIG. 16 and FIG. 17A, where horizontal and vertical scrolling are achieved with a centrally located cursor, the entire contents can also be viewed after application of multiple row column alignment text wrapping.

Multiple row rowSets may be wrapped “raw”. FIG. 31 shows a simply wrapped, triple row text with two separate sets of columns maintained in alignment. The technique used is similar to the technique represented in the FIG. 18 flow chart. In this case, the source text does not need to be contained within an array; the rows are simply interrupted at the defined textareaWidth, and then continued below. Where the FIG. 18 algorithm placed each row on even and odd lines, the three row technique simply places each row as follows: the first row is continued on lines one, four, seven and so on, the second row is contained and continued on rows two, five, eight and so one, while the third row is contained and continued upon rows three, six, nine and so on. After the rows are wrapped while columns remain aligned, spaces may be added between the three rows in improve legibility. As with the texts wrapped in FIG. 19 and FIG. 26, the timing values may be rudely or unusually interrupted, which causes inconvenience while their contents are being edited.

The rowSet can be wrapped “segment” wrapped, at segmentation points. FIG. 32 shows the same three row text as FIG. 29 and FIG. 30, wrapped to the same 60 character width limit. As with FIG. 23, FIG. 24 and FIG. 27, the timing values are never interrupted arbitrarily by line breaks. The values can be easily edited. In FIG. 31 and FIG. 32, two separate sets of alignments are consistently maintained. In FIG. 33, the alignment can be achieved with a relatively character counting technique similar to others described within this disclosure. Preferably, the array technique described in is used and described in FIG. 20, FIG. 21, and FIG. 22. In the case of FIG. 32, any timing number or text segment which, when added to the total characters in each respective row, exceeds the textareaWidth defined, then the array of all three rows is split at that column number, and the row contents are continued upon subsequent lines.

Temporary uppercase in the transcription row can be applied. To distinguish a row's contents, all letters in a row can be forced to appear in uppercase letters or “ALL CAPS”. In the preferred embodiment, this is applied as a temporary view, without affecting the saved state of the row contents. An example of temporary uppercase used in the transcription row is seen in FIG. 32. FIG. 33 shows an unwrapped text version of the contents in FIG. 32. Note that unlike FIG. 31, the text syllables in FIG. 32 and FIG. 33 are rendered in uppercase letters; this can optionally be included within a temporary view, to apply more visual distinction between the syllabic text segments with respect to the aligned context words.

Same-language synonyms, restatements and other contexts may be aligned. FIG. 32 and FIG. 33 also vary from FIG. 31 in that the aligned contexts are not same-language synonyms but rather translations in a foreign language. As described elsewhere in this disclose, the context words included are open to variable interpretations; meanwhile there is little or no doubt as to the definitions of the synchronous vocal text segments.

Separate segmentations and alignments are controlled in a single source text. As seen in FIG. 30, 31, 32, 33, two separate sets of segmentation within the transcription text are controlled; smaller syllabic segments are defined, while larger phrasal segments are also defined. Two sets of alignments are also controlled; timings are aligned with syllabic segments and context phrases are aligned with phrasal segments. Further segmentations and alignments are also controlled, as is disclosed below.

Aligned context segmentations delineate transcription text segmentations. As described below, methods are used to apply the segmentations and alignments within a context row to delineate a corresponding and independent segmentation in the original text transcription row.

Timing points and syllabic segmentation can be removed. FIG. 34 shows a method to exclude the timing information from the text represented in FIG. 33, while excluding the nesting segmentation information, to result in a simple view of precisely aligned text. This method is can be used to reduce the volumetric rate of available information, to thus enable a user to focus solely upon the text and context alignment information. So long as aligned context information segments maintain a minimum of two (2) spaces between each segment, and so long as the context information is manually aligned with the original text segment, the FIG. 34 algorithm can be used to initiate the process to simply view contexts aligned with segments of text.

Untimed printed chunk translations can be produced. The FIG. 34 algorithm is also used to control alignments and array definitions in any segment aligned texts, formatted in accordance with “Bilingual, bifocal texts” described in U.S. Pat. No. 6,438,515 and aligned in accordance with the “Aligning chunk translations” disclosure in Publication No. US-2011-0097693-A1. Where in the previously disclosed alignment methods, at least two spaces were required to identify corresponding chunks in both the aligned translations and also in the original text, the FIG. 34 algorithm can be used to find alignments where the original text has no unusual extra spaces required. This is of particular use in RTF enable textarea inputs, with row returns implemented as specified in FIG. 39QQ.

Untimed chunk translation alignment can be produced using optional methods. FIG. 35 shows a temporary text resulting from the process initiated and illustrated in FIG. 34. Each original text segment is temporarily held above its corresponding translation segment. FIG. 36 shows three steps applied to the FIG. 35 text; the steps restore the syllabified segments to normal text strings, where words are separated by a single empty space. FIG. 37 shows a temporary text resulting for the process described in FIG. 36. Each original text segment appears as normal, unsegmented text above each corresponding context string. Each original text segment appears upon an odd numbered line, while each corresponding context string appears upon an even numbered line. FIG. 38 shows temporary text from FIG. 37 unwrapped into two rows: one row contains all the original text segments extracted in sequence from the odd-numbered lines and then concatenated upon the first line, while the second row contains all the context words extracted in sequence from the even-numbered lines then concatenated upon the second line. FIG. 39 shows the temporary text from FIG. 39, now presented where each segment of original text in perfect alignment with each segment of associated context. The text can easily be arrayed into two rows with 10 aligned columns ordering them.

Editable previews of chunk translations can be managed with a single space between the words of the original text, so long as the aligning text segments are separated by two or more empty spaces, and so long as the aligning text segments are properly aligned with original text segments. FIG. 39A shows the FIG. 39 text with a minimum of two spaces between each separated segment of aligned context text; where the context segment has fewer characters than the original vocalized segment, the original source text is not visibly segmented. However, where any segment of aligned context text has more characters than the original source text segment, extra spaces are added between segments of the original text. In the first line, note the extra spaces between the words “omen” and “unanimous”. FIG. 39B shows the FIG. 39 text formatted in Rich Text Format, with the aligned context text presented at 50% or one half the size of the original text. There are no unusual spaces between the words of the original text. Spaces are managed in the smaller text in order to align the contextual segments with segments of original text.

RowSets may include three or more rows. Wrapping controls of twin row rowSets is disclosed above. RowSets with three or more rows is also controlled, as described below. Control of multiple row rowSets is applied to align multiple forms of data with varying transcription segments, as is also described below.

RowSets are manipulated as single units. Minimal user effort, such as one stroke applied to the “return” key upon a keyboard, is applied to control selections, cuts, copies, cursor positions and pastes in each row within a rowSet, according to defined algorithms, to present the rows continued in a logical and sequential series upon subsequent lines. RowSet wrapping, rowSet backspaces and manual rowSet return functions are provided.

A representative text can be controlled as follows. FIG. 39C shows an example text which will be used to illustrate text wrapping controls which are applied to rows of related texts, while maintaining alignment of columns. The FIG. 39C text will be variable segmented and aligned with timing and context information, and then series of rows will be wrapped to fit within horizontal page width limitations.

A restatement or other context row is aligned. FIG. 39D shows the 39C text example aligned with restated context information. The entire contents are not visible, as the 39D example represents the text as unwrapped; the lines represented are known and recorded in the computer memory, but displayed at a width that is greater than the display medium.

The number of textarea columns is known. FIG. 39E shows the 39D example with one row added to illustrate the columns in the textarea; For every character within a single row of text, there is a precisely aligned column number. For example, in the “Row1” row, the word “two” in the phrase “two spaces” begins at textarea column number 51; in another example, within the “Row2” row, the word “by” begins at textarea column number 37. Coincidentally, the word “with” in Row1 also begins at textarea column number 37. Within Row2, column numbers 35 and 36 have no contents, other than empty spaces. Since there is more than one empty space, the system recognizes this as a aligned context segmentation. Since the word “by” is perfectly aligned with the word “with” above it, the system applies this segmentation to the Row1 line as well.

The number of aligned phrasal segments is known. FIG. 39F adds a “Segs” row to the 39E example, to illustrate the demarcation and enumeration of phrasal segmentations. The phrasal segmentations are found wherever two or more spaces appear with the aligned context row.

A multiple row rowSet can be wrapped raw. FIG. 39G shows an algorithm used to wrap two or more rows while maintaining perfect alignment of the columns seen and used in the FIG. 39E example. To prepare the rows for wrapping, each row in the set of rows must be exactly the same length; all empty spaces after row contents are removed, then empty spaces are added to shorter rows; when each row is the same length, having the same number of textarea columns, then no more spaces are added. Next, the program defines the width limit of the wrapping. Next, the program identifies the textarea column numbers as which the rows will wrap.

The algorithm is executed with a repeating series of two basic steps. One, the first row is wrapped. Two, the row below that is wrapped. The two steps are repeated for each row being wrapped, and then the program removes one extra added line return. In step one, the program defines how many rows will be wrapped. The program then moves the cursor down one line for every row being wrapped, then at the beginning of that line pastes the copied contents. The program adds one single return.

In step two, the program goes up one line for every row being wrapped, then within that row inserts the cursor precisely at the column number where the previous row was wrapped, copies and cuts the remainder of the row contents, moves done one line for every row being wrapped, then pastes the copied contents at the beginning of that line, and then adds one single return.

Step two is repeated once for every number of rows being wrapped. If only two rows are being wrapped, the program removes the final added return and exits. If three rows are wrapped, step two in repeated twice. If five rows are wrapped, step two is repeated three times. Upon completion, the final return is removed, and then the program exits.

A “WrapMeHere” set of variable numbers is defined. FIG. 39H shows an example of variable values needed to execute the FIG. 39G algorithm. First, the number of rows must be defined. This variable may be called any name, such as RowsNumber or RowsN. In 39J example, there are four (4) rows being wrapped. The 39G program also must define the width of the textarea or limited horizontal column display. This variable may be called any name, such as WrapWidth. In this example, the variable width is defined as “70” for seventy (70) textarea columns. Thus, the program knows that four rows will be wrapped at seventy textarea columns each. To define the points where each row will be wrapped, the program defines how many textarea columns are required to display the row contents, which in this case is 151 textarea columns, then divides that total by the WrapWidth value, which in this example is 70. The program defines the set of numbers where the rows will wrap. This variable may be called by any name, such as WrapHere or WrapMeHere. In this case, the set of column numbers defining where to wrap includes two numbers: 70 and 140.

Words may be interrupted when wrapped raw. FIG. 39J shows the FIG. 39F example “raw” wrapped. The four rows identified and used in the 39G algorithm are now wrapped in lines that are seventy (70) textarea columns and characters, including blank spaces, wide. The method is described as “raw” because where the wrapping or line breaks occur, words and text segments may be unnaturally cut; for example the word “see” is interrupted after the “s”, while the remaining letters “ee” are continued on a lower line. Raw wrapping has utility in that the maximum amount of information is presented upon each line; however, the interrupted words are not always preferable. Rows can also be wrapped at segmentation points, as follows.

Aligned segments are optionally controlled in an array. FIG. 30JJ represents and array of the 39J example. Segments associated with the defined segment column number are numbered and controlled in an array. Where assembly of arrayed contents upon a line adds up to a number that exceeds the WrapWidth variable, the rowSet is wrapped at that segmentation point. Thus, if contents in one row exceed the WrapWidth variable, the WrapMeHere variable is defined and all rows are wrapped there, as a single unit.

Multiple row rowSets can be “segment” wrapped. FIG. 39K shows the FIG. 39H variables with a different set of points defining where to execute the wrapping of each row. In FIG. 39L, the WrapHere points are defined at 63 and 123 textarea columns. A new set of variables is introduced: the textarea column numbers where aligned segments begin is defined. The variable can have any name, such as SegmentColumnNumbers or SegmentColumns. As there are six segments within the FIG. 39J example, there are six SegmentColumnNumbers defined: 37, 63, 76, 104, 123 and 151.

WrapMeHere variable values are found. FIG. 39L shows how the FIG. 39K WrapHere points are found. The WrapWidth limit is defined as 70 textarea columns, but in order to maintain complete segments, the actual wrapping occurs before any complete segment exceeds the 70 textarea column per line limit. The program finds the greatest SegmentColumnNumbers within multiples of the WrapWidth limit. In this case, the numbers are 63 and 123.

Multiple rowSet wrapping is executed. The required variables are applied in an algorithm. FIG. 39M shows an algorithm used to wrap multiple rows of aligned columns with segments intact. It is identical to the FIG. 39 algorithm, but the SegmentColumns are defined and the WrapHere points are different, as explained above.

RowSet wrapping can occur at defined segmentation points. FIG. 39N shows the example text wrapped to the 70 textarea column WrapWidth. No words or segments are unnaturally interrupted as seen in the FIG. 39J raw wrap example. While each line is shorter in length, and while the lines do not completely fill the horizontal width of the textarea, the text reads more naturally. FIG. 39NN shows the FIG. 39N example wrapped to 76 columns.

A row can be removed from a rowSet view. FIG. 39P shows the FIG. 39M example with one row removed. The figures shows 9 lines of text, representing three rows wrapped within a 70 textarea column limit. Six segmentation columns are shown. All the contents maintain perfect alignment in columns.

The segmentations can be edited. FIG. 39Q shows the FIG. 39P example resegmented, with five new segmentation columns included, creating a total of 11 aligned segments. The 3 rows are shown on 9 lines, wrapped within a 70 textarea column limit.

Normally spaced text can be aligned with translations, restatements and other such information. FIG. 39QQ shows the FIG. 39Q example formatted in Rich Text. The aligned translations are 50% or one half the size of the original text. The original text appears naturally, without extra spacing between words, and without unusual interruptions where the line breaks appear.

A single carriage return is applied to an entire rowSet. FIG. 39T shows an algorithm which enables a return, when applied within a segment in a row, to execute multiple returns which control the complete set of rows. Thus, all the rows are continued in an orderly sequence upon subsequent lines. In effect, the set of rows behave as if they were one single line; if a return is entered within a segment, a manual wrapping of the all the rows occurs at the defined SegmentColumn point.

The function can be named ReturnRows or RowsReturn or another such name. The function requires variables to be defined. The variables include the number of rows to wrap; the number of textarea columns needed to present the contents; the number of segments aligned and the specific segment within which the return is being applied.

The cursor may be anywhere within the segment, except at the very end of the segment, in which case the function is applied to the following segment. When the cursor is otherwise within a segment and the return key is hit, either alone or in combination with another key such as the ALT key, the program performs two key functions.

In the first step, the program finds the first character in the first row of that segment, inserts the cursor, selects all the text from there to the end of the line, then copies and cuts that text. For every row being wrapped, the program moves the cursor down that number of lines, then goes to the beginning of that line and pastes the copied text, and then adds one normal return, which creates an entirely empty line below the pasted text.

In the second step, the program then moves the cursor up one line for every number of rows being returned, and then places the cursor at the start of the segment column number which is in the process of being returned. Again, the program copies and cuts from that point to the end of the line, moves the cursor down one line for every row being returned, then pastes the copied contents, and then adds one return, creating a new empty line.

There must be a minimum of two rows when executing the RowsReturn function. If there are more than two rows being returned, then the program repeats the second step once for every number of rows being returned. Thus, if there are only two visible rows being returned, the program has completed the task. If three rows are being returned, then the second step is repeated once more.

After each of the rows has been returned at the precise segmentation point defined, the program removes the empty lines which were added below the final row. There is one empty line created for every number of rows returned. Thus, the program removes that number of empty lines. Having executed the orderly return of all the rows at the defined segmentation point, and having removed the extra lines created in the process, the program has completed its task and then proceeds to wrap any rows which have been affected by the added RowsReturn, as described in FIG. 39M.

An example of a RowsetReturn production is provided. FIG. 39U shows an example of the RowsReturn function applied to the FIG. 39Q text. As in FIG. 39Q, there are nine lines of text presenting the contents within a set of three rows. The third segmentation column is no longer on the first set of lines which display the rows, as it has now been returned to the second set of lines. The algorithm described in FIG. 39T has been executed, returning the rows at the third segment.

A RowsReturn causes the RowsWrap function to be repeated. It should be noted that the FIG. 39U example illustrates the adjustment in the RowsWrapping: where in FIG. 39Q, the third set of lines displaying the three rows begins the tenth segment or segment number ten (10), FIG. 39U shows the third set of lines beginning with the eighth segment, or segment number eight (8). Since the RowsReturn function applied increased the length of the second set of lines displaying the three rows, the automatic row wrapping described in FIG. 39M has been re-applied. The greatest number of characters of assembled segments within the 70 textarea column WrapWidth variable is the 66 characters needed to display segments 3, 4, 5, 6 and 7. If segment number 8 were included upon the second set of rows, the lines would exceed the 70 character WrapWidth limit. Thus, the rows are re-wrapped using the FIG. 39 RowsReturn function.

A RowSetBackspace function is defined. FIG. 39W shows a RowsBackspace algorithm which enables any sets of row returns included, as specified above, to be removed. As in other algorithms described here, variables need to be defined.

The program knows how many characters are needed to display the complete row contents, as the program automatically adds empty spaces to any row shorter than the longest row: in this example, 159 textarea columns are required to view the widest row.

The program knows how many rows are included within this view. In this case, there are three rows visible. More rows could be included, such as rows containing alternative segmentations, aligned context information, translations, synonyms, vocally emphasized syllables, links to visual experiences and such. The view in this example includes three (3) rows in the variable named RowSet.

The program knows how many segmentation columns are defined. Wherever two or more spaces separate segments in the aligned context row, a segmentation column is specified. In this example there are eleven (11) segmentation columns or SegmentColumns.

The program knows wrap width limit, within which as many segments per line are included, so long as the assembled segments upon a single line do not exceed the wrap width limit. IN this example, the wrapWidth limit is seventy (70) textarea columns. The program knows where and how many Return Rows points, if any, have been specified. This information is stored in the original text version of the file, as new lines or carriage returns. Using this information, both paragraphs and lyrical poetic formats are achieved, stored and reproduced. It should be noted that in most of the views shown in the present examples, temporary carriage returns are used to effect wrapping of multiple rows. Most of the returns are managed and removed when saving the data. However, the returns included and newlines defined in the original source text are saved.

Only within an original text, such as a transcription of an audio recording in accordance with the present invention, are the carriage returns saved. When applied, the returns segment the text into individual rows, which are managed as described in these figures. In the case of a multiple paragraph text, each paragraph is contained upon a single row. The paragraph may include multiple sentences. In the case of lyrics, each line of lyrics is contained and managed upon a single row.

Where there are multiple lines and/or paragraphs in an original text, the programs described here control each of these lines.

A single backspace key can remove a manual rowSet return. When the cursor is placed at the beginning of any row in a rowSet and the backspace key is hit, the program performs a series of cursor control, select, copy, cut and paste functions to remove a manual rowSet return; where the removal of a manual return affects rowSet wrapping, the rowSets are rewrapped to fit within the defined width. A user thus controls multiple rowSets with one minimal action.

The cursor is place at the beginning of any row within the rowSet. Unlike the RowsReturn function, where the cursor may be anywhere in a segment to execute the controlled series of managed carriage returns, the RowsBackspace function only functions when the cursor is in specific locations. Otherwise, the backspace performs as expected, simply removing one single previous character. However, when the cursor is at the start of any row immediately after a manual return has been included, then that row manual return can be eliminated as shown if FIG. 39W and described here.

A user invokes the backspace key. With cursor at the start of a backspaceable row, and the backspace key hit, the program executes two basic steps, then cleans up and rewraps rows, if need be.

First, the program goes to the first line in the RowSet, to the start of the row. It selects copies and cuts the entire line. The program then goes up RowsN of lines. In this example, the RowsN is (3) three. So the program moves the cursor up 3 lines. At the end of that line, the program pastes the copied text.

Second, the program goes down RowsN+1 or four (4) lines, to the beginning of the line, then repeats the series of actions in the first step. These actions are repeated once for every number of rows currently being viewed and managed. In this example, there are three rows, so the process is repeated three times.

Upon completion, the program removes the 3 empty lines created while removing the manual return.

Then the program finds any line which exceeds the defined wrapWidth variable, and then it proceeds to rewrap the rowSets as needed, so the entire contents of the column aligned texts are visible in an orderly sequence or continued rows.

FIG. 39X shows the example text with three manual returns added. The text, segmentations and alignments are the same as those found in FIG. 39Q. However, in FIG. 39X the rowSet is represented in 12 lines. The three rows are continued in sequence upon four separate lines each. Three manual RowsReturns have been added, one after the third segment, another after the seventh segment, and the third after the tenth segment.

While the WrapWidth limit in FIG. 39X and FIG. 39Q are the same, at 70 textarea columns wide, none of the segments assembled on individual lines exceed the limit, so no RowsWrapping is required. The widest line is 50 characters, which could accommodate another segment within the wrapWidth limit, but do not, since the manual ReturnRows have been included.

RowsReturns and Rowbackspaces control lyric lines and paragraphs. FIG. 39XX shows the FIG. 39X example with all rows except the original text removed. This is to illustrate how manual returns are known to the software and system: they are stored within the text-only version of the file, just as a normal text file would be expected to do. When wrapping sets of rows with aligned columns, however, this information is used to control the entire contents of the column aligned row sets, by identifying the segment end and guiding where the manual RowsReturns are inserted.

FIG. 39Y shows the FIG. 39X with the first manual RowsReturn removed, by applying the RowsBackspace function described in FIG. 39W. It should be noted that the first series of lines which contain the rowSet is now consistent with the FIG. 39Q example: five (5) segments are contained upon the line. The rowSet is resumed upon the subsequent series of three lines. However, since there remains a manual rowsReturn after the seventh segment, no automatic RowsWrapping adjustment is made.

FIG. 39Z shows the FIG. 39Y example unwrapped. Where in FIG. 39Y there are twelve lines used to display the rowSets in sequential series, the unwrapped view in FIG. 39Z contains the same data in nine lines. The entire contents of the first rowSet may not be visible, due to horizontal display width limits. The data, however, is visible where horizontal scrolling capacities are provided for.

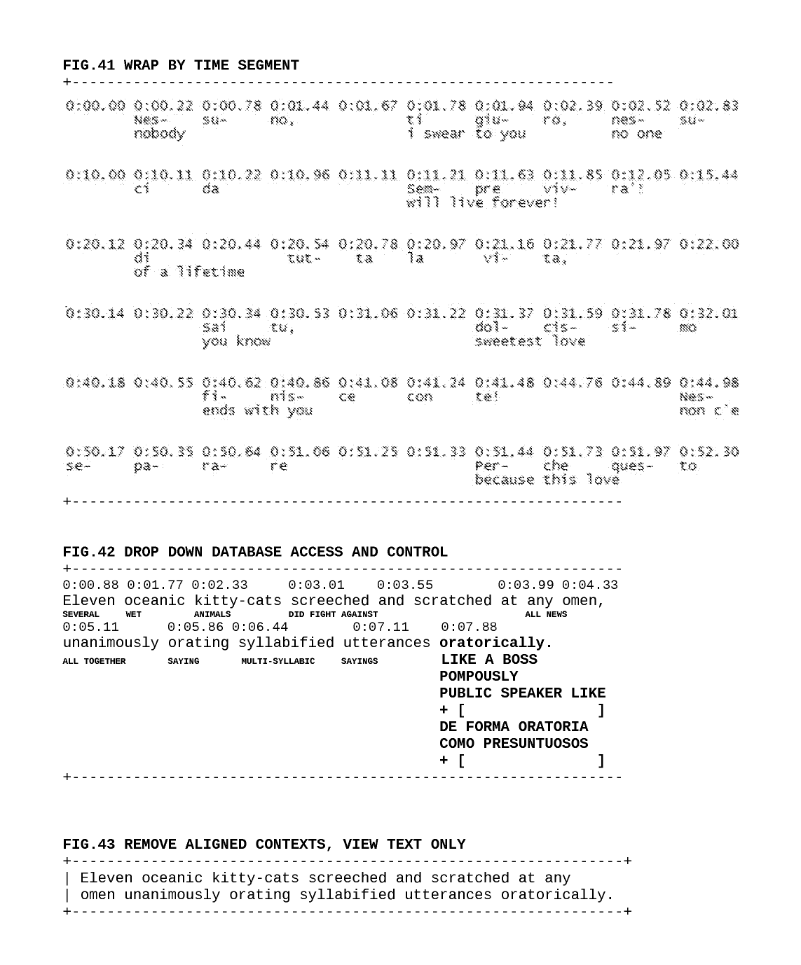

RowSets can wrap at specified timing increments. FIG. 41 shows a three row set of columns wrapped by using timing information to control the wrapping of the set of rows. In other wrapping methods, the horizontal width of the presentation is controlled, to enable more complete contents to be views. In the FIG. 41 view, the row contents are not completely visible within the width limit of the current display. Horizontal scrolling controls, including the new controls specified in FIG. 16 and FIG. 17A, enable the contents of each text line to easily be seen and edited. Where the contents are wrapped using the FIG. 41 method, the horizontal extent of each line is limited, so a user can more quickly access, view and edit the texts.

As seen in FIG. 41, each row set can be interrupted and continued in series upon subsequent lines, using defined timing points as increments to define where and at what point to interrupt and then continue the rowSet contents. In the FIG. 41 example, the defined timing increments are ten (10) second intervals. Thus, each timing line begins at the first timing point that is greater than or equal to multiples of ten seconds. As can be seen in FIG. 41, the row contents which are presented upon a series of wrapped lines contain a timing row. The timing row is represented in six lines. Each of these six timing row lines begins with a number that is nearly an exact multiple of ten. Thus, any timing point defined within a timed vocal text can be easily found. This is especially useful when applied in longer vocal texts, with multiple paragraphs, lyrics and rows.

Any variation of convertible formats, including the standard .SRT and .SUB formats, can be used to present editable versions of the synchronous timing points which are defined and stored in accordance with the preferred embodiments of the present invention.

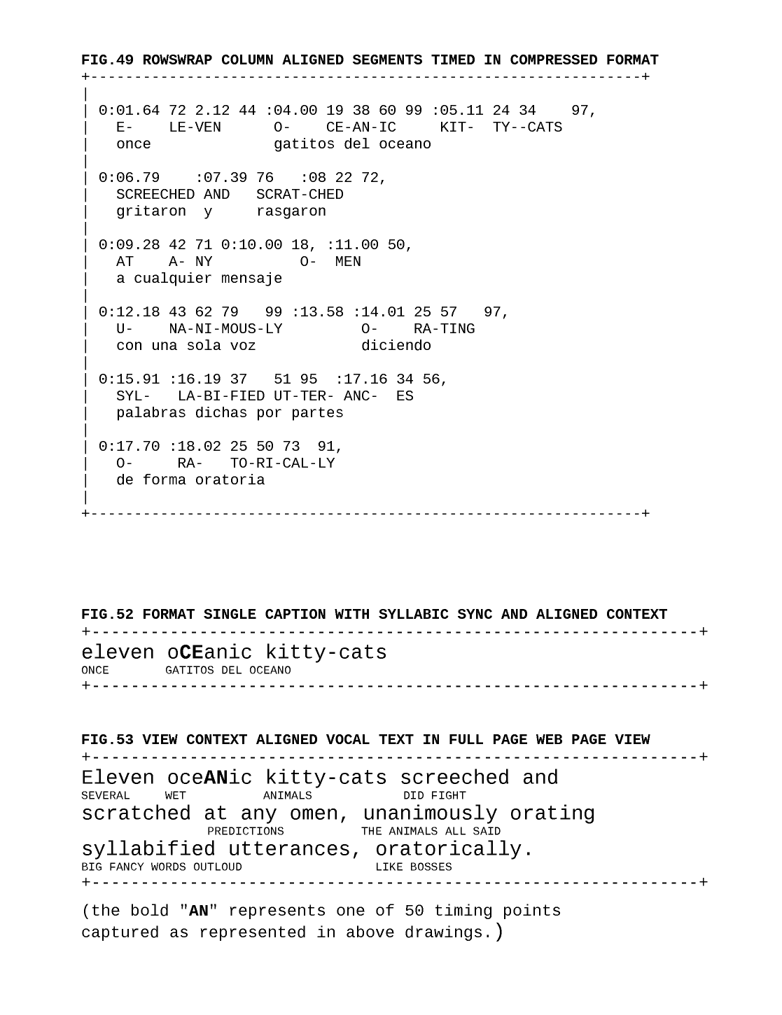

Compressed timings allow more transcription text to be viewed. FIG. 49 shows a compressed format presentation with the addition of multidimensional phrasal and syllabic columns, and also an additional row used to contain one of many possible variations in alignable context information. The illustration serves to confirm that additional dimensions of data may be arrayed and associated with text segments, while using a compressed version of a horizontally presented syllabic timing format. The compressed timing format allows more of the original text segments to appear within limited textarea widths. All the data is viewed, aligned and controlled within a single text editing interface.

Multiple rows with aligned columns are controlled in plain monospace text. Provided rowSet wrap, return and backspace functions control the alignment within variable widths. The series of FIG. 39 drawings illustrate a new and useful method to wrap rows and columns, so the contents of arrayed and spreadsheet like data are easy to see and manipulate. There is broad utility in this new capacity. Within the context of aligning detailed and precise timing definitions with syllabic and even pre-syllabic text segments, and within the context of aligned context information, such as synonyms or translations with phrasal text segments, the method to control the wrapping of rows in select sequential series offers evident advantages. Within the context of associating aligned visual information with segments, as is described below, again, the method of wrapping a number of rows allows easy viewing, manipulation and alignment of segments, which are clearly and usefully associated in variable segmentation column numbers.

Segmentations and alignments are controlled in textareas. The FIG. 39 series of illustrations, as well as FIG. 16 and FIG. 17A, and most of the other figures in these drawings each illustrate manipulation of text in common textarea inputs, where plain monospace text is used. Thus, with a set of software modules such as JavaScript libraries, the text is easily controlled in common text editing environments, including the common HTML textarea input. The system can be easily used controlled in websites.

Controlled wrapping of aligned multiple row arrays has other uses. As explained below, the method to control aligned twin line arrays is also used to align contextual texts with words and phrases seen in bifocal bitext and aligned chunk translation presentations. Links to pictures can be aligned with separately delineated text segments. Another set of separate segmentations can be aligned with structural information, such as formal grammatical categorizations or meaning-centric question and action categorizations. Timings for text segments are controlled in textarea inputs. Within the most basic and widely available text editing environment, the provided file format enables aligned text segments and corresponding timings to be easily viewed and manipulated. No complex spreadsheet formatting is required. Simple plain text is used.

Keyboard controls for timing adjustments are implemented. To ease user control over the timing of the out-point of the previous pause or syllable and the in point of the present pause or syllable, keyboard shortcut commands are mapped to invoke simple and useful functions. For example, if one or more lines of text are selected, the CONTROL+SHIFT+ARROW RIGHT keys are used to add one tenth of a second to the all selected timing points; each repetition of the keyboard combination can add another one tenth of a second. The addition of the ALT key to the combination, or ALT+CONTROL+SHIFT+ARROW RIGHT are used to add full seconds to the timing point of the selected text lines. Conversely, ALT+CONTROL+SHIFT+ARROW LEFT are used to subtract full seconds from the selected lines; and CONTROL+SHIFT+ARROW LEFT are used to subtract fractions of one tenth of a second from the selected lines. Similar keyboard shortcuts are implemented to control the addition and subtraction of precise ten millisecond units. The actual keys used to control the timing may vary; what is required is minimal user effort to control precise timing adjustments. Thus, a user can quickly select and control the timings of subsets of syllables and/or single syllables.

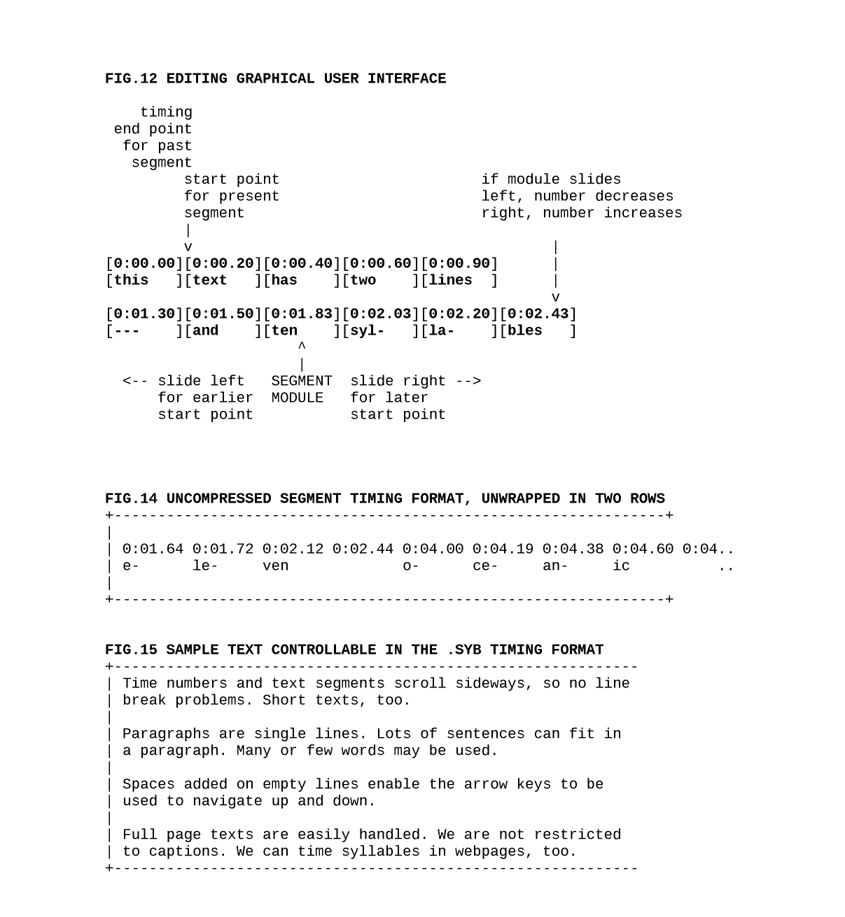

A graphical user interface to edit timings is provided. As seen in FIG. 12, the timing in-points for each syllable, as well as the timing out-points for the previous syllable, are controlled within a Graphical User Interface that obviates the necessity to manually replace numbers within a text editing interface. To make a text syllable appear slightly earlier within the time sequence, the user simply drags the syllable toward the left, and the timing number is adjusted automatically. To make the text syllable appear slightly later within the time sequence, the user simple drags the syllable toward the right; again, the timing number is adjusted automatically in response to the users action. Using such a graphical user interface is very useful for controlling the text timing on devices which lack keyboards, such as is common with mobile cellular smart phones.

FIG. 12 represent a graphical user interface where each segment of text and corresponding timing value is shown in a module; if a module is selected and moved to the right, the timing values within the module are increased; if a module is moved to the left, the timing values within the module are decreased. Groups of multiple timed segments may be selected and their timings adjusted by the same means. Whenever a timing is adjusted, synchronous playback is invoked to allow the user to confirm the accuracy of the timing.

Multiple segments are selectable within the graphical user interface. Selection may be executed with multitouch definition of the beginning and ending segments. Selection may alternatively be executed with a keyboard and cursor combination, such as control click to define the beginning segment, then while maintaining the invoked control key, a separate click to define the end segment. When multiple segments and timings are selected, as a group they are, as described above, easily moved left or right to thus appear earlier or later within the time line.

Each adjustment invokes automatic playback of the adjusted selection. The adjusted selection playback presents both the textual and audible syllables; both are controlled by the defined playback speed; only the adjacent segment of synchronized audio and text are replayed, to facilitate precise timing adjustments specifically, while obviating any need to manual invoke the segment review.

Timing errors are easily corrected. Implementing any variety of means, including but not limited to those described above, the timings for individual syllables, subsets of syllables in selected groups, such as words and phrases, and the entire set of all timings are each easily manipulated by a user; the user can easily control selected parts of the text timings; the user can also control the entire set if syllabic timings, to precisely sync the entire set with the separate audio recording.

Segments of text and audio are precisely synchronized. Depending on a user's preferences, the textual syllables can appear slightly before or slightly after the audible vocalization of correlated syllables within the audio recording. In either case, the variable anticipation or delay is constant: the syllables of text are precisely aligned with the syllables of audio. Typically the text syllables are precisely synchronized to appear neither before nor after the audio, but rather exactly at the same synchronous instance. Thus, an end user can easily associate a very specific aural sound with a very specific visual symbol rendered in text.

Single characters timings are defined. Where it is impractical to manually define synchronous timings for individual characters to coincide with the most basic components of vocalization, accurate estimates can define timing points using simple arithmetic: for example, where a syllable has four letters and a synchronous duration of 200 milliseconds, the timing duration of the whole syllable are divided into four parts, resulting in an estimated timing of 50 milliseconds per character. Where such estimates result in perceptible timing errors, such errors are easily corrected in accordance with the methods described above.

Timed characters can be reassembled into groups of multiple characters. Where two characters represent one sound, for example the characters “ch” in English, they are joined while maintaining their synchronous fidelity simply by eliminating the first character's outpoint and second character's in-point. For example, if the character “c” is timed to synchronize with vocalization between the in-point 0:00:01.100 and out-point 0:00:01:200, and the subsequent character “h” is timed to synchronize between the in point 0:00:01.200 and the out-point 0:00:01.300, when combined to “ch” the timing in point is 0:00:01.100, while the outpoint is 0:00:01.300.

Timed characters can be reassembled into consonants and vowels. Segmentations of consonant and vowel sounds are timed. Words are separated by two spaces, while groups of consonants and vowels are separated by a single space. Chunks, phrases and meaningful groups of words are optionally separated by three spaces. Vowels and consonants are preferable timed directly. Significantly reduced playback speeds, such as 20% or 25% of the original speed, and touch input with multiple fingers allows for precision timing capture of consonants and vowels.

Constantly timed segments are variably assembled. With timing in-points and out-points precisely defined and synchronized with the correlated syllables vocalized in the audio recording, simple softwares are used to assemble the syllables variably into words, chunks, phrases and sentences.

Assemblies include single line caption presentation and full page presentations. When presented in limited digital displays, or when accompanying audio-visual presentations, the presentation of segmented text timed synchronously with vocalization is contained within single lines. Presented in a sequence, the single lines appear synchronously with their corresponding vocalization. When presented in full pages, assemblies include multiple lines, and may include titles, multiple paragraphs, poetic lyrical formats and other such full page text displays. Within such full page display, a sequence of precisely timed nested segments appears to animate in direct response to specific segment of audio recorded vocalization.

Single line caption assemblies may include variable segments and nesting segments. Segments may comprise the entire line, and may be restricted to single characters or syllables presented extremely rapidly. Segments may comprise single words, multiple words and phrases. Within such larger segments, smaller segments such as syllables may be nested, and timed to appear distinctly for a part of the time in which the larger segment appears.

Segmentations and alignments are applied to any text. FIG. 43 shows the FIG. 42 text unsegmented, uncaptialized and without aligned context segments included. Note the FIG. 43 is an identical copy to FIG. 7. However, the process defined within these drawings and within this disclosure demonstrate that significant new controls are now available, in accordance with the preferred embodiments of the present invention, to easily synchronize syllabic segments of the text with a recorded audio vocalization, and also to easily align context information with a separate set of phrasal segmentations.

The FIG. 43 text can now be viewed and controlled in many variable states: alone, as text only; broadly segmented into phrases; aligned with segments of translation in one language; aligned with segments of translation in another language; aligned with synonyms in the same language; concurrently or separately, the text can be viewed and controlled in fine grain syllabic segmentation; the synchronous timing of any segment, phrasal or syllabic, can be controlled within these easily edited views. Whether presented simply in common textarea inputs, or presented in enriched graphical user interfaces, the data is easily controlled, with minimal user actions.

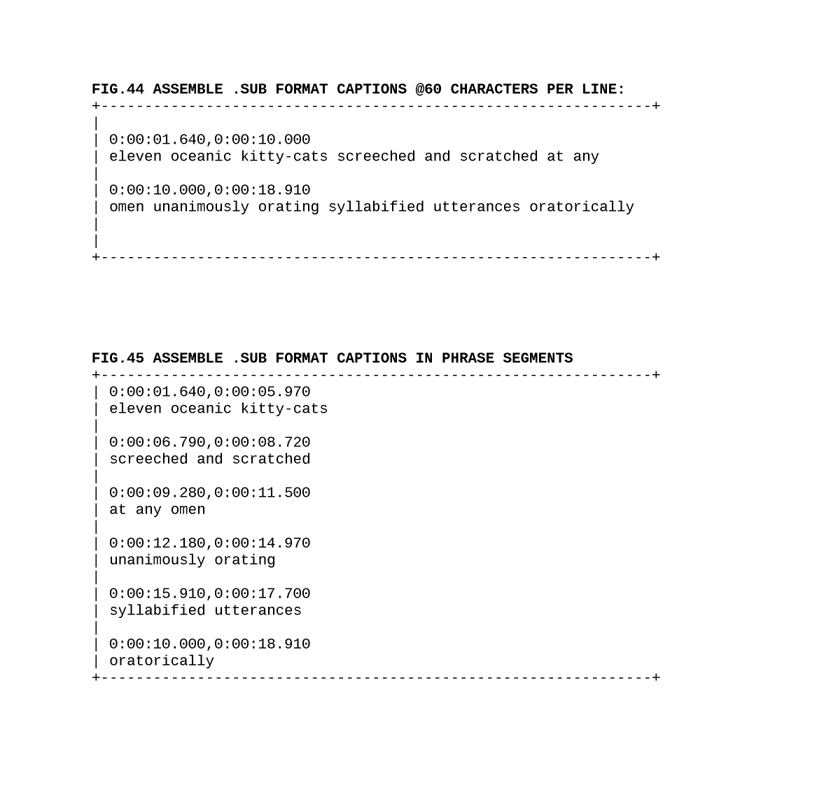

Timed lines are optionally assembled. Segmentations are optionally delineated by wrapping width. FIG. 44 shows an example of a variable timing assembly created from the data input and controlled in accordance with the present system. The FIG. 43 text is isolated from segmentation views and presented normally; the text is simply wrapped within a 60 character textareaWidth limit; the standard .SUB captioning format, as seen in FIG. 4, is used to present broadly synchronous timing points, for relatively long lines which include multiple phrases.

Timed phrases are optionally assembled. FIG. 45 shows an example the FIG. 43 text timed to synchronously present shorter phrases; again, the standard .SUB format seen in FIG. 4 is used to present the captions in common viewing environments, such as youtube.com. Where in FIG. 44 the assembly method was character counted line breaks, the FIG. 45 example shows single defined phrases or chunks for each timed line.

Nested segment parameters are variably defined. Within single line phrases, utterances, chunks and short sentences, the nested text segments may be single characters, multiple characters, syllables, morphemes, word roots or other such segmentations. However the segmentations and nesting are variably defined and assembled, the timings are constant.

Where assemblies are prepared for output in full page presentations, multiple lines are presented. Such lines may include defined line breaks, as is expected in poetic and lyric formats. Multiple line presentations may also exclude pre-defined line breaks, to enable variable segmentation assemblies to appear in paragraphs and other text output conventions. The segmentation and assembly definitions may be variably combined. Nesting segments and multiple nesting segments may be variably defined. However, in all cases, the timing of all segments, whether individually or concurrently presented, is constant: every text segment is synchronized with its corresponding vocalization segment.

Multiple paragraphs are assembled into complete texts. Where each syllable of text is precisely synchronized with syllables vocalized in audio recordings, the timing information is used to animate the syllables of text while the vocalized syllables are heard. Such synchronous animations are graphically achieved using multiple methods, as is described below.

Lyric lines are syllabically synchronized. Whether formatted in single lines as captions appearing concurrently with video playback, or whether formatted as webpages with the complete set of lyrics, each syllable of text is timed to correspond with each syllable vocalized in a specific corresponding audio recording. The assembly of the syllabic synchronization can vary: individual syllables, multiple syllables within single words, multiple syllables within chunks of multiple words, multiple syllables within multiple chunks within a single line of lyric text, and multiple syllables within an entire body of a lyric text are all controlled within the preferred embodiments of the present invention.

Precisely synchronous vocalized text is displayed in full texts, on webpages. Such a text may include a title and multiple paragraphs or lyric refrains. In such cases, where entire text is not visible to a user, parts can be viewed by controlling the browser scroll bar, and/or clicking links which connect sequential pages. Where such a text has one or more existing recorded vocalizations, or where such a text can acquire one more new recorded vocalizations, precisely timed components of text can be synchronized with the vocalization components, in accordance with the present disclosure.

JavaScript is used to modify the presented appearance of segments. The modifications of specific segments are timed to occur precisely while the corresponding segment of vocalization is heard. Standard HTML5 text presentations include the segments as defined elements. Elements in HTML are manipulated with JavaScript controls. Informed by precise timing definitions found in accordance with the present method, the JavaScript controls are applied to manipulate the appearance of specific text segments and elements, precisely while synchronized with specific segments of audio vocalization.

CSS style sheets are used to define the appearance of manipulated elements. Nesting segments should appear visibly distinct from non-presently vocalized parts of the text. This may be achieved by variable techniques, such as implementing controls to make the nested segments appear in bold text, in uppercase letters, in a separate color, italicized, a larger font size, superscript or by other such means. Formatting techniques may be combined variably; in combinations, they are also used to display multiple nesting segments concurrently, as is described below.

Any valid text transcription of an audio recording can be timed to appear as synchronous vocal text. Assembly of each timed syllable can vary, to serve as captions synchronized with common audio video playback systems, as well as other systems allowing concurrent visual display of simple text to be synchronized with audio playback. Where a Unicode character set allows for capitalization of characters, a timed sequencing of capitalization of individual syllables within a line of lowercase text enables alternative assemblies of syllabic synchronization to be displayed within lines containing single words, chunks, phrases and sentences.

Resulting synchronizations of syllabic text are easily presented. In accordance with the present invention, the simple use of capitalized or uppercase letters within a text to convey the precise timing of specific audible syllables allows the method to be used upon a wide variety of digital devices, including televisions, computerized video playback systems, computers, mobile phones, MP3 players and other devices capable of audio reproduction with concurrent text display.

Timed captions optionally include aligned context segments, such as chunk translations. FIG. 52 show a single line of customized caption output, which is aligned with context information; in this representation, the context information contains segments of translation to the Spanish language. The context information may include alternative translations, alternative alignments with separately segmented original text, or translations into languages other than Spanish. The context information may be in the same language as the original vocalized, segmented and timed text; the same language context alignments may contain simplified restatements of the segment, synonymous restatements, pithy commentary or any other information that adds context, definition and comprehensibility to the original text segments. Within the black text in FIG. 52, there is one syllabic segment that is bold and capitalized using uppercase letters. This syllable represents one of ten syllables nesting within the phrase; each syllable appears precisely timed with its corresponding vocalizations, in accordance with the preferred embodiments of the present invention.

Full texts seen in full pages are animated with synchronous syllables. FIG. 53 shows a full paragraph, with phrasal segments aligned with added context information; within this representation, the context information contains synonymic simplified same language restatements of the original text segments. As with the context alignments in FIG. 52, the contents in the aligned contexts may vary widely, and be rendered in any language; so long as the contents make intending meaning of the original language more comprehensible to a reader, the purpose of the present invention is served. Within FIG. 53, in the larger black text, there is one bold syllabic segment “an”, within the word “oceanic”. This syllable represents one of fifty syllables nesting within the full text; the timings are defined repeatedly in the majority of figures represented within these drawings; each syllable appears precisely timed with its corresponding vocalizations. The figure serves to illustrate an alternative full page view of the same information which can variably be segmented, assembled and presented in standard or custom caption formats.

Precisely synchronous vocalized text is presented in standard caption formats. Simple synchronous output can clearly communicate the precision timings using the most basic standard display technologies. Existing subtitling or captioning systems currently used in television, motion picture and video environments can easily apply a presently disclosed method to precisely synchronize syllabic timings and to clearly communicate the synchronous text vocalizations to viewers.

Known caption formats include AQTitle, JACOsub, MicroDVD, MPEG-4 Timed Text, MP Sub, Ogg Kate, Ogg Writ, Pheonix Subtitle, Power DivX, RealText, SAMI, Structured Subtitle Format, SubRip, Gloss Subtitle, (Advanced) SubStation Alpha, SubViewer, Universal Subtitle Format, VobSub, XSUB.

Timing data formats are convertible. Where computer memory has the timed text segments saved in the file format as illustrated in FIG. 5A, the stored timing data may be converted to standard captioning formats, including but not limited to the .SRT and .SUB formats. Any caption format capable of presenting plain text may be used.

Standard caption formatting using plain text is converted as follows. Precisely timed nested text segments are presented synchronously with vocalizations. The presentation is executed without complex text formatting. Only plain text is used. Segment and timing data saved in accordance with the present method is converted to standard captioning file formats as follows:

Number of segments per line is defined. Each line contains a number of segments. In one preferred embodiment of the present invention, the segments are defined as syllables. In this case, the system defines the number of syllables contained on each line.

For every segment in a line, a copy of the line is made. For example, if there are eight (8) syllables counted upon a single line, then eight copies of that line are made.

The copies of the line are rendered in lowercase characters. Most or all of the contents in each copy of each line must be rendered in the smaller, lowercase font set. While not mandatory, even the capitalized letters which start sentences, acronyms and other instances of grammatical capitalization may be repressed.

Sequential nesting segments within each copy are rendered in uppercase. Where the applied segmentation method is syllabic, each distinct syllable is separately capitalized individually upon each separate line, as is illustrated in FIG. 2. The order is linear; the first syllable encountered upon the first copied line is capitalized; the second syllable upon the second copied line is capitalized. The third syllable upon the third copied line is capitalized; the fourth syllable upon the fourth copied line is capitalized; the fifth syllable upon the copied fifth line is capitalized; the sixth syllable upon the sixth copied line is capitalized; the seventh syllable upon the seventh line is capitalized; the eight syllables upon the eighth copied line is capitalized. The uncapitalized parts of each line remain uncapitalized and rendered in lowercase letters. Thus, each separate syllable is distinctly identified upon the separate copies of the copied line. The distinction is clearly presented with the use of uppercase characters or capitalized letters.

Each copy of the line is precisely timed. The timing definitions for each segment, which are known in the saved file format as illustrated in FIG. 5A, are applied to each copy of the line.

The process is repeated for every line. Each separate line is copied for every segment within the line; each copy of the each line has separate and linearly sequential segments distinctly capitalized; the capitalized segments are in distinct contrast to the lowercase lines. Each copied line is precisely timed to synchronize with its corresponding vocalization.

Variable segments appear nested within constant lines. Each copy is typically timed to appear presented for a brief and synchronous moment of concurrent vocalization. Reproduced sequentially, the syllables appear to visually respond instantaneously to the vocalizations replayed in the audio recording. Synchronous vocal text is presented, using plain text, within common captioning environments.

Plain text output in for standard captions reproduces multiple copies of each timed text line. As seen in FIG. 2, each separate copy of the text line is separately timed. A separate component within each separate copy of the timed text lines is distinguished.

In such outputs, distinguished components appear in “ALL CAPS”, otherwise known as “all uppercase letters”, or “all capitalized font case”. The non-distinguished parts of the separately copied, separately timed line remain in all “lowercase”, non-capitalized font characters. Within the separate copies of the constant text line, individual separate components are distinguished when rendered as ALL CAPS.

The copies of the text line are replayed in the timed sequence. As each version of the repeated line is displayed in sequence, according to the defined time segments, the syllables appear to be animated within flow of time. An observer of the timed sequence is thus easily able to differentiate between singly distinguished syllables and the other parts of the line of text.

The attention of an observer is drawn to the distinguished part of the copied line, as the sequential renditions of it are reproduced within the defined segments of time. Since each syllable coincides precisely with audible syllables, the observer associates the audible sounds with the visible text.

The process is repeated with every line in the transcription. Where the component level is syllables, for every syllable within a line, a copy of that line is made. Each copied line is separately timed so that when played in sequence, the lines flow forward in a series. Each separate copied line has an individually distinguished component, such as a syllable, rendered in ALL CAPS. The process is applied to all lines within the entire transcription.

The result is clearly visible synchronous vocalized text, which is easily viewed and edited upon a wide range of available digital displays, using a wide range of processing capacities, and readily adaptable to a wide range of existing software systems, including but not limited to currently standard captioning technologies in wide use. Broad usability within a plurality of digital systems is the intention of synchronous vocalized text rendered in simple output.

Where capitalization is not normally used within a specific Unicode character set, as is common in a plurality of non-Latin based scripts and writing systems, syllabic units are segmented and identified with insertion of neutral characters, such as “*”, on both sides of the specific syllable being concurrently pronounced in the synchronized audio recording.

Where a writing system is not phonetically based in sounds, but rather morphemically based in components of meaning, and where such morphemes are readily associated with specific patterns of vocalization defined in audio recordings, the intention of the present invention can be achieved, again with capitalization of the synchronized morpheme or with the insertion of a neutral character on both sides of the written textual morpheme synchronized with the audible vocalization of the component of meaning as it is reproduced in the audio recording. While such synchronizations may not be strictly syllabic, as in the case of a multisyllabic morpheme, the intention of the present invention is served: a user experiences very specific sounds through the ear while experiencing very specific symbols through the eye; the user can thus readily associate specific sounds with specific expressions of text.

Transliteration from non-phonetically based writing systems to phonetic writing systems can enable the sounds of a syllabic segment of language to be concurrently displayed in text and synchronized with its correlated syllabic segment of vocalization within the audio recording. In any case where the vocal pronunciation of a language syllable is synchronized with a textual rendering of the sound, the purpose of the present invention is served.

A plurality of writing systems and languages are used in accordance with the present invention. Requirements include a digital device capable of audio playback and concurrent text display, as well as a syllabically synchronized set of text timings to enable individual morphemes or syllables to appear in text form while the vocalization is expressed in the form of audio playback.

The precisely synchronous text timings are optionally presented with formatted text. While simple capitalization of specific syllables timed in the most basic text formats can communicate to a reader precisely which syllable is being vocalized within the concurrent audio recording playback, a plurality of other text outputs are formatted. Any text formatting which can precisely communicate to a reader the exactly defined timing of concurrence in textual and audible synchronization of syllables achieves the resulting intention in accordance with the present invention.

Where color, instead of or in conjunction with capitalization, is used to show the syllabic synchronization, the purpose of the present invention is served: a reader hears each syllable vocalized at the precise moment in which the reader sees the written equivalent, and can thusly with confidence grow to associate a concurrent component of sound and text. Millions of color variations can be used to separate one specific syllable from another color in the surrounding text. For an example, each syllable timed to concur with the synchronized audio can appear in an orange color, while the remaining syllables not vocalized at this time appear in a blue color. In this example, the orange syllables appear to move across the text precisely while each vocalized syllable is invoked in the synchronized audio recording.

Where techniques other than capitalization are used to show the syllabic synchronization, the purpose of the present invention is served: a reader hears each syllable vocalized while seeing its representation in written form. Alternative techniques to communicate specific individual syllables can include color, bold text, italic text, increased font size, blinking, underlining, strike-through, highlighting using any of a plurality of background colors, superscript, subscript or any other such common text formatting techniques.

Enhanced text formatting is not always easily implemented in existing captioning systems. Thus, the present invention provides for a simple method to sync specific audible and textual syllables using plain text, while not requiring complex enhanced formatting. However, the present invention is not limited to service only within video captioning systems. As is specified above, common HTML webpages are configured to employ the present invention. Where syllables of text are precisely synchronized with syllables of audio, and where such precise timing synchronizations are achieved using the process described above, the purpose of the present invention is served.

Customized captioning systems can enhance text formatting in video environments. Text formatting controls available in common word processing programs and markup languages such as HTML are introduced into video captioning environments. With such controls, not only can precisely timed syllables be highlighted and sequenced in accordance with the preferred embodiments of the present invention, the implementation of related inventions can also be incorporated to serve language learners.

Multiple nesting segments are synchronized. With highly customized text formatting controls, a syllable is synchronized with a vocalization, while at the same time, component characters within the syllable are further synchronized with more precise components of vocalization. As an example, with a defined timing in point and outpoint set, a large word are formatted in a black color; within that word, one syllable are more precisely timed and formatted to appear in a bold font; within that syllable, one character are even more precisely timed and formatted to appear with a blue color. In the example, the blue element is the most precisely timed with the briefest duration; the bold element appears for more time.

Chunks of translation context are optionally aligned with synchronous vocalized text. While the present invention can precisely synchronize text and vocalization components, it rarely can clearly communicate the meanings of the words or chunks of words. In the context of language learning, it is useful for the learner to comprehend not only the vocalization specific text segments, it is also useful for the learner to comprehend the intended meaning of the language used. This can effectively be achieved with the implementation of the systems and methods described in U.S. Pat. No. 6,438,515 “Bitextual, bifocal language learning system”, and those described in the Publication No. US-2011-0097693-A1, “Aligning chunk translations”. Where such presentations are delivered in editable rich text, in accordance with the present disclosure, no extra spaces are required between the chunks segments in the strongly formatted text.

Aligned contexts optionally appear discretely in comparison to easily visible text components. As disclosed in the above cited Patent and Pending Application, not only can known reference chunks be easily aligned with new chunks being learned, the chunks of one language can, with customized formatting, appear less intrusively and more discreetly in comparison to the strongly formatted highly visible text of the other languages. Thus, a user can experience the benefits of more immersion in one language, while having faintly formatted reference information available for comparison, but only when the user opts to refocus upon the discreetly formatted chunk in alignment, and thereby gather that information more consciously.

Aligned contexts can serve with synchronous vocalized text in captions. As described above, instances of syllabic synchronization can serve language learners in a plurality of environments, including the display of timed captions which accompany television broadcasts, DVD recordings, online Flash, HTML5, WebM, and other video display technologies, and also including text only displays synchronized with audio recordings reproduced using MP3 and other methods of audio reproduction. Typically, such environments for captioning are restricted to one or two lines of text.

Aligned contexts can serve with synchronous vocalized text in full page presentation. Typically, complete web pages are not restricted to single or double lines, but instead allow multiple sentences, paragraphs and lyrics refrains to be included and visible at the same time. Where such texts are longer, web browsers provide scrolling controls. The precise timing definitions found and stored in accordance with present method are applied using HTML5, JavaScript, Canvas, CSS and other controls described above to constantly synchronize variable segments of text visible in timed presentations of full pages texts.

Controlled wrapping of multiple rows with aligned columns is also applied in chunk translation alignment. To control dual and multiple line data arrays within horizontal width limitations in defined displays, textarea inputs and other such computerized text editing environments, the method of wrapping sets of rows described above also applies to chunk translation editing, as well as the inclusion of other aligned information, such as syllable emphasis, emphatic emphasis in syllables or words, same language restatements, sonorous restatements, comments, synonyms and image alignments.

Aligned translations are a form of restatement. For every text segment, the present method is used to associate related text segments. Within the surrounding text context of a select segment, the segment is used with a specific intended meaning. This intended meaning can be translated to plurality of human languages. While a translated segment may appear in a separate language from the original segment, the translation is a restatement of the original segment.

Restated aligned segments may appear in the same language as the original text. For an intermediate apprentice of a language, translation of segments to a known language are of less interest; the apprentice already knows at least 100 of the most common words, and can thus recognized approximately 50% of a text. Such an apprentice benefits more from aligned segment restatements and contexts. Where a same-language segment is not readily comprehended, the apprentice easily shifts the aligned language to one that the apprentice easily understands, such as the mother tongue of the apprentice.

Restatements provide context to make a segment more comprehensible. Translations and same-language restatements which are aligned with segments of an original authentic text provide to a user a known context which makes a new language segment more comprehensible. For a beginner student, translations help the user understand the basic meaning of a new text. For an intermediate student, same-language restatements provide more immersion into the sounds and expressive controls used in the new language. Switching between translations and same-language restatements is achieved with minimal effort. The user is provided with a basic understanding each segment.

Aligned restatements are a form of context. Whether provided in the same language as the original text, or whether provided in a language which a user fully comprehends, the aligned restatements simply provide additional context to the context existing within the original text. Vocabulary is naturally introduced in texts, understood in reference to the surrounding context, and confirmed where the word usage is repeated, especially where the repetition intends the same meaning. What is intended with inclusion of aligned translations and restatements is to add comprehensible context to any less comprehensible segment of text.

Contexts aligning with segments can be various. Aligned context includes any associable information. Aligned contexts are not restricted to simple translations or restatements. Comments or questions may be aligned with select segments. In which sense a word is used may be specified. The word “see” for example may be used more literally, in the sense of witness or observe; the word “see” may also be used figuratively, in the sense of “understand” or “agree”. The intended meaning of the sense of a word can be aligned as context, in a form a clarifying restatement. Further, a reaction, comment, warning or other such context information may be aligned with segments.

Variable synchronous assemblies of a text transcript are synchronized with audio recordings. The timing information precisely captured using the above described methods are used to assemble a plurality of text outputs: syllables or morphemes are printed one at a time so their timing are precisely controlled; vowels and consonants are assembled into single words; single words containing multiple syllables are assembled; chunks of multiple words are assembled; phrases or sentences with multiple chunks are assembled; paragraphs with multiple sentences are assembled; texts with multiple paragraphs are assembled; poetic and lyric formats are assembled; assemblies can adapt to serve in video environments, audio environments, HTML webpage environments and other environments allowing for concurrent playback of audio and display of timed text. In each case, in accordance the preferred embodiments of the present invention, fined grain components of language such as morphemes and syllables are precisely timed and synchronized in both aural and textual forms.

Constant, precisely defined timing synchronization enables multiple uses. While the above described uses of precisely defined syllabic text timing are defined, such a list of potential uses is by no means intended to be limiting. For example, the disclosed method to synchronize syllables of text in time with corresponding segments of audio recordings are used to collect data, which are statistically analyzed and used in machine learning systems to inform the automatic production of syllabically synchronized aural text. Further, similar analysis of collected synchronization timing data are used to inform speech recognition systems, and in a plurality of human languages. To achieve this end, it is useful for learning systems to compare variable vocalizations of single syllables.

Vocalization of single and assembled components are easily compared. As an increasing volume of vocalized and textual syllables are synchronized and stored in a database, the comparison of the constant textual expression with variable vocalizations of the syllable is trivial. To access variable vocalizations of the syllable, a user simply invokes a query containing the constant text string of the syllable. Since the timed syllables are variably assembled, as described above, they are combined with other syllables to form words, chunks and phrases. Such components of language are symbolized in text and stored on computers in databases as text strings. Thus, a user query for specific text strings, which may contain multiple syllables, can access and deliver to the user a plurality of variable vocalizations of the text string. Such variable vocalizations may be captured from separate recordings with separate transcriptions; such variable vocalizations may also be captured in separate recordings of constant transcriptions.

Multiple audio recordings of a single text are synchronized. For a human language learner, it is extremely valuable to hear variable vocalizations of a constant text. For example, upon hearing variable artists cover or perform variably interpreted separate renditions of a constant set of song lyrics, the learner can extrapolate the variable vocalizations to more easily hear how the component phrases, words and syllables can go together and flow together. Provided with variable spoken pronunciations of a same text, the learner gains even more extrapolation leverage. This human principle also applies to machine learning of complex human language: instead of attempting to process translations, for example, through a predetermined set of grammar rules, more successful results are derived from the statistical analysis of vast data sets.

Multiple audio vocalizations of isolated text components are compared. Repeated experiences of language components such as syllables, morphemes alone and assembled into words, chunks, phrases and texts, enables a learner to extrapolate patterns of pronunciation, intonation, emphasis, expression and other such characteristics of vocalization. Access to a plurality of variable vocalizations recorded within a database is trivial: simple invoke a query with a string containing a single syllable or multiple syllables. When, in accordance with the present invention, variable vocalizations of syllabic text are precisely synchronized, and such vocalizations are easily accessed, compared and experienced by the user, the user can learn language more quickly and with more confidence.

Synchronous vocal text reduces doubt amongst language learners. As mentioned in the background of the invention, a core impediment to learning is the experience of unwanted feelings, such as fear, uncertainty and doubt. The overwhelming amount of new information a learner experiences when attempting to learn a new languages can cause other unwanted feelings, such as anxiety and low self-esteem. However, application of new technologies, such a precise syllabic synchronization in aural text, easily accessed variable vocalizations of textually synchronized syllabic language components, discrete formatting of known chunks of language in alignment with new language chunks and other such advances can mitigate the unwanted feelings which impede learning. In accordance with the present invention, the phonetic component of text and language is clearly defined with repeated experiences of precisely timed text, particularly in association with authentic materials of actual interest to a language learner.

The volumetric flow of new information is regulated. A beginning can assemble vowels and consonant segments, while experiencing their playback at considerably reduced rates of speed. Gaining confidence while mimicking the most basic vocal components, the user can proceed with syllabic segmentations replayed with less speed reduction. With increased confidence, the user can proceed with single word and phrase segmentations, replayed at normal speeds. The user applies variable segmentation levels and playback speeds to experience and confidently mimic the vocal sounds represented in the text segments.

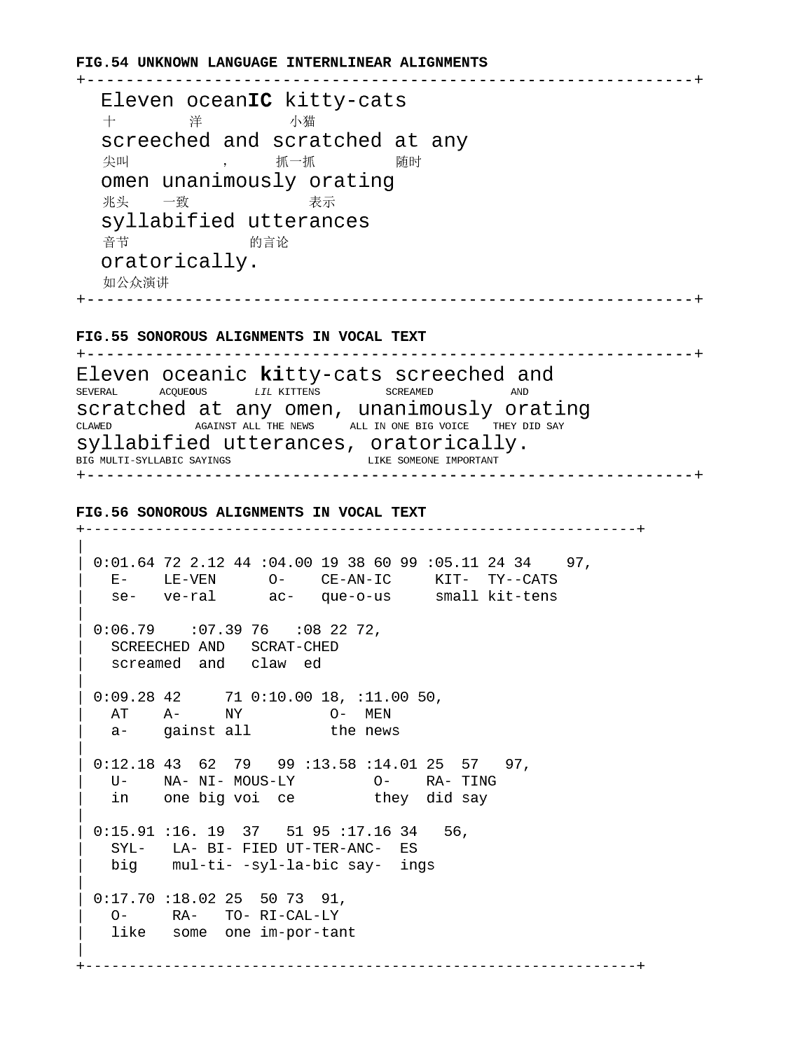

Unknown language segments are optionally aligned with native language text. FIG. 54 shows the same text as FIG. 53, with aligned contexts rendered in simplified Chinese script. As an alternative to including only known language within the contextual alignments, the interlinear context information may contain associated information a reader does not know but is willing to learn; where the alignment serve users with texts that can be meaningfully associated at a later date due to repeated informal experiences, the purpose of the present invention is served. Where users use the invention to experience language and thereby learn language, the purpose of the present invention is served. In the FIG. 54 illustration, within the larger black text, there is one bold syllabic segment “ic” ending the word “oceanic”. This syllable represents one of fifty syllables nesting within the full text; the timings are defined repeatedly in the majority of figures represented within these drawings; each syllable appears precisely timed with its corresponding vocalizations.

The FIG. 52, FIG. 53, FIG. 54 and FIG. 55 texts are representative: the graphical styling is more precisely controlled using CSS style sheets: the aligned translations can appear less intrusive; the lines of easily visible original text can appear more drawn together, with less vertical space separating the two; a user can set and control these styles according to a users' preference.

Similar sounding restatements are optionally aligned with segments. FIG. 55 shows the same representative text used throughout the figures, in this instance with aligned sonorous segments. The word “sonorous” is used with specific intention to mean with generally similar sounds a restatement or contextual comment which contains approximately the same number of syllables. Within the context alignment, similar sounding language or the same language is used; thus the vocal components are familiar to the ear.

In the FIG. 55 illustration, within the larger black text, there is one bold syllabic segment “ki” ending the word “kitty-cat”. This syllable represents one of fifty syllables nesting within the full text; the timings are defined repeatedly in the majority of figures represented within these drawings; each syllable appears precisely timed with its corresponding vocalizations. In the FIG. 55 illustration, within the smaller, light grey text of aligned context words, the word “lil” which under the bold “ki” syllable is rendered in italic text. In the FIG. 55 illustration, each interlinearly aligned segment text contains approximately the same number of syllables as the original source segment with which it is aligned. The aligned segments can also be timed to appear animated in response to the vocalization of the original text.

Approximately the same number of syllables is used. FIG. 56 shows a sonorous alignment of similar meaning words timed synchronously with vocalizations in the audio recorded in the link at FIG. 6. The text timings are rendered using the compressed vocal text file format. The aligned context segments are rendered in the same language as the original source text segments; unlike previous context alignments, which are aligned with larger phrasal segmentations, the FIG. 54 segments are aligned with each syllable. The words used to restate the message are in the same language as the original message, and thus composed of a similar set of sounds. No foreign language sounds are suggested by the text in such a presentation. The content of the aligned texts restates the message of the original text using alternative words. The nearly identical number of syllables causes the message to be restated with similar sounding or “sonorous” rhythm and cadence. Where the restated message is separately vocalized, the text can be precisely timed in accordance with the present method.

Restatements are optionally switched. FIG. 57 shows the FIG. 56 texts reversed: the restatement text is synchronized with a separate vocalization recording; while there are approximately the same number of syllabic segments, the timing values defined for each segment are different; as with FIG. 54, when played back at a normal or variable playback speed, two sets of syllabic segments are animated synchronously with the vocalization.

Restatements are preferably synchronized in vocal text. FIG. 58 shows output of the FIG. 57 source text, currently showing the timing point of twelve point nine one seconds (12.91 seconds) where the syllabic segment “big” is nesting within the timed text phrasal segment of “all in one big voice”; the interlinearly aligned context of that phrasal segment contains the word “unanimously”, within which the syllable “mous” is italicized. FIG. 58 represents one of fifty separate states of views of the same text, where within each view a separate syllabic segment, along with a correlated sonorous syllabic segment, together are made distinctly visible. The duration of this currently illustrated state of the text, when played back at the normal synchronous playback speed, is only 200 milliseconds, or two tenths of one second. It is not uncommon, when synchronizing fast speech, for syllables to be completely vocalized in one or two tenths per second.

Similar sounds and messages are compared. The alternating experience of a similar messages, such as the arbitrary examples shown in FIG. 55 and FIG. 58, experienced with somewhat similar rhythms and an almost identical number of syllabic segments, provides a learner with comparable sounds which represent a comparable meaning, although variably expressed using different words. Experience of the similarities and differences provide a rich context within which language is easily learned. The practice of restating a similar message with variable words is common to many language methods and learning approaches. But no method is known to easily enable a user to align the restatements and present both versions as synchronous vocal text.

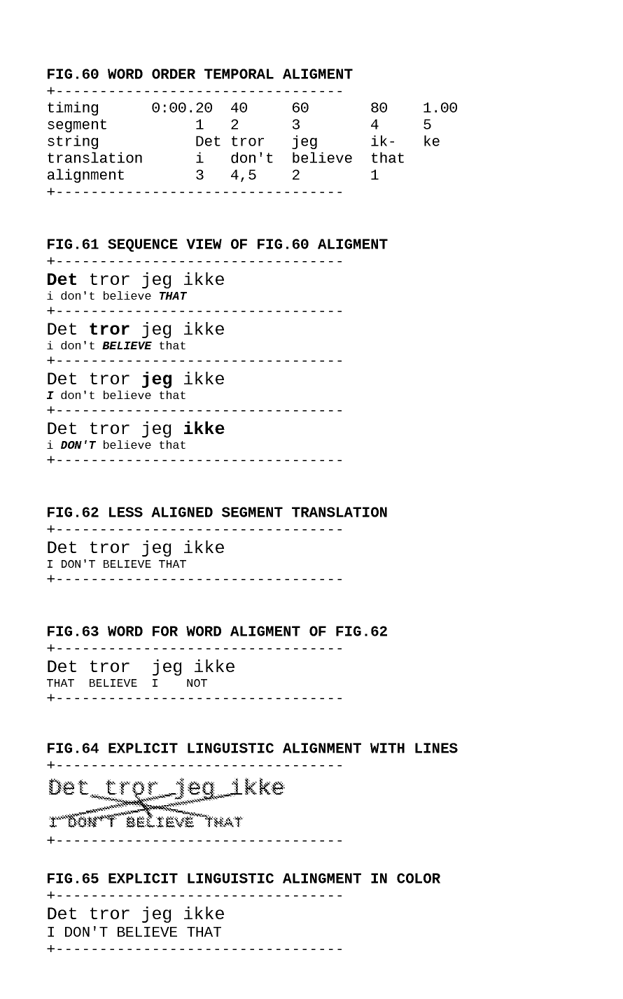

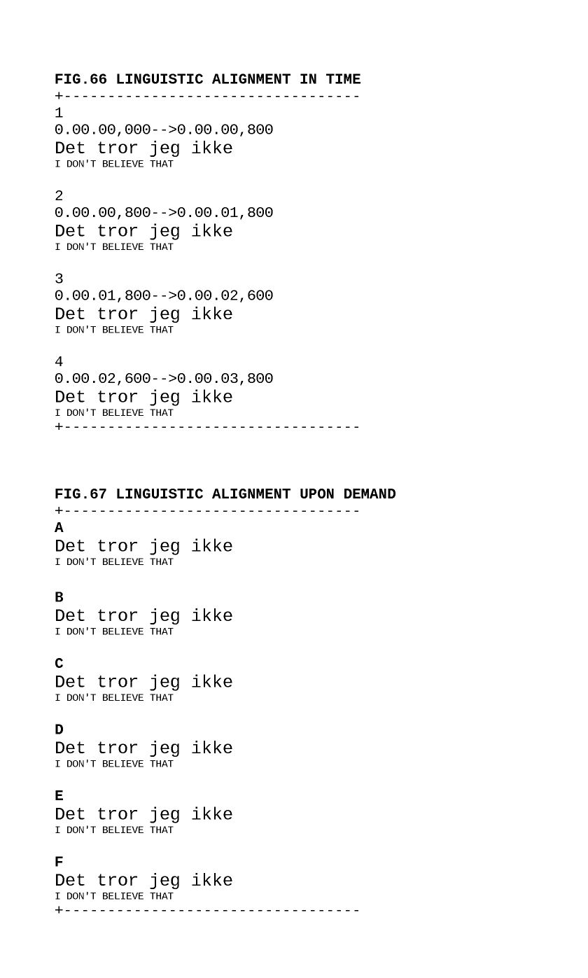

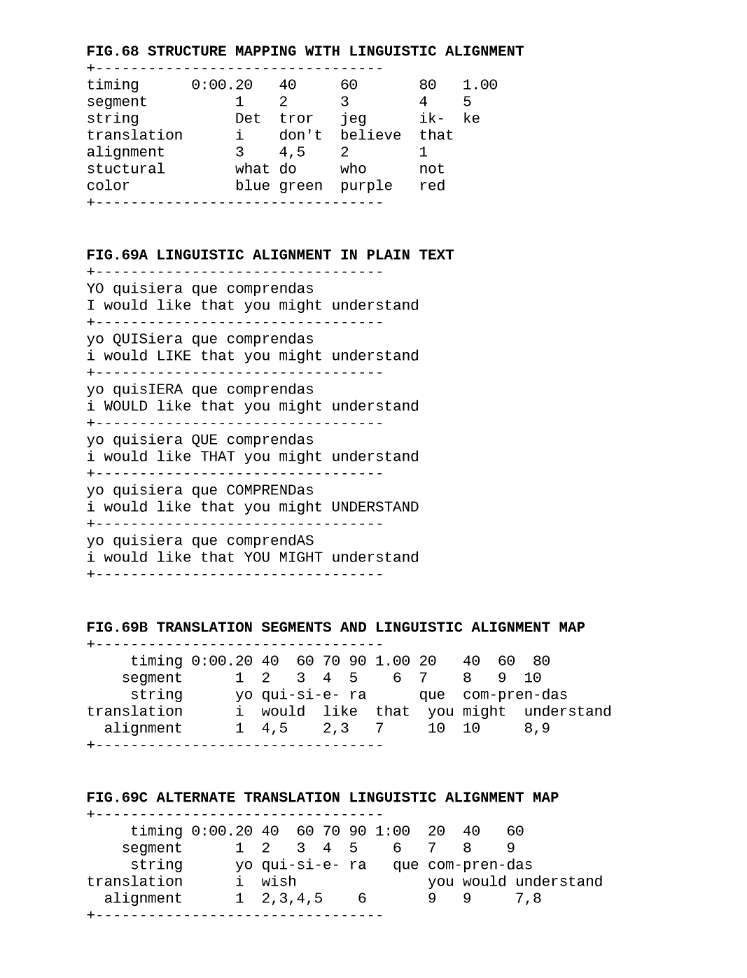

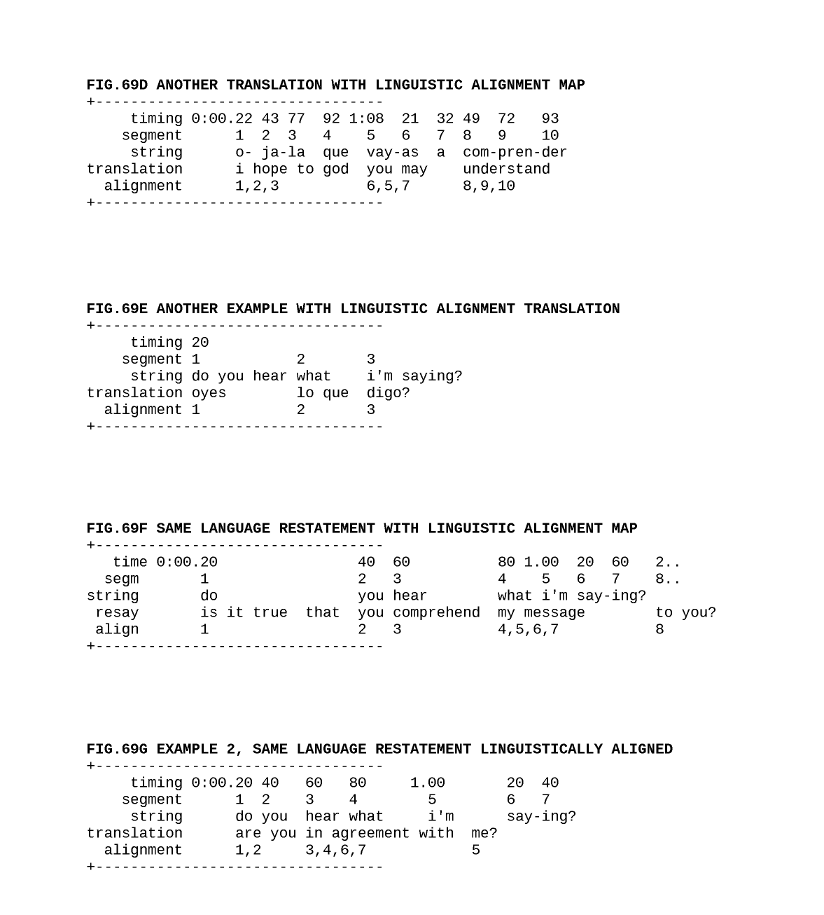

Parts of speech within segments can be aligned. FIG. 60 shows 5 rows of information arrayed into 6 columns. The first column is used to identify the five rows, which include aligned timing definitions in the first row, numbers used to identify segments in the second row, actual text strings with the segment contents in the third row, translations of those text strings in the fourth row, and the numbers used in the second row repeated, although in a different sequential order, in the fifth row.

Code numbers controlled in separately aligned rows associate the parts. In the fifth row, the numbers are aligned with each segment, as are all of the columns. As stated, the numbers are in a different sequence in comparison to the linearly progression segment numbers on the second row. Where the “segment” row numbers proceed in order from one to five, the “alignment” row numbers start with “3” in the second column, end with “1” in the fifth column, with “4” and “5” in the third column and “2” in the fourth column. These alignments are not arbitrary. Their placement identifies links of linguistic alignment between the source text and the translation.

“Linguistic alignment” means which parts of words carry a similar meaning or perform a similar function. Linguistic alignment should not be confused with “graphic alignment” or “alignment”, which is used throughout this disclosure to describe the orderly presentation of related text segments and timings controlled within columns and rows. Used alone, the word “alignment”, within this disclosure, always means graphic alignment. When the word “alignment” is used to mean “linguistic alignment”, the full phrase is used.

Doubts about word order are reduced. One feature of linguistic alignment is word order. Different languages and grammars order subjects, verbs and nouns in different sequences. In some languages, adjectives precede nouns, while in other languages, adjectives are used after nouns. For these and other reasons, word for word translations are only rarely functional, and if so, then typically only when utterances are extremely short. Normally language usage includes longer utterances and sentences, which do not exactly translate word for word. When comparing translations with an original text, in order to identify which words and word parts are related, the two texts can be linguistically aligned, with lines drawn between the related words and word parts.

Similarly, although with less precision, the alignment of translations segments or chunks described in the “Bifocal, bitextual language learning system” and the “Aligning chunk translations” disclosures serves to relate broader phrases with one another, as a means to work around the ineffective word for word translation problem. However, within a single aligned segment, it is not explicitly evident which words and word parts correspond with one another.

Parts of speech alignment was not previously controlled. FIG. 62 shows an example of a single segment of text with a single alignment of translation. Both the text and the translation contain four words, but unless a reader comprehends both the Norwegian original and English alignment languages, it is not readily apparent which words share similar meaning. If one were to assume that the words and meanings both shared the same linear progression, one would be mistaken, and confusion would result.

Word for word translations can cause confusion. FIG. 63 shows the actual progression and assembly of the words and meaning in the Norwegian language. The aligned English “word for word” translations combine to form an unusual construction, “that I believe not”, which does not communicate a clear message. The translation in FIG. 62, “I don't believe that”, forms a much clearer message in English.

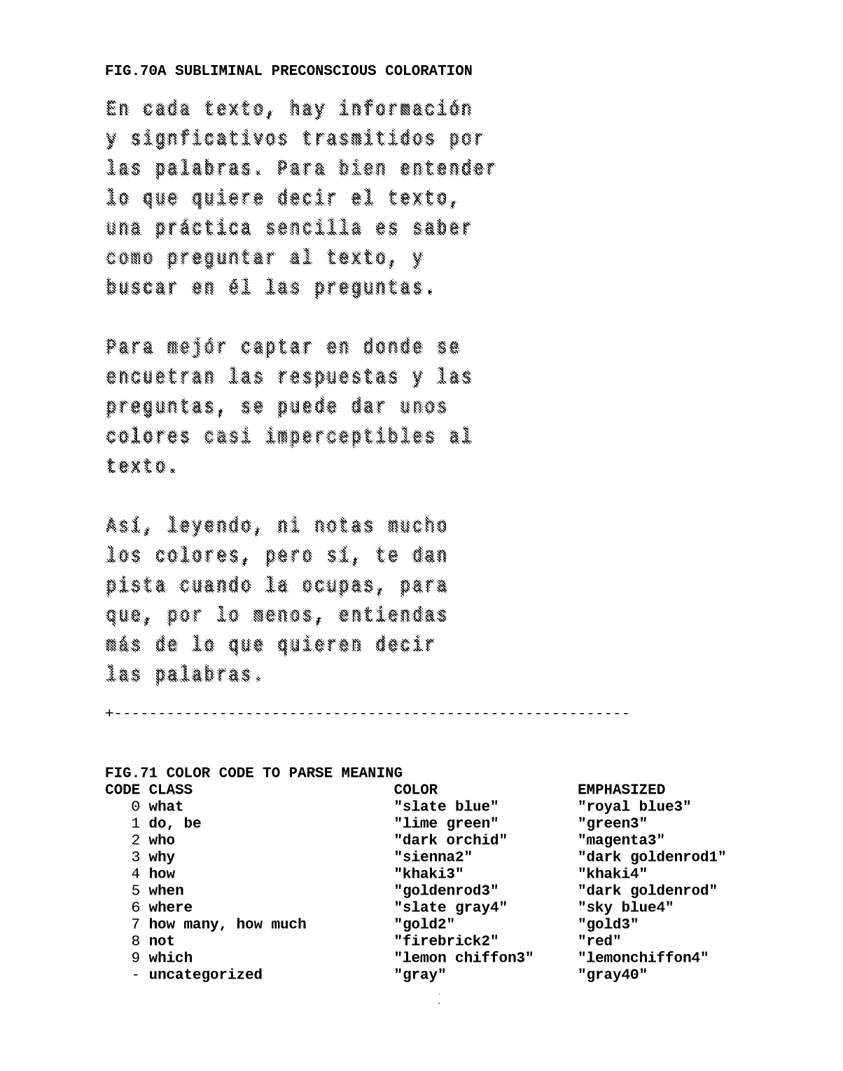

Methods are known to align words and word parts between text and translation. FIG. 64, FIG. 65 and FIG. 66 contain the exact same texts as FIG. 62, with all the words in both the original source text as well as the aligned translation text appear in the exact same order. However, where FIG. 62 does not communicate which words correspond with which words, in FIG. 64, FIG. 65 and FIG. 66, the connections between the words are clearly seen.

Lines are drawn between the parts. FIG. 64 shows an example of a common linguistic alignment, where lines are clearly drawn between words with corresponding meanings. The method of simple black lines drawing between the words enables the knowledge to be copied and reproduced in almost any data storage and/or publishing system. As can be seen in FIG. 64, the method serves to show which words in one language correspond with which words in another language. However, the presentation is cluttered with information and not easy to use. Further, extra space must be added between the words to accommodate the lines drawn between the words. Shifting between views of phrasal segmentations and full linguistic alignments disrupts the positioning of the elements, which is an unnecessary inconvenience to the user.

Color is used to associate the parts. FIG. 65 show a similar linguistic alignment as that found in FIG. 64, where color is used to associate word with similar meaning but which, within the different languages, appear sequenced in a different order. For example, a negation word “ikke” in Norwegian is the fourth word in the original text, which corresponds to the second word “don't” in the English translation. Both words are styled to appear in a red color, while the other words appear in blue, green and purple colors.

The FIG. 65 linguistic alignment requires color, and thus is not easily copied and reproduced in legacy information storage and publishing systems. Visually, however, the use of color to communicate the linguistic alignment is cleaner, clearer and more easily perceived by a user, and is thus more effectively used with minimal user effort. Further, when shifting between views of less detailed phrasal segmented alignments and fully detailed linguistic alignments, the position of all the characters remains constant; only the colors change. Thus, a user easily predicts where the information will appear as the view is shifted.

Time can be used to isolate linguistic alignments. FIG. 66 represents a timed linguistic alignment, where each word of original text, as well as its corresponding translation word, appears briefly for the amount of time designated by the timing format, which in this example is the .SRT timing format. The represented timing periods are relatively large, with syllables being vocalized a just under the rate of one syllable per second. Where recorded vocalizations are slowly paced, while played back either at their normal speed or played back at a reduced playback rate, a user can experience the sounds and the parts of text and their meanings at the same time. While in certain cases this may be useful, in is often experienced as too much information too quickly, especially when used with fast speech. The linguistic alignments within segments are more easily experienced when the user controls the timing of the appearance of the linguistic alignments.

Linguistic alignments can be made visible upon demand. FIG. 67 represents and interactive presentation where linguistic alignments within segments appear at the instant that a user wishes to review the information, while remaining otherwise invisible. FIG. 67 shows the FIG. 62 text in five different states. In the first state, the FIG. 67 text is an exact copy of the FIG. 62 example. In the second state, the first word in the original text segment is blue, and the final word in the aligned segment of translation is blue. As in FIG. 66 and other figures, each word has a color which corresponds to its closest translation equivalent. The first and last reproductions of the segment and aligned translation represent the text when not interacted with. The other reproductions B, C, D and E each have colored elements used to linguistically align corresponding words in the source and translation texts.

“Hover” controls are optionally implemented. Implementation of the HTML :hover selector enables a user to place the cursor over words or parts of words either in the original text or the aligned translation, which causes both of the related words, are parts to change in color.

Vocalization reproduction is optionally synchronized. Further, a series of vocalizations of the selected original text can be invoked while the user places the cursor hovering over either link. Thus, the user can see what the part of the language says, while directly the experiencing the sounds vocally expressed. This service may preferably be configured to be invoked by a hard click, which causes audio reproduction to repeat the vocalization three times, first alone, second in context, where the entire segment is vocalized and then repeated alone for the third time.

The availability of the linguistic alignment within segments via the hovering link technique can be switched on and off, and thus optionally available to a user. Consistent with the many controls included in this disclosure and controlled by using the provided file format, the optional information may or may not be included in views of original text. Control of linguistic alignments is a useful option provided by the disclosed file format.

Code numbers aligned in separate rows define such alignments. FIG. 60 shows a representation of how the FIG. 67 user selected hovering linguistic alignment linkages are defined, and also the linguistic alignments represented synchronously with vocalization as represented in FIG. 66. The static colorized linguistic alignment seen in FIG. 65 is automatically constructed through reference to the linguistic alignment linkages defined within a row of segmented text, as seen in FIG. 60, and described above.

The representations in FIG. 65, FIG. 66 and FIG. 67 also show that color can be used to describe grammar or structure in the language being learned. For example, the subject of the sentence, or what is being talked about, is whatever is referred to by the word “det”. “Tror” is the verb which expresses what is happening regarding what is being talked about; what is happening is “det” is being believed or perhaps disbelieved. “Jeg” identifies who is doing what. As can be seen in the linguistic alignment within the segment, the word “jeg” carries a similar meaning to “I”. “Ikke”, like “not” or “don't” in English, is used to negate the verbal assertion in the word “tror”. Used together, the Norwegian words “Det tror jeg ikke” convey a meaning similar to the English phrase “I don't believe that”.

FIG. 68 shows a method to control the colors of linguistically aligned parts, and associate specific colors with specific structures in language. The FIG. 68 example is an identical copy of the FIG. 60 representation, except two new rows have been added. One new row contains “structural” or grammatical category information; the other new row contains “color” assignments.

The “color” row is not strictly required within the file format. The colors are preferably controlled in a separate preferences file, which is applied to customize a CSS style sheet. The row is added here simply to illustrate a variable method to control the colors which correspond the specified language structures.

Colors can concurrently be aligned with form and meaning classifications. The structures defined by color are in this example broadly defined. More colors can optionally be used to identify more narrow and grammatical categories of language usages. For example, in FIG. 68, in the third column within the “structural” row, the value “do” can be replaced with the grammatical term “verb”. Any structural system which can classify the language parts and be used to understand their use can be used. The example in this disclosure is an alternative system which classifies words in groups with similar referential meanings. For example, both personal and possessive pronouns are grouped into a single category, which relates to a key question word, “who”.

Blue, as an example, is used to signify the noun, object, referent or “what” we're talking about. Where blue is only used with nouns, a reader grows to associated the color, when seen used to style parts of a text, to mean a noun, object, person or thing being talked about. Any color could be used, so long as the choice remains consistent throughout the texts, so that the reader associates the color with things relating the question word “what”.

Green, as an example, is used to signify the verb, action, state of being or doing in relation to the blue thing, noun, object, referent or what we're talking about. Where green is used only with verbs, the reader who experiences the linguistic alignments in variable contexts grows to associate the color in the text with words of action. Any color could be used, so long as the choice remains consistent throughout the texts, so that the reader associates the color with the actions happening, what things are doing or the way things are, what things “do” and “be”.

Purple, as an example, is used to signify who is doing the action or who the action is done to. The color can be also be used to communicate possessive pronouns and other word usages where a person is involved. For example, the phrase “I don't believe your words” contains two words, “I” and “your” which specifically refer to people, in this case doing something and having or saying something. Where a reader experiences purple words and knows these words have to do with people the reader associates the color with things which people have and do. Any color could be used, so long as the choice remains consistent throughout the texts, so that the reader associates the color with people, so we know who is involved in the message. We use a color for any word used in the message to define “who”.

Red, as an example, is used to signify negation. The color can be used within any word to communicate the negation of a statement. For example, the color can be used in parts English words such as “untrue”, where a “true” blue thing is negated with the red prefix “un”. Wherever words or parts of words are used to negate messages, the color can be used to communicate the negation. Any color could be used, so long as the choice remains consistent throughout the texts, so that the reader associates the color with negation. Thus, using simple colors to communicate structure, we can define who does what, an also the opposite, or “not”.

So, within a synchronous vocal text, whether in full page presentation or line by line captions, the syllabic timings can also correspond with color coordinations which can be used to experience structure in the language. Where before, in simple karaoke systems or same language subtitling systems, the parts of speech were not identified, they are now clearly communicated.

The user controls the experience. The colorization of multiple segments can also be presented statically, as the single segment in FIG. 65 is presented. The structural and linguistic alignment colorizations can also be made to be available upon demand, as is represented in FIG. 67 and described above. Thus, the user can experience the language structures and linguistic alignments within segments, assemble such structured and linguistically aligned segments into full texts, view the structures and linguistic alignments, either synchronously while vocalization is reproduced in audio, or upon demand, where the user experiences the segments at the user's pace.

Rows are included or excluded from wrappable rowSets as directed by the user. When using the methods to teach language, a teacher can select elements to align with a text and make comprehensible and meaningful presentations for a learner. When using the methods to learn language, a learner can include or exclude rows prepared by a teacher; where a row is desired but unavailable, a learner may publish a request for the information.

Colored structure rows can be aligned. FIG. 70 shows an example text parsed into colorized segments. Various words in the text appear in one of ten separate colors. The colors are used to classify words into categories. While the categories can be parsed with a traditional grammatical structure, as is demonstrated below, the FIG. 70 example shows the words parsed using a novel classification structures, based less on the grammatical form of the parts of speech used and more on the intended meaning of the words.

Colors can be subtle. FIG. 70A shows an alternative text rendered in colors which appear to be a uniform dark grey color. Upon closer inspection, a reader can detect slight colorization in varying words and parts of words. When printed on computer displays, the saturation and lightness of the colors are jointly controlled, allowing a user ranges of experience from vivid color separation to the subtle view represented in 70A, to no colorization at all. Extensive use of subtly colorized text trains a user to associate color with structures of meaning and/or forms used in the language. Context is thus provided in alignment with specific text segments.

Color coding is arranged. FIG. 71 shows a list of eleven numbed rows. Upon each row, in the second column, is word or group of words used to describe a category by which the meaning of a part of a text can be classified. The words included in the list are primarily composed of question words, such as “who”, “what”, “where”, “when” and so on. Three exceptions within this example are separate categories which are less directly related to question words. One category of exception corresponds to the grammatical form knows as a “verb”, or a word that communicates a state of being or an action being performed. Another category of exception represents negation. Another classification included in the list is uncategorized. The example list of categories in FIG. 71 defines a structure of meaning which includes action, negation and primarily question classifications.

Classed and named, numbered and colored. Each word in the list shown in FIG. 71 appears in a separate color, which is defined in the second column. Both the color definitions provided and the categorization classes are provided as examples. Any color can be combined with any number of categories defined by any metric a user prefers. The provided example, however, offers a useful metric by which a text is parsed into classes which enable the intended meaning of text to be more easily grasped and understood.

An emphasized color is optionally included with each class. The third column in FIG. 71 shows more intense versions of the colors defined in the second column. These colors are used to communicate emphasis or extra importance to a specific text segment, in relation to other more moderately colored segments. Declaration of emphasized coloration within the final presentation is applied as described below.

Each word in the list show in FIG. 71 is preceded by a number, except for the final item on the list which is preceded by a dash. The number represents a shortcut which can be used, as shown below, to classify segments of text into categories, which are colorized within final presentations.

FIG. 71 shows a method which is used to define variable categories into which a text is parsed, to assign specific colors to the categories and to provide emphasized coloration of text segments as needed. The definitions are referred to as text segments are optionally classified by applying methods specified below.

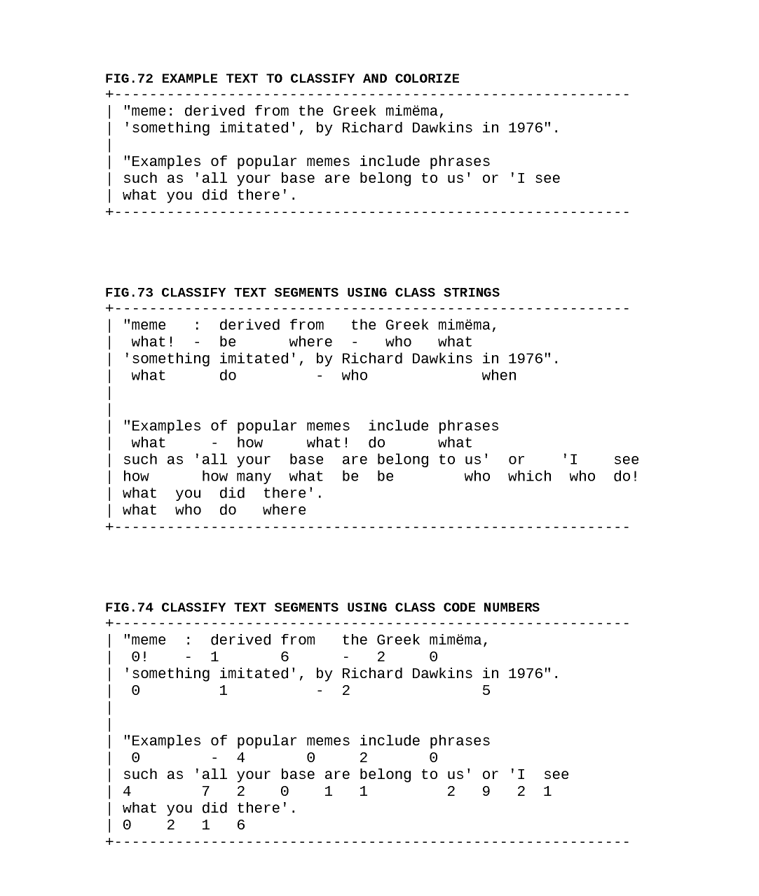

An example transcription is presented to illustrate the methods. FIG. 72 represents an example text containing two paragraphs within two separate rows which may be variably wrapped to fit within specified textarea column width limits, as described earlier, particularly within the FIG. 39 series of illustrations. The text shown is rendered in monospace font, which allows segments of context text to be aligned exactly with the shown original text. Any aligned text segments are controlled so that columns maintain alignment in variable widths of horizontal display space. To align context segments with the provided example text, an extra space is added below each of the lines shown, and related context segments are aligned as shown in FIG. 73.

Question word classes are aligned with transcription segments. FIG. 73 shows new rows of context segments now aligned with the original example text show in FIG. 72. The same method to align context segments described earlier is applied here; namely, within the newly aligned context rows, the segmentation columns are defined wherever two or more spaces separate the aligned words. As the original text segments are precisely aligned in the textarea column above each defined color column, the system applies the same segmentation described earlier. Thus, in the FIG. 73 example, the first rowSet and paragraph includes twelve (12) segmentation points, and the second rowSet and paragraph contains twenty (20) aligned segmentation points. These points are referred to, in conjunction with the classification and colorization matrix example provided in FIG. 71, to assign specific colors to specific segments of text in a final presentation.

Code numbers can represent the question word classes. The FIG. 74 shows the same text seen in FIG. 72 and FIG. 73, now with numbers aligned with the original text segments. The numbers are referring to the classifications and colors defined in FIG. 71. The resulting output from both the FIG. 74 and FIG. 73 source texts is identical, and illustrated in the second and third paragraphs of FIG. 70.

Color emphasis can be aligned with specific segments. In the FIG. 73 and the FIG. 74 examples, the first word and number aligned with the first text segment are followed by an exclamation point. The exclamation point is used to emphasize the segment, by increasing the saturation of the color. As can be seen in FIG. 70, the corresponding word “meme” shown in 13thy line appears with a more intense, which is designated in the “emphasis” row of the classification and colorization chart seen in FIG. 71.

The currently presented method to assign classifications and colors to segments of text provides a system which allows any metric to be used to parse a text into separate classes and assign separate colors to each class. To explore possible classes, the method allows for specific text strings to be aligned with the defined segments. Thus, a user can easily and directly assign specified classes to original text segments without the need to remember the color name, nor the color code number. As shown in FIG. 73, so long as the aligned word corresponds identically to a string provided in the class column defined within FIG. 71, the color used to format the segment is clearly defined.

The colorization and classification is optionally personalized. As experimentation results in more stable definitions of color code numbers, and as a user memorized the numbers corresponding with the segmentation classes, the user can more quickly and easily classify the text segments simply by using the color code numbers defined in the FIG. 71 example. Using the stable color code numbers results in a more readable source text, as is illustrated in FIG. 74.

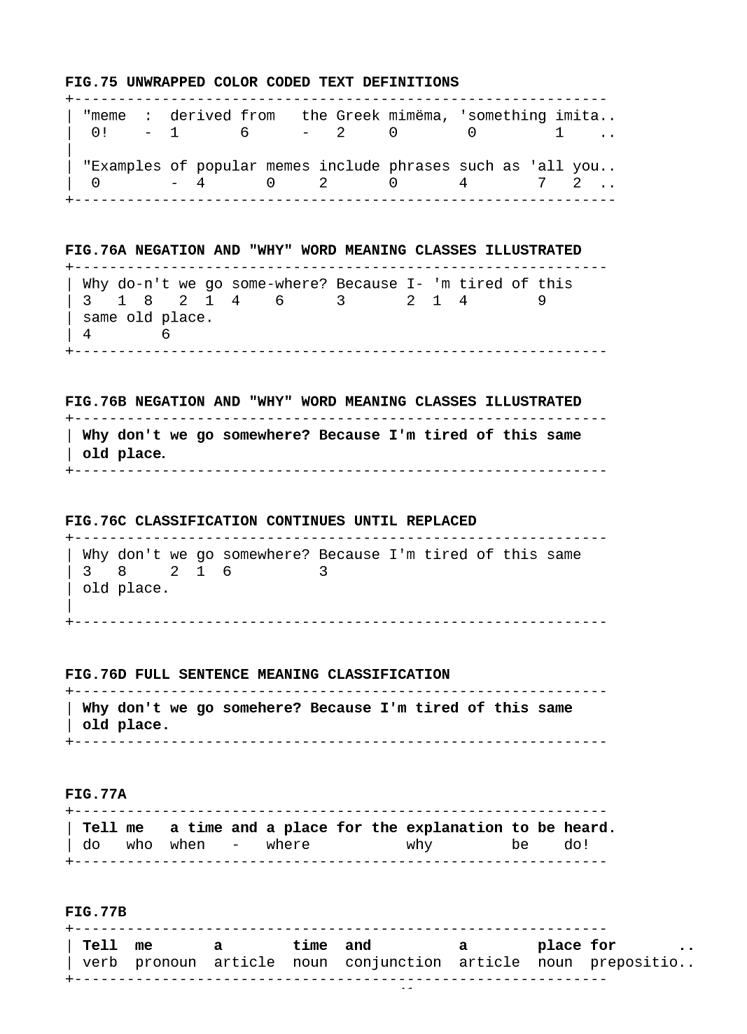

FIG. 70, FIG. 71, FIG. 72, FIG. 73, FIG. 74, FIG. 75 show a method to alternatively segment a text, in a separate set of segments distinct from both syllabic segmentation and phrasal segmentations described earlier. The purpose of this alternative structural segmentation is to specify a structure of meaning communicated in the text. Any metric of structure can be defined. The structure shown is based primarily on a metric of questions. Wherever a text segment may be construed to answer a question, the classification and colorization communicates the class of question which is answered by the segment of text.

“Who” words and word parts are classified. “Who” is a word that can be used as a metric by which text can be classified into categories of meaning. In reviewing FIG. 70, one can see that any text that refers to a person is presented in a “dark orchid” color. Variable grammatical classes of categorization may be combined. Within the FIG. 72 example text, the words “parents”, “children”, “peers”, “Greek”, “Richard Dawkins”, “your”, “us”, “I”, “you”, “individual”, “another”, and “people” are each used to refer to persons or people included in the meanings of the text. The traditional grammatical classifications of these would include nouns, pronouns, and possessive pronouns, and proper names, but these are combined in a distinct group of names are words used to define exactly “who” is referred to in the text. The inferred question answered in the text is “who is in the text?” “Who?”

“What” is also used as a classification category. Within the example, many words referred to are things that can be classified as objects or concepts that are referenced within the text. In grammatical terms, these “what” classified words generally correspond to nouns. As specified in the FIG. 71 classification and color guide, the “what” words appear in a “slate blue” color. When reviewing the FIG. 70 example, one can quickly and easily see what concepts and objects are referred to in the text. Were a reader to ask the question “What is referred to in the text?” answers to that question would be seen in words appearing distinctly in the slate blue color shown. Text appearing in the blue color show which words are classified by the question word “what”.

“How” is also used as a classification category. Within the FIG. 72 text example, several words are used to further describe objects and concepts referred to in the text. Words classified as “how” words in general may be analogous to grammatical modifiers such as adverbs and adjectives. However, the “how” designation is more flexible. An example of this more flexible interpretation in meaning classified structural definition is seen in line 25 of the FIG. 70 example, where the words “Kinda like” appear in the “khaki3” color. The phrase “kinda like” is used to describe “how” the “meme” is, or what it is similar to. In another example, within line 8 of FIG. 70, the words “as by” are not grammatical modifiers in form, but in meaning the words are used to specify “how” cultural inheritance is spread. To assign “how” classifications to text segments, one simply asks “which words within this text are used to describe “how” things are done and “how” things are.” “How?”

“How much” or “How many” are used as a classification category. Wherever within the FIG. 72 text example, words are used to define quantity, those words are classified and colorized, so that a reader can quickly measure quantities specified within the text. Again, the classification is not strictly grammatical and is more flexible. Words classified as defining “how much” or “how many”, within the FIG. 70 example, include “all”, “unit”, “one” and “keep”. The usage of the word “keep” on line 25, for example, would grammatically be classified as a verb meaning “to continue to” do something, such as make parodies. However, the word usage is variably classified, not by form but rather by the content of the intended meaning: this usage of the word “keep” answers the inferred question “how often to people make parodies of the viral video?” with the inferred response: “they keep doing it”, which suggest that people do it “a lot”. In this case, the language clearly is used to specify a quantitative answer to the question “how much?”

“Where” is used as a classification category. Wherever words in the FIG. 72 text example are used to define “where” people or things come from, “where” they are or “where” they are going, those words are classified as “where” words. Thus, the words “from” and “there” in the FIG. 72 text example are, in FIG. 73 and FIG. 74, aligned with classifications instructing the program to format these words in the “slate gray4” color specified in the FIG. 71 classification and corresponding color guide. For a broader example, one can review the example in FIG. 70 and quickly see the overall location relationships in “where” things, people, events, transfers and such occur. In the very first phrase of the FIG. 70 example, the grammatical forms would be classified as a conjunction, an article and a noun, but the FIG. 71 classification enables the phrase to be classified in meaning: the place to which this text refers is “on the Internet”. The “slate gray4” colorized text in FIG. 70 can communicate the spatial relationships, both physical and metaphorical or conceptual, defined in answer to the question “where?”.

“When” is used as a classification category. When words in the FIG. 72 text example are used to define “when”, in the sense of time, something happened, is happening or will happen, they can be aligned with instructions to colorize such time defining segments of text. In FIG. 70 upon line 14, the phrase “in 1976” appears in a “goldenrod3” color which is distinct from the other colors and text segments. Reference to the classification and colorization guide shown in FIG. 71 reveals that this specific colorization corresponds with text segments used to define times specified within the text. A quick glance at the FIG. 70 example reveals that this text is interpreted to define the timing of things in only one single instance. In other text examples which are not currently illustrated, common words such as “before”, “after” and “now” would be colorized as “when” words. Thus, a reader can quickly grasp the timing relationships of when things and events occur. Colorization of specific text segments are used to communicate any words used to define the timing of instances or events. The colorized text allows a reader to quickly define the timing relationships, defining possible answers to the inferred question of “When?”.

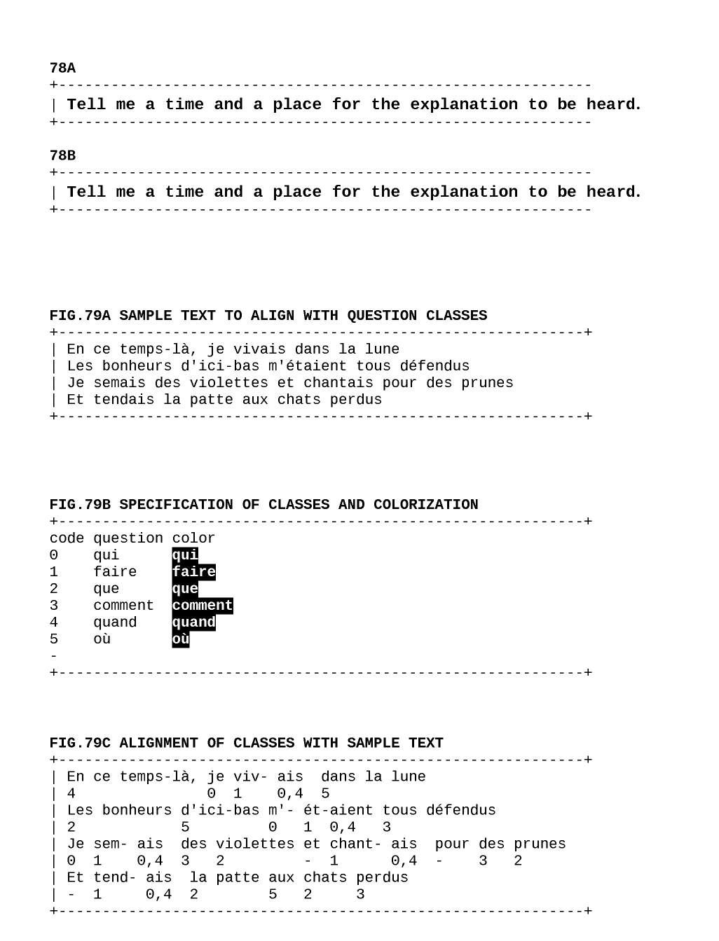

Other words are used as classification categories. FIG. 76A and FIG. 76B are included to show an example of other classifications defined in FIG. 71. FIG. 76A shows certain classification codes from FIG. 71 which are aligned with and defining segments of a separate text example. FIG. 76B shows the resulting colorized text presentation, which includes an example of negation, shown in the “firebrick2” color, and also includes an example of the “why” word classification used.

“Why” is used as a classification category. Where words or text segments in FIG. 76A and FIG. 76C text examples are used to with the intention to define the motivation behind an action or a request, such segments are aligned either with the code number defined in FIG. 71. As seen in FIG. 76B and FIG. 76D, a reader can then quickly see any meanings in the text which define the motivations expressed in the language usage. The FIG. 76D example illustrates the interpretive flexibility of the system: since the entire second sentence is used to define the motivation behind the question posed in the first sentence, the second sentence can optionally be coded to appear in a single classification color. FIG. 76C shows how this is simply executed. Consistent with all context alignment rows, wherever two are more spaces separate any element, a segmentation is defined, with a corresponding segmentation defined in the original text. Where in FIG. 76A there are fourteen (14) segmentations defined, FIG. 76C shows only eight (8) segmentations. The final segmentation is defined in FIG. 76C at the beginning of the second sentence and the word “because”. No further segmentations are defined. The classification and colorization is applied until interrupted by a different classification. As no further classification is made within the second sentence of FIG. 76C, the entire contents of the sentence appear in a single color and class, which is associated in FIG. 71 as the class of the question word “why”.

Negation is used as a classification category. FIG. 76B and FIG. 76D show negation used in a segmentation that occurs within a single word: “don't”. In the FIG. 76A and FIG. 76B examples, the word don't is segmented into two parts: the first part is classified as an action word or verb; the second part of the word, a contraction of the word “not”, is classified as a negation. The meaning inferred within the FIG. 76 examples asks “why we do NOT go somewhere?” The negation is communicated in the text, and also in the colorization, as one can see after referring to and learning the example color and meaning classification guide shown in FIG. 71.

“Do” is used as a classification category. Analogous to verbal forms, words used to express states of being or doing are classified. Unlike formal grammatical classifications, however, when classifying segments in terms of questions and meanings, a grammatical verb may be otherwise classified. For example, in FIG. 76D the verbal form “I′m” is classified within the “why” category, as the segment is used to explain a motivation or reason behind an action.

Classification is optional. Uncategorized segments of text can classified and colorized using the “-” symbol, as specified in FIG. 71. Again, any symbols, numbers, class name strings, and colors can be tested and used with this system. Specified within this disclosure is one alternative metric among many other potential metrics, by which a text can be parsed into segments which define classifications and structures of the meanings intended, in contrast with the traditional grammatical approach of focusing solely on the formal structure. So any symbol could be used to explicitly uncategorize a text segment. Uncategorizing text segments allows fewer segments to be classified if so desired. As shown in FIG. 70, the unusual colorization appears to be too much information and may thus cause discomfort in the eye of a viewer at first.

FIG. 77A shows a new text example with aligned question words used to define segments. The classifications and color designations are the same as those in the example illustrated in FIG. 71.

FIG. 77B shows the same text as FIG. 77A, with a separate set of classification words aligned the segmented text. In FIG. 77B, the classification words are more strictly grammatical terms. When coordinated in a reference matrix similar to FIG. 71, traditional grammar classes can be used to colorize segments of text and parts of speech.

FIG. 78A shows a presentation of the FIG. 77A input text, now processed to appear colorized, according the color specifications defined in FIG. 71.

FIG. 78B shows a presentation of the FIG. 77B input text, now processed to appear colorized, according to color specifications similar to those defined in FIG. 71. The classifications in the FIG. 78B output, as noted above, are separately defined from those in FIG. 71.

Question and grammar classifications are compared. Comparison of the FIG. 78A formatted text and FIG. 78B formatted text are similar, in that they both show the same sentence with separate words and groups of words colorized. A notable difference in the colorization of the segments can be seen in the variable colorization used to present the grammatical noun words in FIG. 78A: the colors are different. Reference to the FIG. 71 classification and colorization guide reveals that colors represent text that defines “when”, “where” and “why”, whereas the FIG. 78B text fails to distinguish the intended meanings. FIG. 78B, on the other hand, provides a more effective illustration of the grammatical forms used.

Use of the question matrix of colors and classifications shown in FIG. 70 is experimental. Initial use is accompanied by instructions not to take it too seriously, or worry about memorizing the color code. It is with repeated use of a single set of colors and classifications that the colorization becomes more consciously meaningful and useful.

The colors do not need to be constantly presented. When viewed within in dynamic instances of synchronous vocal text, all text segments which are not currently synchronous with the present audio vocalization may appear in a black or otherwise dark color in contrast to a light colored or white background. The colors may optionally be dark, as seen in FIG. 70A; they may also be optionally presented sequentially, as illustrated in FIG. 66 and FIG. 67. When presented in this fashion, the variable colorization only appears momentarily while the synchronous vocalization is heard.

The selection of colors currently illustrated is an example. An improved selection may include less intense coloration, which using JavaScript controls such a sliding control bar can be brightened or dimmed according to user preference.

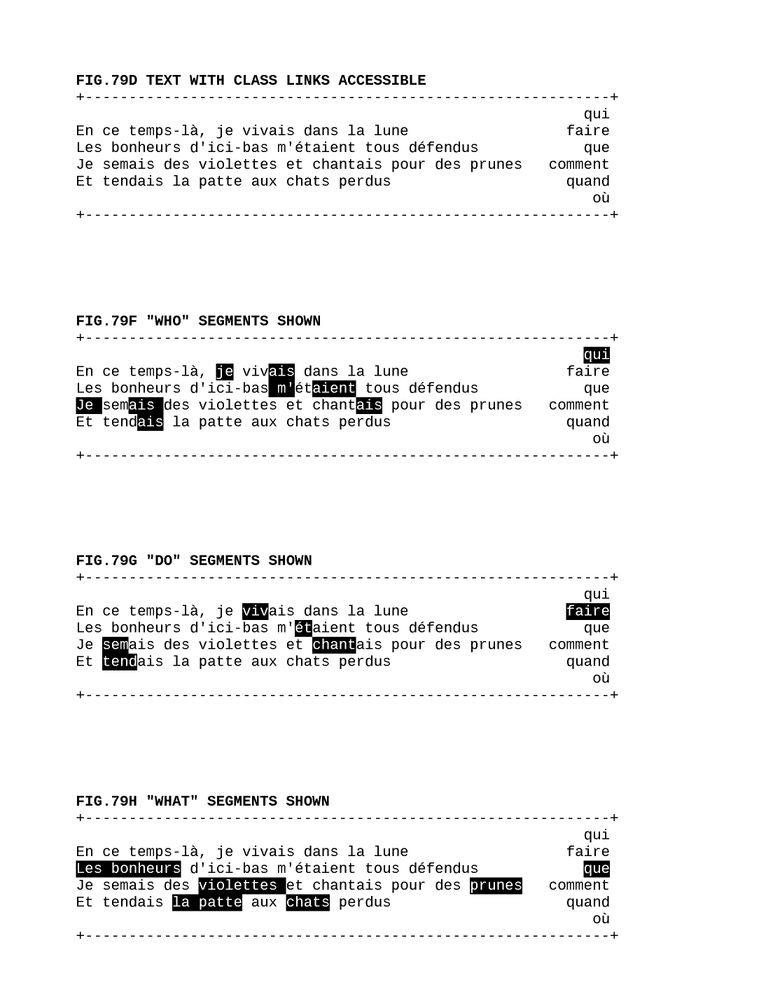

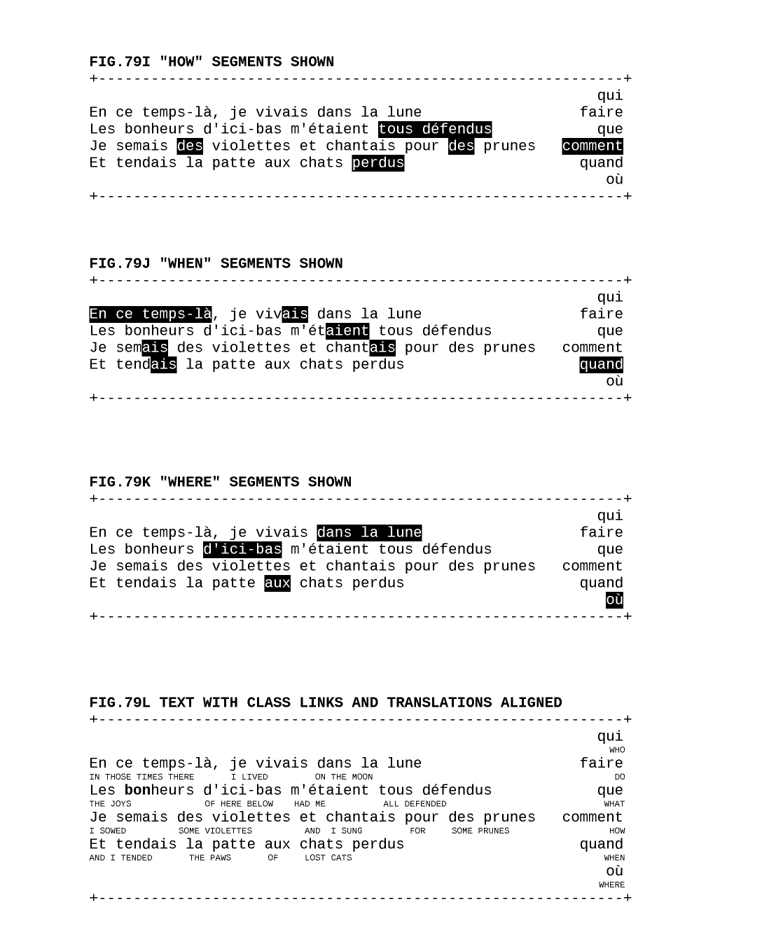

Isolated views of the colorized groups are optional. FIG. 79D, FIG. 79E, FIG. 79F, FIG. 79G, FIG. 79H, FIG. 79I, and FIG. 79K show another method in which segments of structure are viewed in an example text. Links are provided in the views to alternatively sort isolated views of each class. Thus, a reader controls the volumetric rate of information input and is less overwhelmed with too much information.

Example illustrations are provided. FIG. 79A shows a representative example text. Any text which can be segmented into grammatical forms or segments of meanings which can be classified could be used.

FIG. 79B shows a definition of code numbers, class names and colorization schemes to be applied to specified text segments.

Classifications are optionally combined. FIG. 79C shows the FIG. 79A text aligned with code numbers defined in FIG. 79B. It should be noted that within the FIG. 79C illustration, certain segments are defined with two classes. This is achieved by including a comma “,” between the class code numbers. For example in the first rowSet, in the fourth segmentation, “ais” two code numbers are included: 0 and 4. Thus, the segment is used to define “who” is referred to and “when” something happens.

FIG. 79D shows the FIG. 79A text with links added the right side. The links identify the classes defined in FIG. 79B. The links are representative. In a preferred embodiment, views of the specific classes are accessed by voice command.

FIG. 79F shows the parts of the text defining “who” is identified in the text. Definition of who is involved in the text is expressed in the verb conjugation parts, and thus declared in the FIG. 79C in specified segments. Some of these segments also define “when” an action happens, and are thus declared as shared classes as described above, by inclusion of both class code numbers, which are separated by a comma.

FIG. 79G shows the parts of the text which in FIG. 79C are identified as segments which define what actions occur in the text. FIG. 79G highlights generally highlights the verbs. Words and parts of words are highlighted which are related to states of being or actions.

FIG. 79H shows the parts of the text which in FIG. 79C are identified as segments defining what things, such as objects or concepts, are referred in the text. FIG. 79H generally highlights the nouns. Words and parts of words are highlighted which are related to things.

FIG. 79I shows the parts of the text which in FIG. 79C are identified as segments which define how things are and how actions occur. FIG. 79I generally highlights the adverbs and adjectives, as well as descriptions of quantity.

Classifications are optionally combined. FIG. 79J shows the parts of the text which in FIG. 79C are identified as segments which define when things happened, will happen or are happening. Some of these segments are, in this example, sharing class identification with the “who” class, as described earlier. For example, in the first line, in the fourth structural classification segment, the “ais” string is aligned with the “0” code number for “qui” and the “4” code number for “quand”. Thus, the string is separately highlighted with the separate colors in both FIG. 79F and FIG. 79J.

FIG. 79K shows the parts of the text which in FIG. 79C are identified as segments which are used to define where, or in what location, certain things are or where they happen. Any text segments used to define the location of people or things referred to in the text are identified in this view.

Thus, the views seen FIG. 79E, FIG. 79F, FIG. 79G, FIG. 79H, FIG. 79I, and FIG. 79K are variable states of the same text represented in FIG. 79D. The contents of each separate view state are controlled by classes defined in FIG. 79B and aligned with segments as shown in FIG. 79C.

FIG. 79L shows a separate set of phrasal context alignments shown concurrently with the structural segmentations and contents show in immediately previous figures. A single syllable within the second rowSet is shown in bold, to thereby also represent concurrent syllabic segmentation which is synchronized with the audio vocalization. Thusly, multiple segmentations are controlled and alternatively viewed with a single original source text. The multiple segmentation and contextual alignments assist a user in understanding the structure of the text, the meaning communicated by the text, and also to directly experience the sounds associated with each segment of text.

The question classification method is applied to get answers from a text. Referring to the 79L example, to find “who” is referred to the text, the link “qui” is invoked to reveal the 79F “who” segments; to find “what” is referred to in the text, the link “que” is invoked to reveal the 79H “what” segments; to find what happens in the text, the “faire” link is invoked to reveal the 79G action words.

The methods adapt to personal user preferences. The alignment of structural classifications with parts of language examples, whether the structures are meaning-based, such as those defined in FIG. 71 or whether they are form-based, such as traditional grammar structures, can be used by language learners to analyze the construction and content of language as it used. Typically, such analysis is of interest to a minority of language users. Most people don't care about the mechanics of language. Most people simply want to use language to express themselves, inform themselves and to make friends with other people.

Multiple experiences with language are optionally made available. Directly experiencing language, by repeatedly experiencing synchronous vocal text presented with entertaining and interesting authentic materials, and also by selecting and sorting sets of pictures which are used to visually define text segments, where possible, offer more engaging and instructive experiences while learning language.

For those interested in traditional formal grammar structure, and those interested in parsing texts using alternative meaning structures defined in more basic terms, such as questions and actions, the present method is useful. Context alignment methods, such as controlling text segmentation and controlling alignments while wrapping rowSets in variable widths, as described in the FIG. 39 series of illustrations, are applicable. Variable segmentations and alignments of contextual information are used to make any text more comprehensible.

Rhythm, stress and emphasis are key direct experiences. Another application of an alternative set of context information which is aligned with variable sets of text segments is the identification of variable rhythmic and syllabic emphasis heard in audio vocalizations which are synchronized with text. The present system provides ample means for a user to experience the rhythms of language.

Stress and emphasis are optionally controlled in separate rows. FIG. 80 shows four rows and 8 columns; a new row labeled “stress” is added. Exclamation points are included in columns where the vocalization is emphasized. In the FIG. 80 example, the emphasized syllables are commonly stressed while spoken. While this is common knowledge to a native English speaker, the information is not necessarily known to a student of English. When the stress information is applied to the synchronous vocal text presentation, for example by italicizing the emphasized syllable, the user's experience is amplified. The visual communication of the emphasized syllabic reinforced the synchronous connection between the text and the stressed syllabic vocalization.

FIG. 81 shows a timed caption output where the stressed syllables are defined in FIG. 80 are formatted to appear in italics, while the timed syllables appear in bold. When reproduced in playback and each line temporarily appears synchronously in time with audio vocalization, the italic styling communicates the synchronization of the stressed syllables. The rhythmic nature of vocalized is coordinated with the visual appearance of the animated vocal text.

The italicized styling affecting the emphasized syllables in FIG. 81 represent one possible styling control which can be applied to syllabic text segments to visually communicate the instances of emphasis synchronously with the vocalization. Any styling control could alternatively be applied. For example, a separate color could be used.

Where no styling is possible, for example in the simplest plain text closed caption environments, the emphasized syllables can be specially timed to appear to quickly flash, to further emphasize, visually, the synchronous connection with the vocalization.

Plain text is animated to represent a stressed syllable. FIG. 82 represents an emphasized syllable rendered in plain text, which is capable of being played back in standard closed captioning playback systems. As an example, one emphasized syllable from the FIG. 81 example, which appears there upon the third line, is further repeated and timed to the single character segmentation level. The emphasized syllable, in this example, contains four characters. The line is repeated four times, with each character appearing to nest in lowercase within the uppercase rendering of the other characters.

Emphasized syllables are also definable. FIG. 83 shows seven separate repetitions of the FIG. 80 strings row, but each syllabic segment is separately capitalized. The figure serves to illustrate how separate words can be alternatively stressed in a variable instance of vocalization of a constant text. In each instance, the variable stress affects the meaning in the sentence.

When the word “what” is vocalized with extra emphasis, the inference suggests that the listener should focus on the message being communicated. In response to the atypically emphasized syllable, a question may arise in the listener's though process. “What?” “What is the speaker saying?”

When the word “hear” is vocalized with extra emphasis, the inference suggests that the listener may not perceive what is being said. While in a typical vocalization, the word “hear” is already emphasized, it can be further emphasized to stress the inferred message. In response to the atypically emphasized syllable, a listener may ask themselves questions. “Do what?” “Hear?” “Do I perceive the intention of the message?” The speaker is inferring that the message is not understood. “Do I even understand the message?”

When the word “you” is vocalized with extra emphasis, it is inferred that the individual listener may not understand the intention of the message. The listener, upon hearing the atypically stressed vocalization may ask themselves questions, in order to form a response to the inference. “Is the speaker suggesting that I do not understand the message, while in comparison, other listeners do understand it?”

When the contraction of the words “I am” or “I′m” is vocalized with extra emphasis, the speaker may be calling attention to their own personal opinion about a subject, in contrast to another's opinion. The inference suggests that the speaker is not referring to what anyone else is saying, but rather specifically to the actual message that the speaker is saying. Attention is called to the speaker of the message. Questions may arise in the listener' mind. “Do I understand the speaker's point of view on this topic?” “Do I understand that this is specifically the speaker's opinion, in contrast to other opinions?”

When the syllable “say” within the word “saying” is vocalized with doubly extra emphasis, the inference may be to call attention to the form of the message. A listener, in order to form a response to the question, may typically ask themselves questions. “What is the speaker actually saying?” “How is the speaker saying the message?” “How does the spoken form of the message affect the intended meaning and communication?”

When the word “do” is vocalized with extra emphasis, the inference is clearly to request verification and validation to confirm the understanding. An additional inference is that the speaker does not completely believe that the listener understands the message. A listener, in order to form a response to the question, may typically ask themselves questions. “Do I or do I not understand the message?” “Is it true that I do not understand the message, or is the assertion false?”

If the syllable “ing” in the word “saying” is vocalized with extra emphasis, the inference may be construed to suggest the immediacy of the request. Attention is drawn to the active state of the action. A listener, in order to form a response to the inferred question, may typically ask themselves questions. “What is being said at this moment?” “How is it being said right now?”

Atypical emphasis in a syllable alters meaning. Thus, FIG. 83 and the description above represent examples of how a single constant textual expression of language usage may be variably vocalized, with emphasis place upon specific words and syllables, to thereby materially affect the message communicated by the language usage. It is not uncommon for a writer, when adding emphasis to a word or syllable within a text, to italicize that word or syllable, to thereby communicate the inferred meaning.

How language is vocalized affects its meaning. Multiple studies show that communication between humans within physical spaces is primarily non-verbal. Where words are used and vocalized, a great deal of meaning is communicated in how words are vocalized, which syllables are stressed, what tone of voice is used. The ability of a static text transcription to capture these meaningful and directly experiential communications is limited. Animated synchronous vocal text presentations, however, now include more ability to communicate emphasis and rhythmic elements of language usage.

Emphasis is optionally controlled in a rowSet row. The inclusion of extra emphasis within a synchronous vocal text is provided with the inclusion of an additional row, which allows the extra emphasis to be added to specific segments of text.

A stress row and an emphasis row are optionally included. FIG. 84 shows the FIG. 80 representation with an additional row, which is labeled “extra emphasis”. In the FIG. 84 example, the first word “do” is identified as vocalized with extra emphasis by the inclusion, within the extra emphasis row, of two (2) exclamation points in alignment with the segment.

Syllable stress and emphasis are optionally controlled in a single row. FIG. 87 represents a method to control both normal emphasis and extra emphasis within a single row. The row is labeled “combined stress and emphasis row”. As in FIG. 80, normally emphasized syllables are identified with the inclusion of a single exclamation point, which is aligned with the segment column containing text which is normally vocalized. Similarly to FIG. 84, two exclamation points are included in the segment column which contains the syllable vocalized with emphatic emphasis. In the FIG. 87 example represented, the emphatically emphasized syllable is “hear”, which is in the third column. In the combined stress and emphasis row, there are three exclamation points which coincide within that third column. Thus, the single exclamation point defining normally stressed syllables, and the double exclamation point defining extra emphasized syllables are combined, thereby enabling a plurality of emphasis specifications to be included within the text.

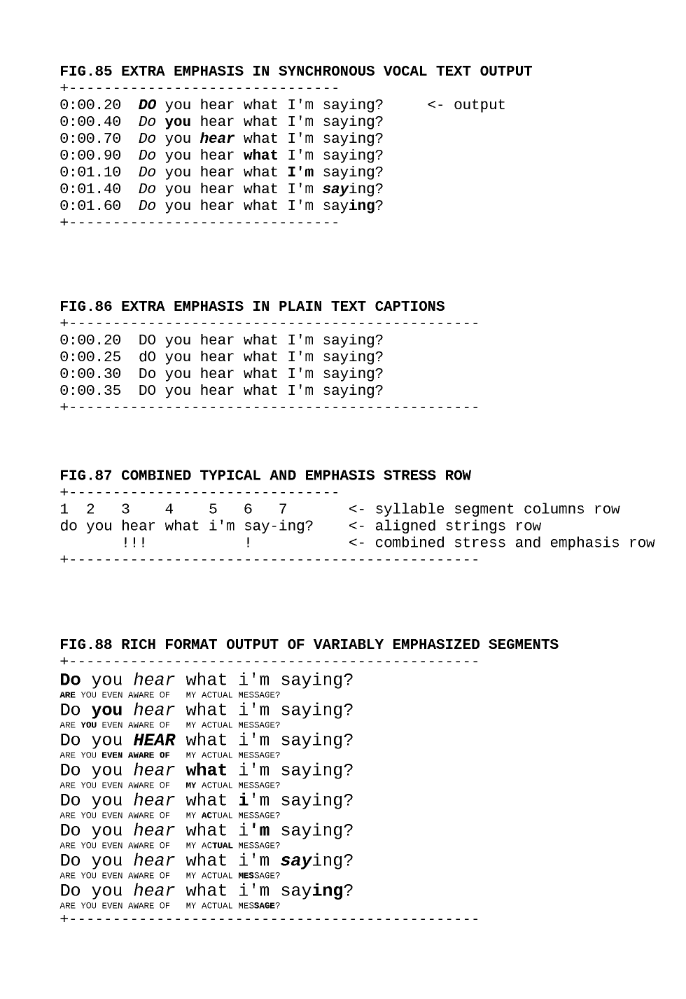

Plain text animation can visually synchronize emphasis. FIG. 86 represents a method which, using unstyled plain text, the extra emphasis can be communicated within current common captioning environments, even with short two letter words or syllables. In FIG. 86, the first line seen in FIG. 85 is repeated four times, while the timing of 200 milliseconds is divided into four parts. The repeated line is identical, except that the first word “do”, which in FIG. 84 is identified as vocalized with extra emphasis, is shown do alternate in three different states. In the first and last repetition, the word do is rendered in all uppercase letters. In the second repetition, the second letter is capitalized while the first letter is not. In the third repetition, the first letter is capitalized, while the second letter is not. When replayed in sequence, extra attention is drawn to the special syllable, which is synchronous with the extra attention drawn to the emphasized vocalization.

Both stressed and emphasized syllables can be rendered in styled captions and full texts. FIG. 85 represented timed output, which includes special styling controlled to communicate the extra stress information specified in the extra emphasis row represented in FIG. 84. The first syllable, in this representative example, is styled to appear italicized throughout the timed sequential phases presentation, much like a writer could emphasize the stressed word within a static text. Concurrently, each syllable appears in bold as it synchronously is presented visually while the corresponding audio vocalization is reproduced. Thus, the vocalized emphasis stressing the word “do” is synchronously communicated visually in text, to thereby communicate the specific inference, which is to request definitively an answer as to whether or not the listener of the messages does or does not hear the message.

Styled text can variably render both stressed and separately emphasized syllables. FIG. 88 represents one example of text formatting which applies the syllable stress and emphatic emphasis definitions to increasingly synchronize the visual appearance of text with specific instances of vocalization. Informed by the syllabic emphasis specifications defined in FIG. 87, individual syllables are separately styled to communicate their level of emphasis. Normally emphasized syllables include “hear” and “say”. Extra emphasis is added to the syllable “hear”, by maintaining italicization throughout the presentation, and also by capitalizing the syllable precisely while it is vocalized.

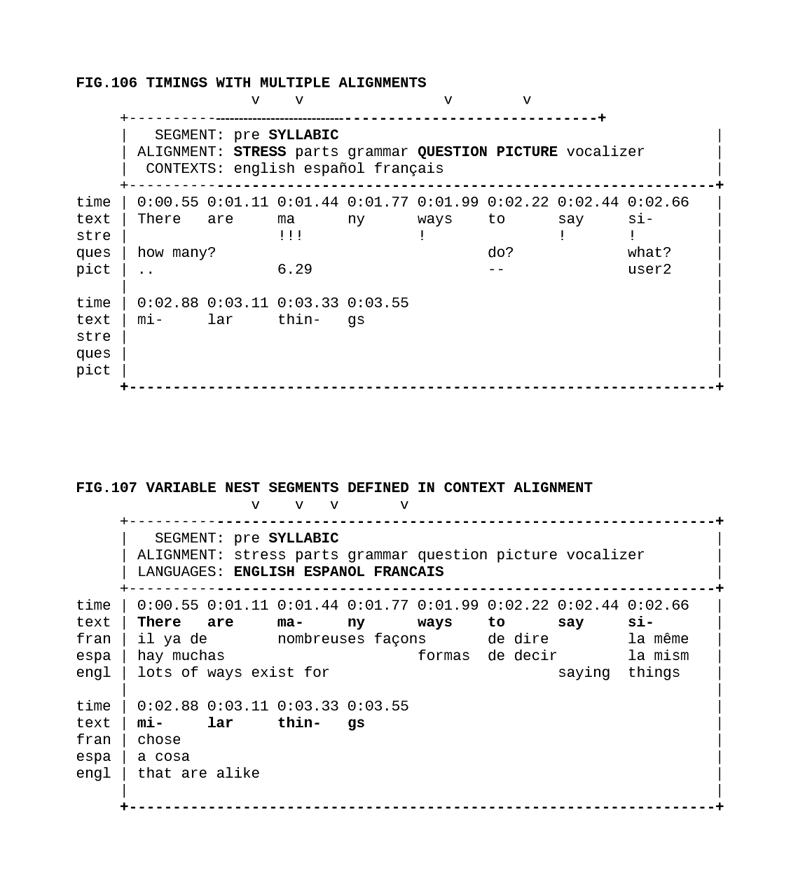

Styles can be controlled by multiple aligned rows. Alignment FIG. 88 also includes, for illustration purposes, aligned context words in the same language. The aligned context words, in this example, contain a restatement or clarification of the intended message expressed in the original text and vocalization. Further, the illustration also includes colorized communication of basic language elements as described above and in FIG. 67, FIG. 68 and FIG. 70 ETC. With the combination of several elements specified in this disclosure, it is shown that multiple layers of meaning can be concurrently communicated, and thereby present highly informative presentations used by language learners. As described in FIG. 106, variable elements can be included or excluded within specific instances of presentation. The playback speed of the presentation is controlled, so the information can be gathered at a pace selected by the learner.

Language can also be experienced in association with pictures. Pictures come in many forms. Still pictures may include photographs, drawings, comics, paintings, collages, montages; motion pictures such as movie clips, video recordings and animations, including animated .gif files offer more dynamic pictures. Pictures are plentiful. As of 2011, there are billions of pictures on the Internet. Trillions more pictures will soon be available. Pictures are already associated with text segments. Visual search engines apply text string input to find vast numbers of images. Results, however, are currently uneven. The present method is applied to improve such results, with special emphasis on sorting multiple pictures in association with a text segment while it is used in context.

Some text segments are easily pictured. Different pictures can better describe the same text used in different contexts. A single text segment can be described with many different pictures. Not all text segments are easily described with pictures. A single picture can be described with many different text segments. Pictures do not always clearly describe a single word, phrase or text segment. Relation of pictures to words is often less objective and more subjective. In most cases, more pictures more accurately define a text segment. As with vocalizations, various experiences with pictures reinforces the learning. Access to multiple pictures of text segments is trivial. The present invention simplifies the association of sets of images with a word or set of words. Sorting sets of multiple pictures in association with a text segment is simplified. Ranking pictures is simplified. Picture sets are saved. Garbage is managed. Versions of picture sets are saved. Comparison of sorted picture sets is simplified. Group picture sets are shown by default. Individual picture sets are easily found.

Picture sets are associated with synchronous vocal text segments. Both individually selected sets and group selected sets of pictures are accessed in human readable URLS which forward to machine readable lists of sorted pictures. Synchronous vocal text playback is invoked when a picture set is accessed, and when individual pictures within the set are viewed or resorted. Thus, a user repeatedly experiences visual representations of the meanings, while hearing various audible vocalizations of the words, which are synchronized with dynamic text presentations of the words. The language is repeatedly and directly experienced, and thereby easily learned.

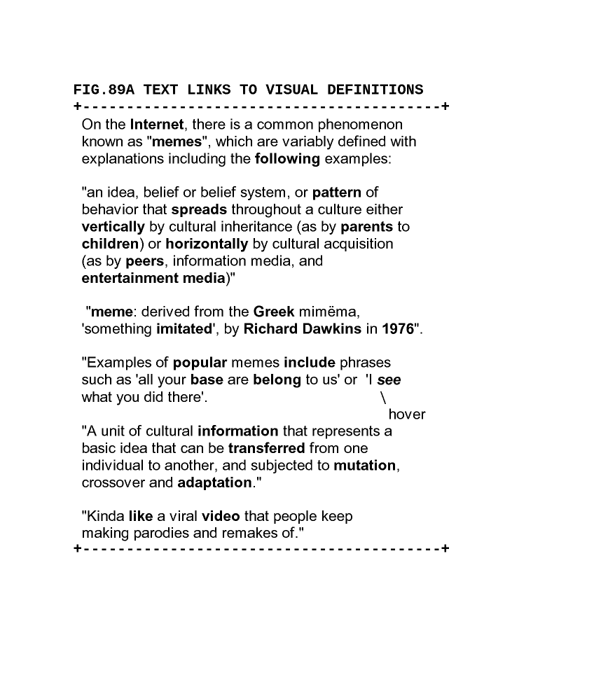

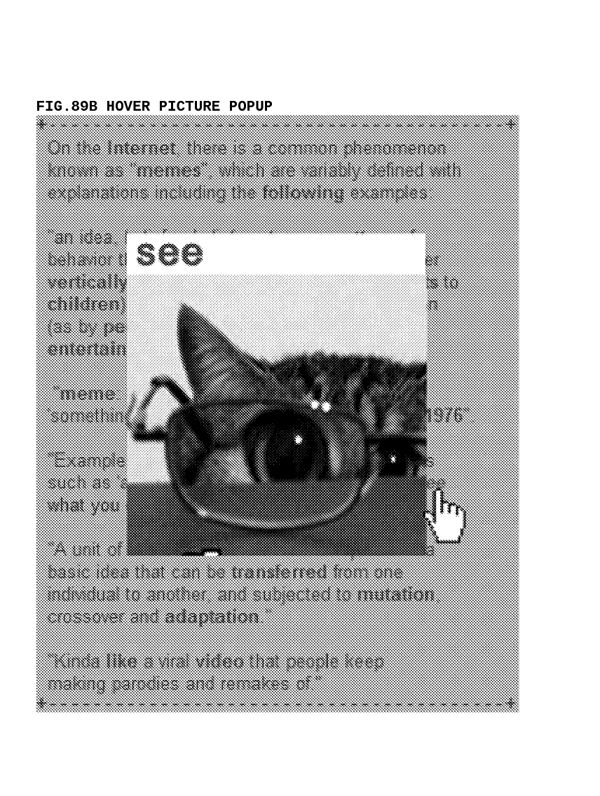

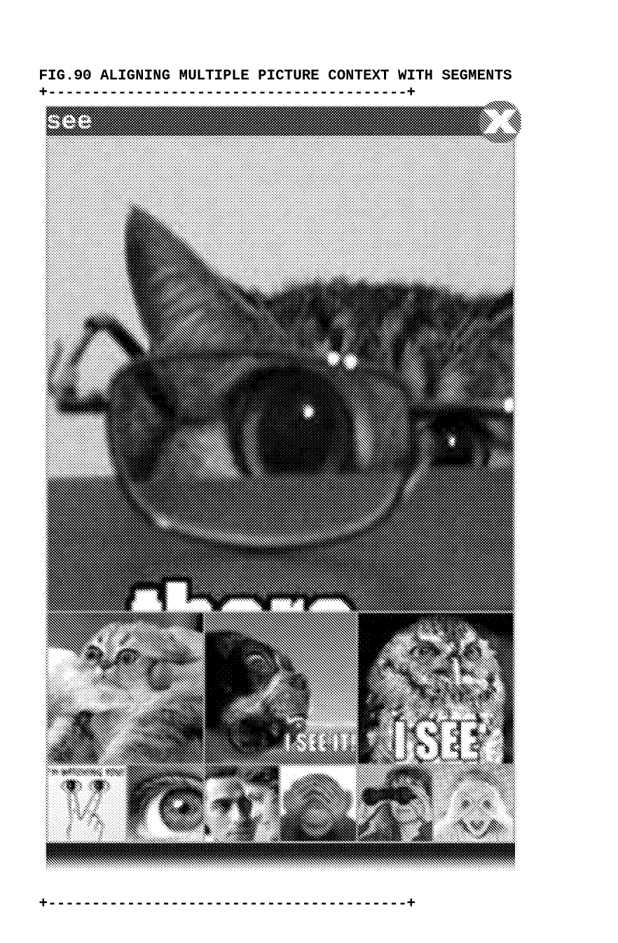

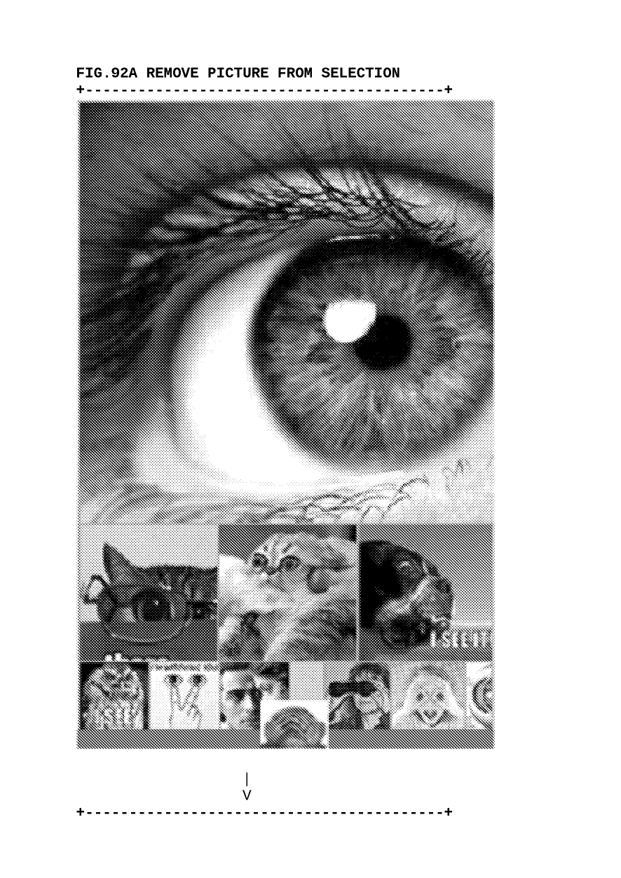

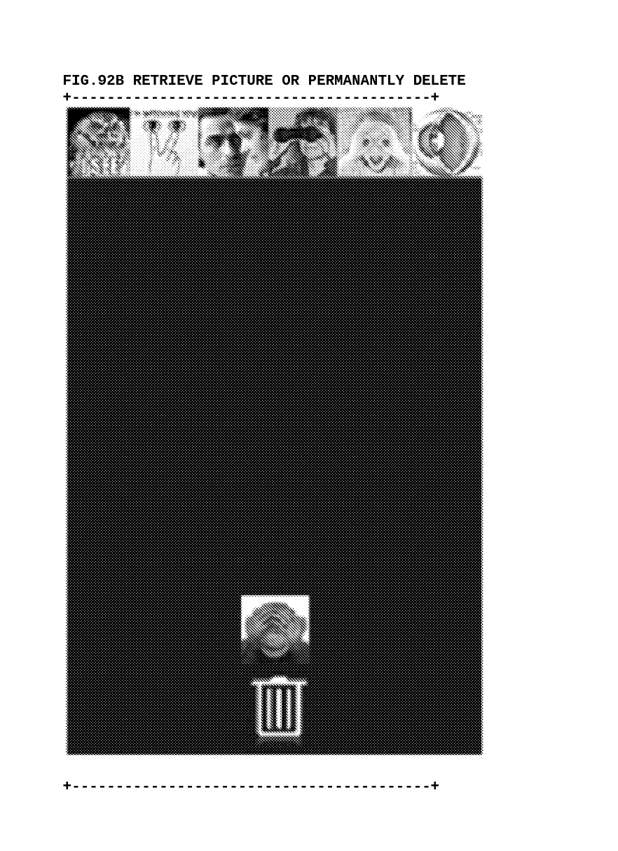

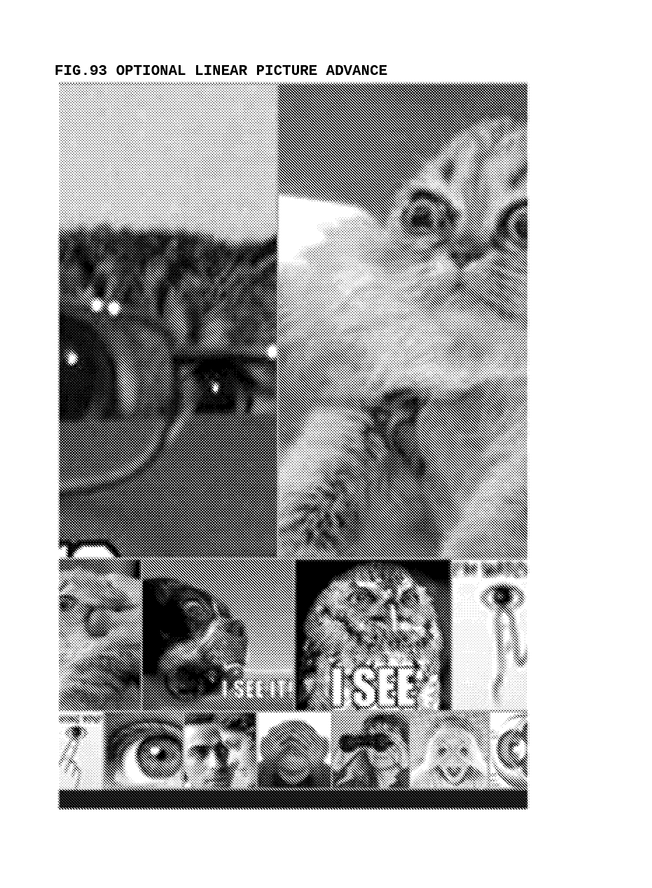

FIG. 89A represents a sample text which can be aligned with pictures; the text can also be vocalized, syllabified, phrasally segmented and aligned with textual context information. Several words and phrases within the FIG. 89A text are shown in bold, which is intended to represent them as HTML links. The linked information is optionally accessed with a direct link or preferably via implementation of the HTML “hover link” control. The hover links show information while a user places the cursor over the area where the linked text is displayed. The information displayed while the link is invoked may include photographs, artworks, videos, animations and other such digitally rendered visual presentations, which are here referred to as “pictures”.

FIG. 89B shows a view of a picture which is linked with a segment of text. The picture is represented as appearing while the cursor hovers over one of the links represented in FIG. 89A; if the cursor were to hover over a separate link, a separate picture or set of pictures would appear. Each picture linked is used to illustrate visually the meaning of the word or words linked. When the cursor exits the area over the hover link, the picture disappears and the FIG. 89A text-only view is resumed.

Pictures illustrating text segments are easily reviewed. The user can hover over various links in the FIG. 89A text to see each link visually illustrated in pictures. Thus, with minimal action, a user can hover over the links to gather visual representation of information in the text quickly. Where tab advance throughout the hover links is enabled, the user can repeatedly press the tab key to see various pictures which illustrate the contents of the text.

Illustrated text is more easily learned. The words and phrases represented as hover links in FIG. 89A are selections which can be illustrated visually. Where written words evoke visual memories and imagination within a reader's experience, such language can be aligned with links to digital pictures. For a user learning a new language and learning to read a new language, seeing pictures which help to illustrate the intended meaning of a new word or phrase is helpful; where it can be effectively illustrated in pictures, new language is more easily learned, as it is more directly experienced.

A visible example is directly experienced. As an example, the word “see” used in the 13th line of FIG. 89A represents a single word which can be represented in pictures. The word is shown in a red color and italicized, which intends to represent the invoking of a link or preferably hover link. Immediately as such a hover link is invoked, a picture or set of pictures, such as the picture shown in FIG. 89B, appears upon the screen.

The contents of a visualization are easily manipulated. If a hover link as described and represented in FIG. 89A and FIG. 89B actually clicked, the picture or pictures shown are managed. Multiple pictures are then viewed and sorted in association with the currently linked text segment and current context within which the active text segment is used. A customized graphical user interface is provided, which enables a user to quickly experience, sort and rank multiple pictures associated with the text segment.

FIG. 90 shows a picture sorting tool. Multiple pictures are presented while ranked in order. A preferred picture appears in larger scale, in contrast to less preferred pictures appearing in smaller scale. The pictures are sorted as described below. The sorting process and optional concurrent synchronous vocal text playback enables a user experience visual dimensions of specific words, to thereby learn new language.

FIG. 90 shows a set of pictures used to illustrate a text segment. In the uppermost area of FIG. 90, there is an example text segment. The segment is identical to the linked segment seen in immediately previous figures. In FIG. 90, below the text segment, there are ten pictures shown within the representation, contained within three ranked rows: one primary picture is represented which fills approximately 60% of the viewing area. Within a separate row below the primary picture, there are three pictures represented which fill approximately 20% percent of the viewing area. Within a separate row below these three pictures, six pictures are represented within an area which fills approximately 10% or the total viewing area. The pictures represent the top ten pictures found which associate a word, set of words or a name represented in a text string, which is shown above the pictures.

The set pictures shown in FIG. 90 are representative. Any picture can be included within the frames shown. Motion pictures, animated gifs, diagrams, photographs, drawings, painting, cartoons, animations, and other such pictures are represented in static thumbnail views, each separately contained and appearing within a specific frame.

The pictures shown in FIG. 90 correspond to a word linked in FIG. 89A. The word is “see”, and is used as an example. If a separate FIG. 89A hover link word represented were to be used as an example to illustrate the present method to sort pictures and align them with text segments, then separate picture contents would appear. While the present example text segment, “see”, is visually illustrated by the selection of pictures seen in FIG. 90, a broad variety of other pictures could be used to illustrate the example text segment.

The pictures shown in FIG. 90 represent thumbnail views. The entire contents of each picture are not necessarily shown. “Thumbnail” is used to describe miniaturized versions of a picture, which are used to symbolize the actual picture or other data. When a link is included with the thumbnail representation, then other data, such as the full view of a single picture, can be easily accessed and viewed.

The thumbnails are optionally cropped into square proportions. If pictures are not cropped, and proportional portrait and landscape views are permitted, then the tall portrait proportions tend to be considerably reduced, while the wide landscape proportion pictures are apparently larger and thus perceived as more important. When controlled and represented in perfect squares, some details may be lost at the edges of the pictures, but a more balanced representation of picture contents is presented. Full views are presented with the actual proportions of the original picture dimension.

Specification of the picture area within the square cropping limits is controlled. Squarely proportioned thumbnail views are used to view the pictures and sort them. The thumbnail views appear in three scales: large, medium and small. If a picture needs to be increased in size to fit into the larger views, it is increased in size. If the picture quality declines due to the enlargement, then the picture is optionally dragged down into a lower priority row. An interface is provided to define the specific square area which is used to represent the picture within the sorting interface.

Any single thumbnail within the set can be viewed in full. Double clicking on the thumbnail reveals the entire picture. The full views of pictures are optionally zoomed into, scrolled horizontally and vertically, which allows details within the pictures to be seen. Such controls in picture viewing are standard in modern graphical user interfaces. Within the present interface, when a picture is zoomed into, no sorting is possible, as the vertical scrolling control takes precedence. If zoomed out to a full view of the picture, then the sorting described below is easily executed.

A picture can be sorted also while viewed in the full view: if the picture is dragged up, it is sorted to receive a higher rank and thus appear larger. If it is dragged down, its rank is lowered, and it then appears to be smaller. To be clear, this process is more fully described and represented below in FIG. 97. If a picture is sorted while in full view, the single picture viewer is replaced with a view of the newly sorted arrangement of pictures in the FIG. 90 represented sorting interface. If the full view is generated from a picture in the lowest row with the smallest pictures, and the picture is dragged down within the full view, then it is explicitly communicated that the image is now in the trash.

Sorting is optional while in the full view. It is also possible to make no sorting evaluation of the picture. The full view is within a modal box, which provides a visible and actionable “x” icon, which can be clicked to escape the full view of the single picture and return the assortment of pictures previously seen.

Sorting is executed simply by moving pictures up or down. Dragging a picture upward raises its priority; dragging a picture down lowers its priority. The pictures within the three row presentation are sorted simply by dragging the preferred images into the larger rows above, or by dragging less preferred pictures into smaller rows below.

Moving a picture below the bottom row removes it from view. Pictures are removed from the view by dragging them to the dark area below the bottom row of pictures, as shown in FIG. 92A. Thus, unwanted pictures are easily removed. When the interface is used to review new images, and where the user has access to multi-touch controls, the user can select multiple pictures to remove with the same sequence of actions. It is critical that the user can eliminate unwanted pictures with minimal efforts. It is also critical that the user can recover any pictures accidentally removed. Such trash removal or recycling systems are very well defined in common user interfaces, and also applied within the present interface.

Minimal user action is required to remove unwanted pictures from FIG. 90 view: a user simply drags the picture down below the lowest row, and the picture is removed. As represented in FIG. 92A, at the bottom of the frame, the garbage area changes to a more red color while the picture is removed. The interface appears to respond to the action, to communicate to the user that the unwanted picture has been removed. The representation provided is one of many optional methods usable to achieve the required confirmation that a change to the existing data is made.

The removal of a thumbnail loads a new thumbnail into view. Within the set of sortable pictures in FIG. 92A, in the lowest row with the smallest pictures, and in the right edge of that row, a new picture begins to appear. The source of the picture is specified below. The new picture, as well as the two pictures immediately its left, should be imagined as sliding toward the left, to thereby occupy the gap which was left over by the picture which is in now the process of being removed. The process represented in FIG. 92A is executed quickly, within a time frame range of 0.300 milliseconds to three seconds. After the operation, a stable view of the resorted data remains.

The accidental removal of a picture is easily reversed. If a wanted picture is accidentally dragged down into the black area and removed, the user simply double clicks on the lowest dark area to review any pictures which have been removed.

FIG. 92 shows a full view of the garbage collection area. Approximately 80% of the display area is filled a dark background color which is consistent with the minimized garbage area shown in the sortable views. A trash can icon is presented at the bottom of this full view of the garbage collection areal. In the uppermost 20% percent of the display, the lower row of the sortable interface is represented; double clicking within this upper area, or dragging it down replaces the full garbage collection view with the sortable view represented in FIG. 90.

In the full view of collected garbage, pictures are sorted by moving them up or down. Unwanted pictures in the garbage collection area are temporarily stored and sorted in two ways. Moving a picture or pictures up above the garbage collection background color returns the pictures into the sortable list. Such an action is confirmed by including the restored picture in the list of thumbnails in the top of the illustration. If a picture or pictures are dragged down into the trash can icon, they are permanently deleted. A confirmation of this deletion action can optionally be required, but only if the confirmation process can optionally be removed. Thus, the user can safely train themself the process of permanent deletion, then remove the confirmation process, then execute final deletion operations with minimal effort. If there are no pictures stored in the full garbage collection view, it is replaced with the sortable view represented in FIG. 90.

Sorting is consistently executed by moving pictures up or down. In all views, including any unzoomed single picture in full view, and including the picture sorting view shown in FIG. 90, and including the garbage sorting view shown in FIG. 92, sorting actions are executed with minimal thought effort: the pictures are simply moved up or down. Mistakes are as easily corrected. The sorting actions are explicitly confirmed, as the result is immediately evident in the visibly repositioned layout.

Thumbnails are also sorted horizontally within the rows. A direct horizontal movement applied to a thumbnail moves the set of thumbnails to the left or right, as described above. When a thumbnail is moved vertically, it becomes sortable. A simple vertical movement or “quick flick” up or down is applied to sort the thumbnail accordingly. However, when a user's control of the thumbnail is maintained, then that thumbnail can be repositioned in the horizontal sequence of the thumbnails to either side.

FIG. 93 shows a linear method to scroll through the assorted thumbnails. Within the FIG. 93 illustration, each thumbnail appears to be moved toward the right side. In the lowest, smallest row, on the left side, a new thumbnail appears to be coming into view. On the left side of the lowest, smallest row, a thumbnail appears to be cut in half. The other half of that thumbnail image now appears on the right side of the middle row; this other half of the thumbnail is now enlarged or scaled up to match the size of the thumbnail images in the middle row. On the left side of the middle row, the thumbnail appears to be cut in half, with the other half continuing in larger scale in the top row.

In the FIG. 93 linear method to view the sortable thumbnails, one single row of pictures is represented on the three apparently separated rows. The rows, however, represent the same row, with the row contents simply appearing in variable sizes. As represented in FIG. 93, if the contents of one sized row are moved horizontally to the left or right, then the other apparent rows respond, moving sideways in the same direction as the manipulated row, left or right. In the linear assortment method, if the pictures are horizontally scrolled, then they images snap into place, so that static view states are consistent with the orderly view represented in FIG. 90.

FIG. 94A represents the linear method layout in a diagram. The figure shows a numbered sequence of thumbnail areas, which appear in three various sizes. All of the thumbnail areas represented depict a single row of thumbnails, which is ranked linearly in a numeric sequence. The uppermost picture is ranked as number one. In the middle or second row, the left most picture is ranked number two. The middle picture is ranked number three, and the picture on the right is ranked number four. The smaller pictures on the bottom row are ranked from left to right as picture numbers five through ten.

FIG. 94B represents FIG. 94A diagramed contents now horizontally scrolled five positions to the left. Thumbnail area number six is now seen in the largest view. Five new thumbnail area numbers are now included in the lowest row with the smallest viewing areas. FIG. 94B represents one of an unlimited number of positions where a set of ten (10) sequentially numbered thumbnails are viewed a single time. The set could include the range of numbers between three and twelve or twenty-one and thirty. Thumbnails are scrolled to the left and right. As represented in the illustrations and diagrams, the thumbnails are scrolled horizontally to the left or to the right. No more than ten full thumbnails are seen at one time. When the highest ranked number one thumbnail area is seen in the largest view, then no more leftward scrolling can occur. However, there is no potential limit to the number of pictures contained within the linear row. As represented at the bottom of FIG. 94A and FIG. 94B, more pictures can be loaded into the sortable view.

Direct horizontal user action invokes horizontal scrolling controls. If any part of any thumbnail area is scrolled directly to the left, without a previous direct vertical movement, then topmost picture scrolls to the left out of view, the left most picture in the second row appears in larger scale in the uppermost full view frame, and all pictures scroll one step to the left. In so doing, a new picture appears in the lowest row in the frame on the right. This picture is loaded from a previously saved assortment of pictures, another user's selection of pictures for a specific text string, or from an Internet image search engine.

Scrolling the largest thumbnail advances the pictures one at a time. When a user applies a full width scrolling command from one side of the display to the other upon the largest set of thumbnails, only one thumbnail is advanced. Such a control is applied when the user wants more time to review the contents of each picture represented.

Scrolling the smaller set of thumbnails advances the pictures much faster. When a user applies a full width scrolling command from one side of the display to the other upon to the smallest set of thumbnails, then in this example, six different pictures are quickly represented in the largest thumbnail views. The effect is similar to a differential gear, where comparatively little effort is levered to a greater effect. Thus, a user can effectively review thumbnails slowly or quickly, and with minimal effort control the volumetric flow on information input.

Many new pictures are quickly introduced in the smaller set of thumbnails. Unwanted pictures are quickly removed by dragging them down into the black area. Preferred pictures are quickly prioritized by dragging them up into larger views. As the user scrolls through the horizontal arrangement of the pictures, they are quickly viewed and evaluated. They are easily prioritized simply by dragging them up into larger views or down and out of sight.

Users receive feedback which confirms their actions. Where possible, audible and haptic feedback accompany movement of the pictures in the separate carousels. The audible click occurs whenever a picture frame edge reaches the display viewing area edge. The upper carousel row with the largest pictures scrolls appears to scroll more slowly, with fewer audible clicks, while the lower carousel row with the smaller pictures appears to scroll much more quickly, with many more picture frame edges reaching the display area edge, thus producing a far more rapid rate of audible clicks.

The linear method works best while sorting a lesser number of pictures. The sorting capacity of the linear method represented in FIG. 93, FIG. 94A and FIG. 94B is limited in instances where a high number of pictures are managed. For example, when a new picture is introduced in the smallest row in thumbnail area 50, and the user wants to prioritize the picture in the top ten set, 5 separate sorting actions would be required.

To sort larger numbers of pictures, carousels are used. Using the less linear method, the three sizes and tiers of pictures become separate carousels, which are used to sort pictures in three separate levels of priority. The three rows do not represent a single row, but rather three separate rows, which are used to control the image sorting process. Each row is arranged in a carousel.

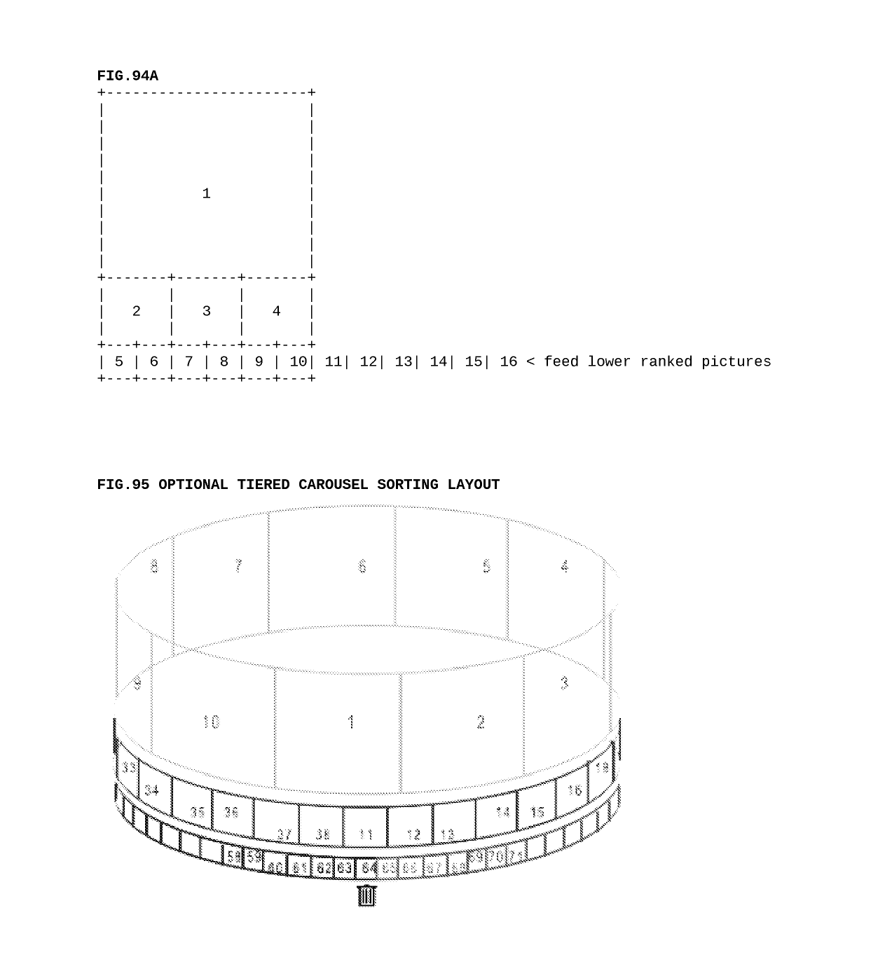

Thumbnails are repeated when using carousels. Each carousel contains a limited number of pictures which, when the limit is reached, the series of pictures is repeated. As seen in FIG. 95, each thumbnail within a carousel combines with other thumbnails in that carousel to form a circle. Thus, if ten thumbnails are included within one carousel, a repeated view of the first thumbnail is shown immediately after the tenth thumbnail. FIG. 95 shows a diagram representing thumbnails located in separate carousels, and a row where new thumbnails are fed into sorting interface. As with the linear method, the garbage collection area is provided at the bottom of the interface.

Using carousels, pictures are sorted into three tiered rows. The most preferred pictures appear in the carousel in the top row, which contains the larger views of the pictures. Generally preferred pictures appear within the middle sized carousel. As these picture are formatted as thumbnail images which appear three times smaller than the largest pictures on top, their overall contents can be quickly scrolled through and reviewed. The smallest thumbnail areas represented in the bottom row are arranged in a special carousel which, as disclosed below, allows new thumbnails to be introduced.

Using tiered carousels, each row contains flexible number of thumbnails. If a user wants many pictures in the largest row, then the user will need to scroll horizontally through many pictures to access a preferred picture. By dragging less preferred pictures down to a lower carousel, there is less need for horizontal scrolling, as more thumbnails are visible. Thus, a user can restrict a group of preferred pictures, while having fast access to a greater number of thumbnails within the smaller rows below.

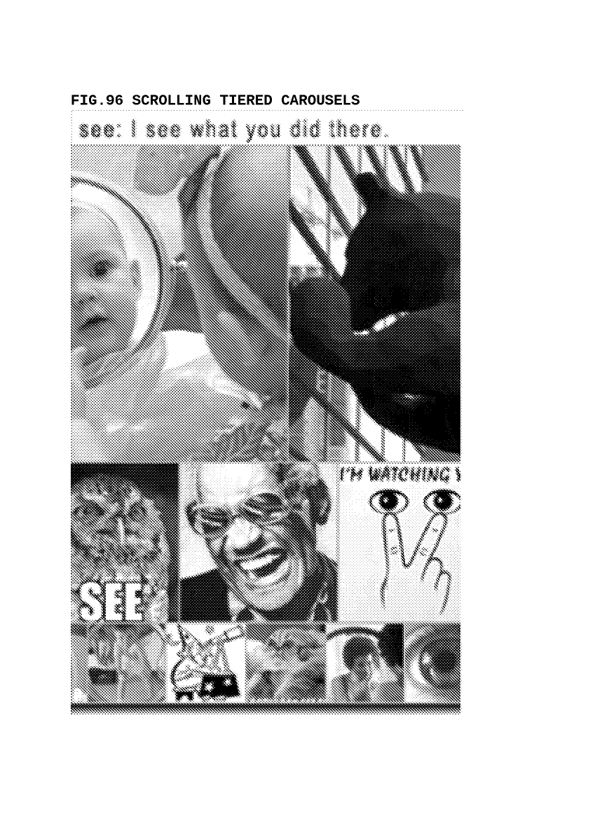

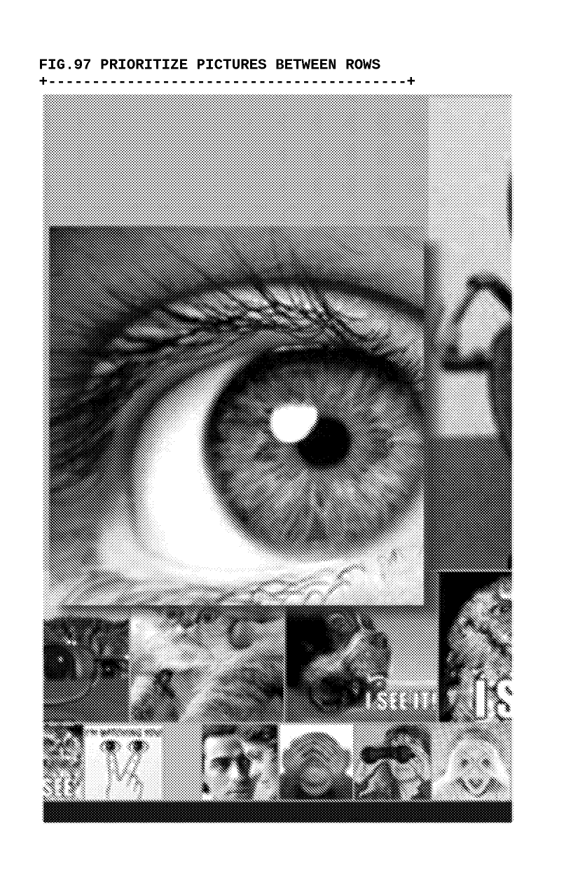

Using tiered carousels, each row is controlled independently. As seen in FIG. 96, each tiered carousel contains separate thumbnail pictures. Unlike the linear sorting method described above, the tiered carousel contents do not represent a single row of linearly sequenced thumbnails. If, for example, the middle carousel is horizontally scrolled the left or right, the thumbnails within the carousel do not reappear in the upper or lower carousel. In another example, the lower carousel can be scrolled sideways in one direction and then the upper carousel can be scrolled sideways in the other direction. Horizontal scrolling of one of the carousels does not affect the position of the other carousels.

In the larger sized carousel, thumbnails scroll slowly. Horizontal scrolling of the largest sized thumbnails contained in the top carousel requires more user effort; each thumbnail is advanced one at a time. Each of the largest thumbnails, however, is easily viewed: double clicking to access a full view of the actual picture is thus not always required. A user can simple view the large thumbnail and evaluate its relevance to the text segment being illustrated.

In the middle sized carousel, thumbnails scroll at a moderate speed. Sidewise scrolling in the middle carousel performs at a moderate speed. Thumbnails are easily viewed and more pictures represented by the thumbnails can be easily accessed.

In the smaller sized carousel, thumbnails scroll very quickly. While greater user effort is required to see the image contents represented in the smaller thumbnails in the bottom carousel, a large quantity of thumbnails are viewed at the same time. When scrolled entirely across the width of the frame, in this example ten new thumbnails are made visible. With ten quick movements, a user accesses one hundred thumbnails.

Pictures are quickly assessed and acted upon. Sorted up, down, sideways or disposed of, existing thumbnails are quickly ordered into preferred ranks. As a user orders an existing set of thumbnails, unsuitable pictures are removed and new pictures are introduced.

Unsorted thumbnails are preferably introduced in the lower carousel. Multiple configurations are possible: thumbnails of pictures sorted by trusted sources may optionally be introduced in the central or upper carousel. Methods to introduce new pictures into the sorting interface are discussed in detail below.

Sideways scrolling motion within tiered carousels flows freely. The thumbnails do not need to snap to a predefined grid, as is preferable in the linear sorting tool. Depending on the rate of horizontal motion actively input by a user, the carousel may spin slower or faster. As seen in FIG. 96, the largest carousel row view may optionally include the contents of more than one thumbnail.

Sorting actions in tiered carousels or one linear row is identical. Consistent throughout the image sorting method, simple vertical movement applied to a thumbnail changes its position. Moved up or down and then sideways, the thumbnail is repositioned horizontally within the same carousel. Moved up, the thumbnail is transferred to a larger carousel. Moved down, the thumbnail is transferred to a lower carousel. Moved to the bottom of the display, the thumbnail is transferred into the garbage collection area.

Garbage management in tiered carousels or one linear row is identical. Wanted thumbnails accidentally removed for the sorting carousels are accessed by double clicking on the garbage area. Management of garbage is represented in FIG. 92A and described above.

Large numbers of pictures are easily sorted while using tiered carousels. Where using the linear method, repeated user action is required to move a thumbnail more than 10 positions in the sequential order, the tiered carousel method allows a single user action to move a thumbnail from low priority to high priority. For example, if there are one hundred pictures in the smallest carousel row and ten pictures in the largest carousel row, the repositioning of a thumbnail from the lowest rank to the highest rank requires one simple user action; the user moves the picture from the lowest row to the highest row with minimal effort.

Many pictures are represented and can quickly be scrolled through and evaluated. Temporary full views of potentially interesting pictures are, as explained above, accessed with a double click upon the thumbnail version, and sorted there as desired with a simple upward or downward action applied. For a user sorting pictures, the benefit is easy access to a select few picture in larger views within the top-most carousel, and fast access to many potential pictures in smaller views contained in the lower carousels.

Linear and tiered carousel formats are optionally combined. The top ten pictures, for example, can be linearly ordered. Remaining pictures are then sorted using carousels. For example, if after the first ten pictures, there are eight pictures in the “top tier” variable, twelve pictures in the middle tier carousel and twenty pictures in the lower carousel, and then the forty pictures which are not in the top ten are easily sorted. A new picture introduced in the lowest row, for example, can be quickly prioritized into the top ten pictures with two user actions.

Linear or tiered carousel sorting methods are optionally switched automatically. In this configuration, the linear method is used until more than a defined variable number of pictures are currently being sorted, at which point the sorting method automatically shifts to the tiered carousel method. If the variable number of pictures is assigned the number twenty, for example, then when twenty-one or more pictures are currently being sorted, the carousel method is used.

New pictures are introduced as needed. To add a new picture into the sorting interface, a path to the location where the data which forms the picture is required. Further, an evaluation as to whether the picture illustrates the meaning of the text segment which is currently being described is required. Pictures are required and sorting is required.

Text segment defined pictures are found online. A variety of Internet based image search engines provide robotic associations between pictures and specified text segments or search queries. Typically, thousands of images which are associated with specific text segments. New unsorted pictures introduced from Internet search requests are not always appropriate for the present purpose, and are removed as specified. Picture not located by Internet search engines are also optionally included.

Users may include other pictures. Either from online networked data sources or from local data sources, users easily add picture data to be sorted. User selected pictures can be introduced by dragging them directly into the sorting interface or into a sorting folder. A user may directly maintain a text file list of image paths, using a database, cloud storage and retrieval system, or other such commonly practiced method. What is required, at the minimum level, is a valid and permanent link which defines the path to the image data. Optionally, copies of the image data are saved in a separate location of computer memory.

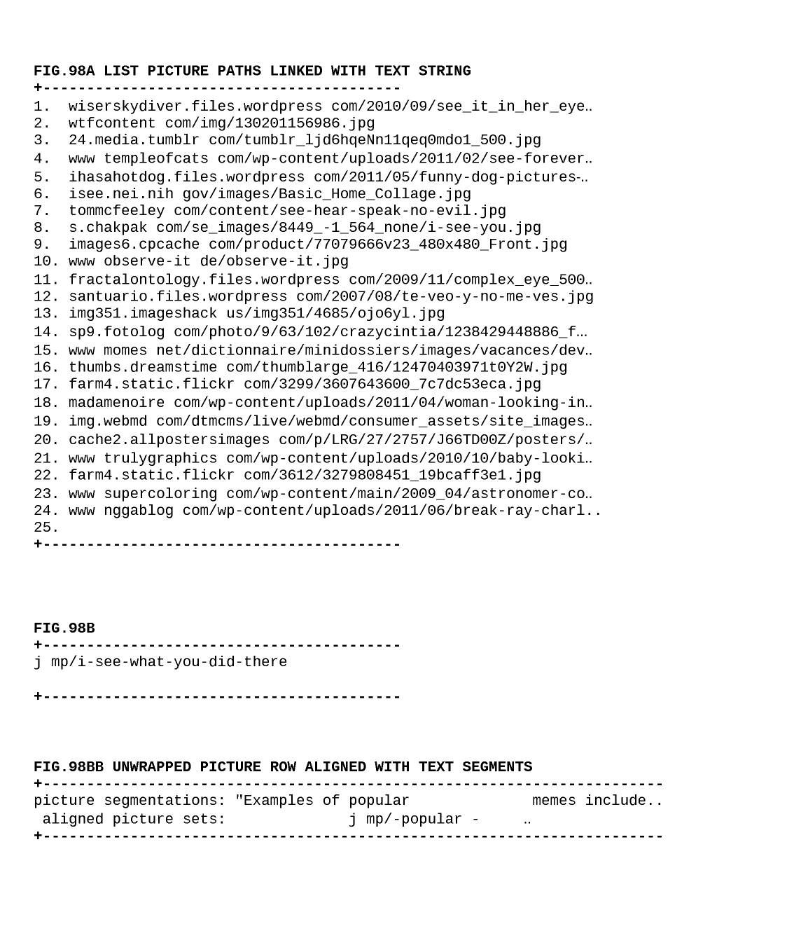

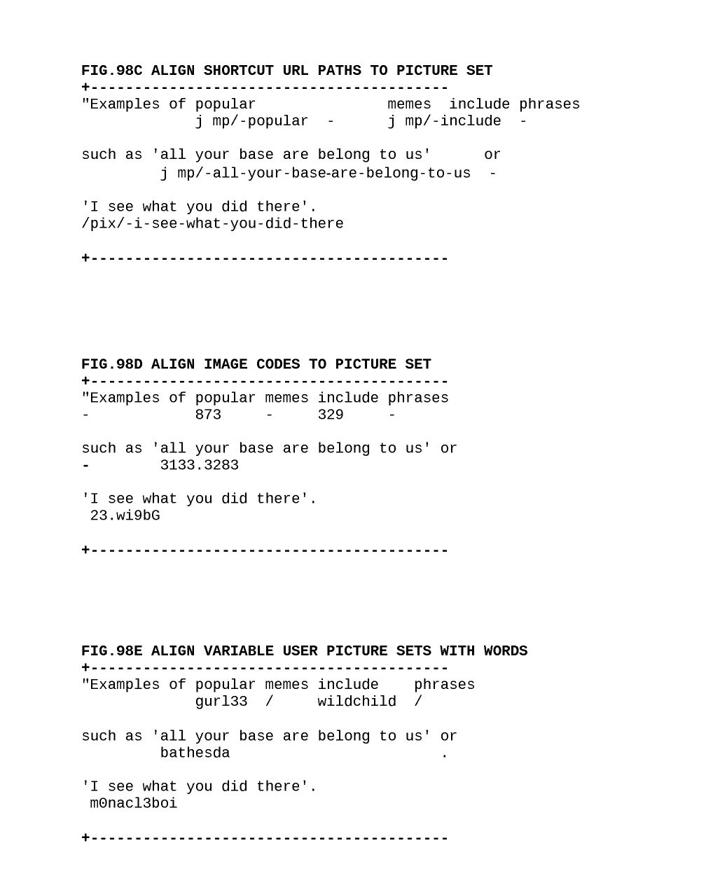

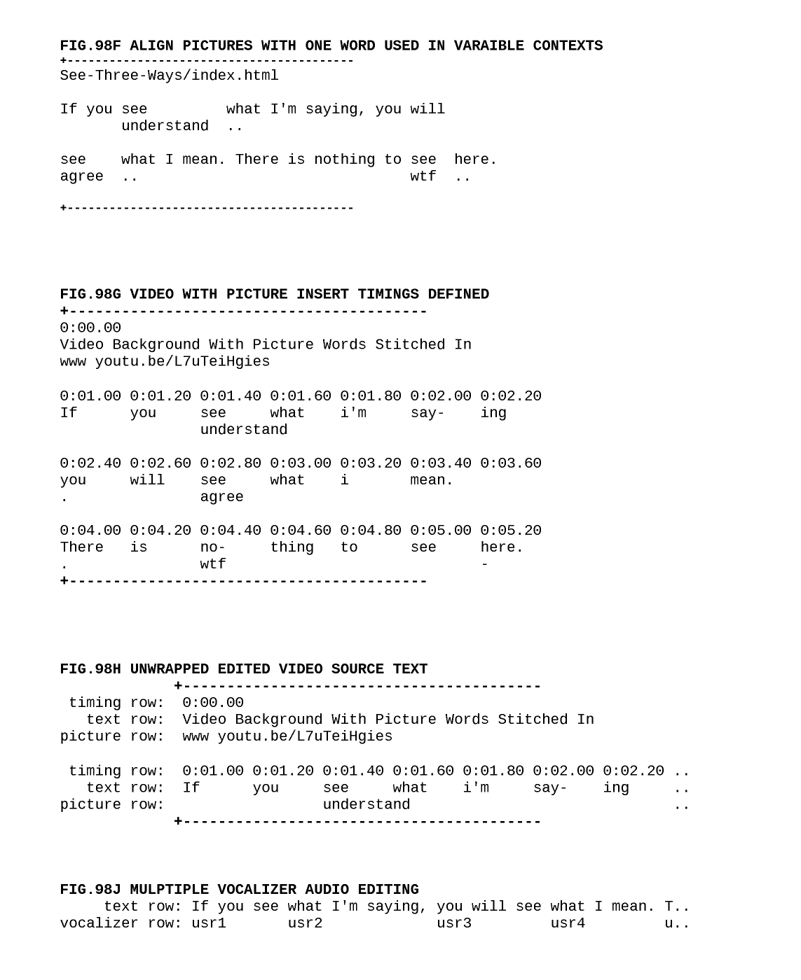

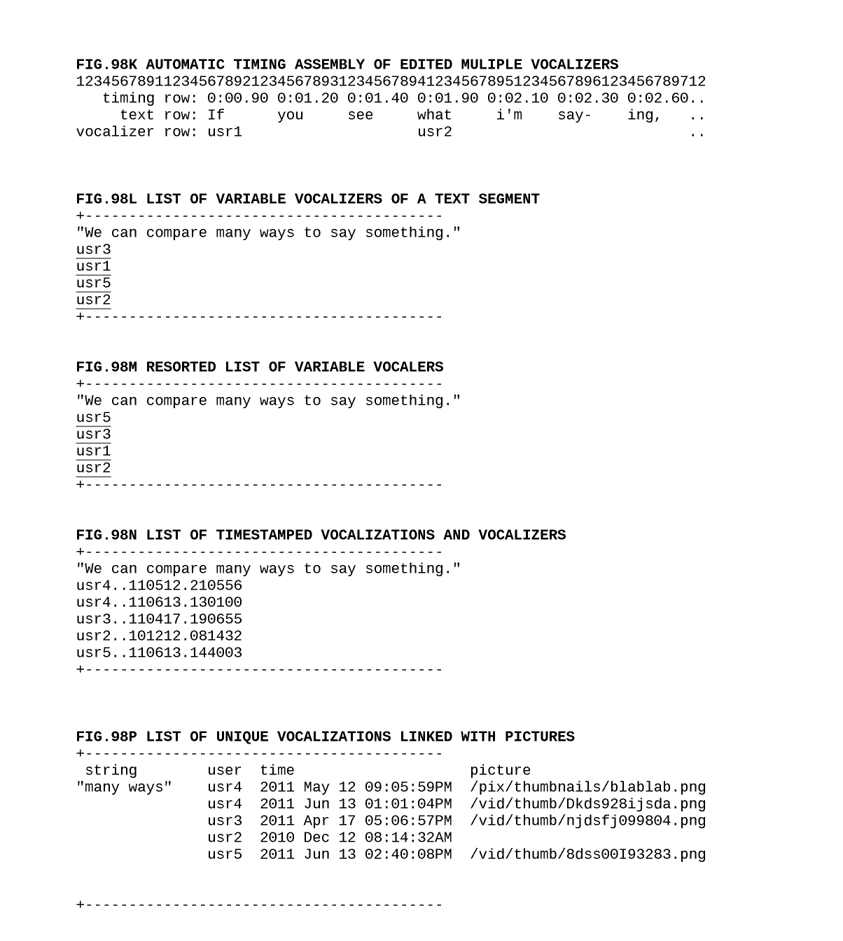

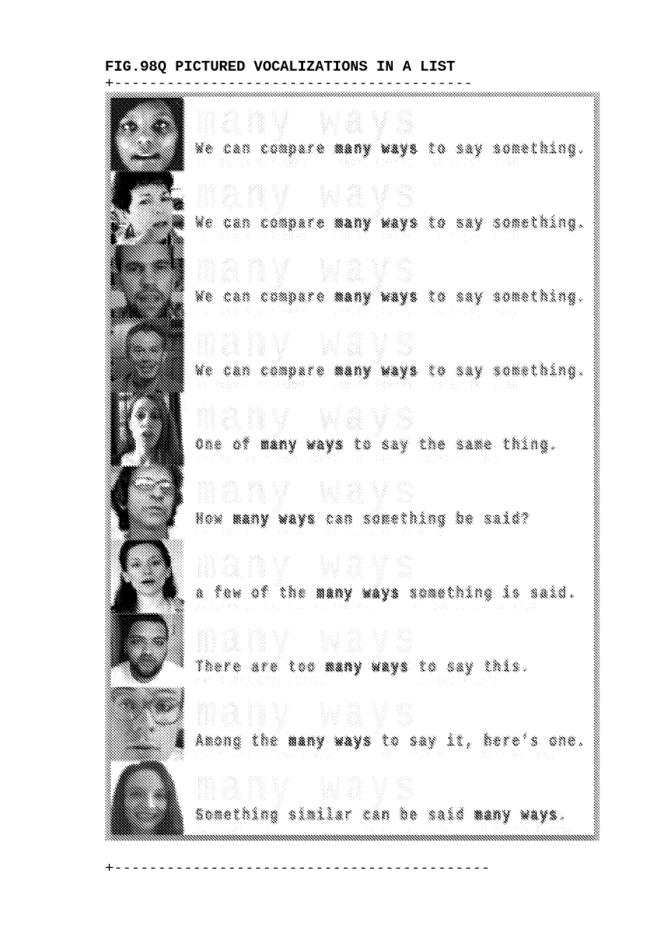

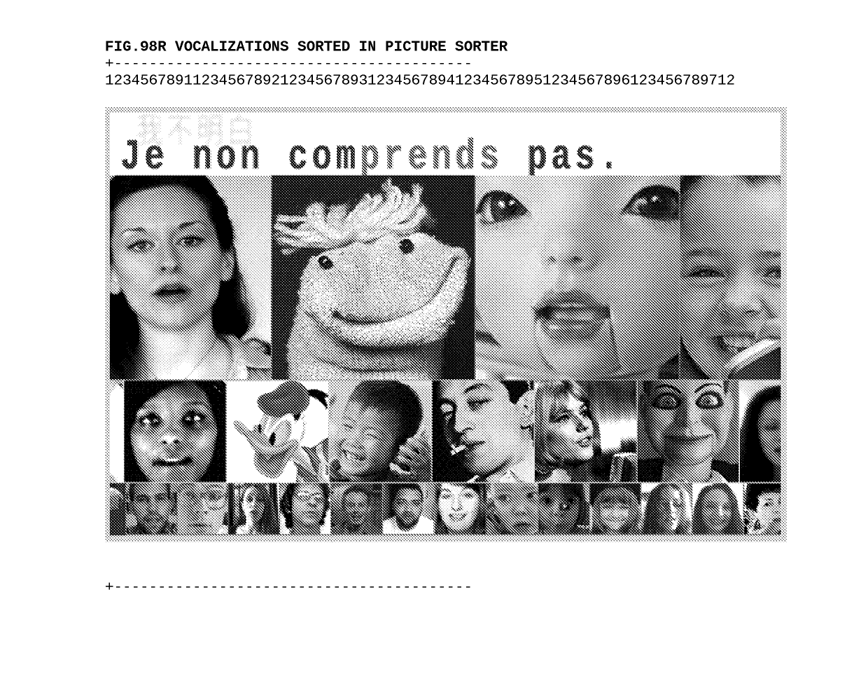

FIG. 98A represents a list of pictures. Within the figure there is representative list of paths to locations within computer memory where image data is stored. Using the path specified, the image data is accessed, retrieved and processed to form a digital reproduction the picture. As with thumbnail images, the paths are not the pictures themselves, but rather represent links to the actual picture.

FIG. 98A also represents a sorted list. Each item represented in the FIG. 98A list is explicitly numbered. The numbers serve to illustrate that each item on the list portrayed is presented after a carriage return or upon a unique line. In computer systems, the precise identification of the number of an item within a list of items is trivial to define. Thus, a list of hundreds or thousands of pictures is easily controlled on a computer.

Groups are defined within the sorted list. As each item in the FIG. 98A list is numbered, variable numbers are assigned to specific numbers in the list items to define how and where the present picture sorting tool should size and distribute the thumbnail representation of it. For example, a variable named “garbageLine”, for example, may be defined in one instance at line or list item number 18, while in another instance at list item or line number 22. Similarly, in the carousel controlled view, the list of preferred pictures which are to be represented in the top carousel with the largest thumbnails may be identified by a variable named “topLine” or some other name. The value of this topLine variable in one instance may be 3 or 4, and in another instance 20 or 30. Thus, within the program, variables are defined for each set of pictures managed.

Sets of pictures within defined groups are controlled by the program. In the linear sorting method, one border is required. The garbageLine variable defines the boundary between the visible list of pictures, and the pictures held in the garbage collection area described above. In the carousel method, two additional border variables are used: one boundary separates the top carousel contents from the middle carousel contents, while another boundary separates the middle carousel contents from the lower carousel contents.

Intelligent agents sort the list. Ranking the pictures in order, however, requires intelligent evaluation and then application of sorting actions. While a human could manage the order of the list of links represented in FIG. 98A using the plain text form shown, it requires far less thought and effort to manage thumbnails representations of the images, as specified within the preferred embodiments of the present invention.

Versions of sorted lists are saved. Whether using sophisticated database technologies, or simple accessible plain text files, variable versions of picture lists are easily saved in computer memory and accessed using specific addresses or paths. Previously defined sets of pictures may optionally be saved apart from the most recent version. Variable versions of picture sets also enable a unique arrangement of pictures to be associated with a common text segments used in a unique context.

Versions of pictures sets are associated with language used in a specific context. While words can be generically illustrated with sets of pictures, the present method also allows a picture or sets of pictures to be aligned with a specific use of language, and aligned with a segment of text or vocal text. Thus, where there is an unspoken reference or innuendo suggested in a text, and where a student of the language might not gather the intended meaning, a picture or a set of pictures can be used to align added context with the text segment, to thereby make the intended meaning of the language used more comprehensible.

Simple paths to saved versions of picture sets are defined. FIG. 98B shows a URL or Uniform Resource Locator. The text is used to access a link to information located on the Internet. The FIG. 98B example is a form of URL known as a “shortened” URL, which is provided by a service which is known as a “URL shortener”. The use of such a service allows a complex collection of information, such as the assembled picture sets described in this disclosure, to be easily accessed.

Paths to pictures sets are aligned with text segments. FIG. 98C shows shortened URLS aligned with text segments. The shortened URLS refer to links which are used to embed the hovering view of a picture or pictures; if the link is clicked, then a user can manipulate the order of the picture. Another form of URL is also included in FIG. 98C as an example. In the final link, the resource referred to is located on the server within a folder representatively named “ipix”.

Naming or numbering schemes for URL paths may optionally be applied. As the intention of the present invention is to facilitate the visual illustration of words in human language, and as there are a wide variety of human languages, a system of common numbers may be developed. The constant numbers can correspond to variable language expressions used to refer to a common visualization. For example, the word “see” in English corresponds with other words in English, such as “look”, “observe”, “eye”, and other such words. “Ver” in Spanish expresses the same concept, as does “voir” in French and “vedere” in Italian.

FIG. 98D shows variable numbers aligned with specific text segments. While a specifically defined numbering scheme is beyond the scope of the present disclosure, it is now known that specific numbers can be used to identify common concepts which can be visually described with variable pictures, and also verbally described with variable words in various languages. Such a numbering scheme is not exclusive. For example, the same set of pictures is accessed by the various text strings as well and the defined number. Variable arrangements of the pictures are defined by modifying the common number. For example, within FIG. 98D, the phrase “I see what you did there” is aligned with a number “23”, which is followed by a hash, or unique text string which is used to identify a specific assortment of pictures. The number “23” in this case would correspond to pictures describing “seeing” or “sight”, while the hash would locate an instance of the phrase with pictures defined by an individual user.

FIG. 98E shows variable user names aligned with specific text segments. User names are aligned with specific words within the separate alignment row used to control pictures. Specification of the user name in association with the text segment illustrated instructs the system to align a specific user's selection and assortment of images with the text segment. It may be noted that within FIG. 98C, an unnecessary repetition of the text string is shown: the text segment illustrated is repeated both within the segment itself, and also in the picture set linked. This redundancy is eliminated by using the text segment to identify the general picture set, and also specifying a user name to identify a unique assembly of pictures used to identify the specified string. Further, from the file name, the general surrounding context of the text segment used is known, as is the numbered instance of the string.

FIG. 98F shows variable words aligned with specific text segments. Controlled in the picture row, variable intended meanings of the same word used in variable contexts can be visually communicated. In the FIG. 98F example, the word “see” is used three times in the text row. Within the picture row, a separate word is aligned with each of the three separate instances of the word “see” used in the text. The separate words include “understand”, “agree” and “wtf”, each used to clarify the separate intended meanings communicated by the word “see”, as it is used in separate contexts. The sequential position of the varying usages of the word “see” are easily defined: the first instance of the word “see” is aligned with pictures describing the word “understand; the second instance of the word “see” is aligned with pictures describing the word “agree”; the third instance of the word “see” is aligned with pictures describing the word “wtf”.

The exact context of each instance is visualized in the FIG. 98E example. One word, “see”, is used three times. The pictures aligned with each instance of the word in use, however, are not the same pictures. This is explicitly made possible by aligning picture sets for related words, specified according to the context within which the original word was used. Implicitly, the program easily counts how many instances of the example word

FIG. 98G represents an existing video with timed pictures inserted within it. Within FIG. 98G, three aligned rows are shown which define timings, text and pictures. A shared video link located in the aligned picture row. The first row and line of text represents the timing row; the second line and row represents the text row. The third line and alignment row contains the video link. This ordered sequence of timing values, transcription text and aligned pictures continues upon subsequent lines. Thus, the video data is known, a specific title for the current edit example is known, and specific sets of pictures for words used in specific contexts are known. The video configured to play at all times when no other visual information. The video contents preferably contain a vocalization of the transcription example shown in the text row. The most preferred pictures and also the sortable picture sets are aligned with specific words, according to above specified methods.

Within the video, the timings of inserted pictures are precisely defined. The alignment of the picture word and the original text words end wherever a standardized symbol, such as a dash “-”, is included within the alignment line. For example, in the FIG. 98F illustration, the background video defined in the third line continues for 1.4 seconds, when a picture represented the word “understand” appears for one second. The timing start point in this example is aligned with the text row word “see” and the picture row word “understand” is 0:01.40. The timing end point in this example is 0:02.40, and is defined with the inclusion of a symbol, such as a dash “-”. Where the timing of the picture ends, the original video, which is defined in the third line of the FIG. 98F example, is resumed. The resumed original video continues until another picture or sortable picture set is inserted. In the FIG. 98F example, pictures which illustrate the word “agree” are aligned with the phrase “see what I mean.”, and for a period of time defined as 1.2 seconds. Again, the end point of the resumed picture is defined by a symbol such as the dash, which in this case appears aligned with the “0:04.00” or four second timing point.

Inserted pictures may include video segments. As previously specified, the term “pictures” is used in this description in a broad sense. As used herein, the word “pictures” intends to include charts, diagrams, maps, animations, animated gifs, movie clips, video segments, emoticons, cartoons, illustrations, artworks, drawings, collages, Photoshop illusions, screen captures and other such visually communicated information. Thus, a video segment from one source may be inserted for a defined time period within the reproduction of a video from another source.

Timing in points within publicly available videos is easily accessed. For example, within one popular online video sharing service known as YouTube, the URL of a video can be modified to access the timing in-point at which playback begins. This is achieved by adding timing specification, such as #t=0m30s to an existing URL for a shared video, such as youtube.com/watch?v=-RRIChEzzow, which results in the following timing in-point specific URL: youtube.com/watch?v=-RRIChEzzow#t=0m30s. Where timing in-point specifications more precisely, existing videos can be cued to occur precisely with vocalizations which are synchronous with segmented text. Nevertheless, with current publicly available technology, it is trivial to specify the exactly second at which the reproduction of a shared video begins.

Timing out points are defined by where picture words are aligned with the timing row. As described above, the duration of picture display is precisely defined. Also described above, the timing in-point for a separately referenced video can specifically defined. Thus, while the starting in-point of a video insert is specifically defined, the endpoint is implicitly defined. The inserted picture lasts until a new picture is inserted within the picture row, or until a symbol such a dash is inserted and used to define the timing endpoint.

Video is edited. An existing video is used as a foundation and timed audio soundtrack. This foundation video preferably includes a vocalization, which is transcribed in text and then aligned with times and contexts, in accordance with the present invention. Within this foundation video, segments of video or other pictures are inserted for precise periods of time. Where the inserted picture segment includes a vocalization of the synchronized text, the inserted audio preferably overrides the audio of the foundation video. Thus, as one of many possible examples, where there exist separate video recordings of people pronouncing the same words, a user can be introduced to multiple people pronouncing and vocalizing the same text.

Alignment of picture sets with text segments is controlled. As with the alignment of timing points with syllabic segments, and as with the alignment of context words with phrasal segments, and as with the alignment of structural codes with meaning segments, sets of pictures are now aligned with text segments as they are used in context.

An aligned vocalizer row is optionally controlled. Where separate users record separate vocalizations of a constant text, distinct parts of each vocalization are cut and reassembled in sequence with other parts of separate vocalization. Combined together, they form a whole vocal representation of the text. Where each separate vocalization is synchronized in time with text, the timing points of each segment selected from the separate vocalizations are known. This knowledge is applied by the program to automatically assemble perfectly timed vocal collages with minimal user effort.

FIG. 98J shows two rows: one text row and one vocalizer row. The text row contains the same sample text used in the previous two figures. As with all texts used in the figures, the example is representative of any text transcription of recorded language vocalization. The vocalizer row contains representations of user names, which are aligned with segments of text. As separate user names are aligned with separate text segments, the program defines the exact timing of each user's separate vocalized segment, then assembles an audio track containing the various vocalizations. The user who edits the assembly of vocalization parts is not required to manage the timings, as they are defined.

FIG. 98K shows three rows: one vocalizer row, one text row and one timing row. Comparison of the timing points defined in FIG. 98K with the timing points defined in FIG. 98G and FIG. 98H reveals within the FIG. 98K timings the vocalization starts earlier, and also slows to a slower rate of speed in the segment “what I′m saying”. As with FIG. 98J, FIG. 98K has a visible vocalizer row defined, and a separate user vocalizing the text at the beginning of the same segment “what I′m saying”. What is represented in FIG. 98K is the automatic assembly of precisely timed synchronous vocal text which is vocalized not only by one but many separate users. Where the source vocalizations sampled are synchronized with timing points, a human user can variably combine them simply by controlling a vocalizer row as show in FIG. 98J.

Audio is edited. Where an assembled vocalization described in the three paragraphs above is generated, the assembled vocalization and resulting audio track is used as the soundtrack for a series of pictures, including motion pictures, to be defined within the separate picture row, which is described above and illustrated in FIG. 98BB, FIG. 98C, FIG. 98D, FIG. 98E ,FIG. 98F , FIG. G and FIG. 98J.

Vocalization of texts are produced and managed. The system is used to transcribe and precisely time text segments synchronously with recorded audio vocalizations. The system is also used to produce and manage multiple recorded vocalizations of a constant text.

Multiple vocalizations smaller text segments are readily available. Syllables, words, phrases and other such parts of language captured in text segments of relatively short length are easily found now. Where any database with timed text and audio are connected to the system, timed text segments synchronous to audio vocalization are known. Grepping or searching for a text string within the body of known timed text data allows all instances of the text segment, timing points and also the synchronous audio segment to be found.

Multiple vocalizations longer texts are easily produced. Full sentences, paragraphs, choruses, full songs and stories are easily recorded by confident readers and speakers of a language. Readily available smart phones make the task of reading a text and recording a vocalization trivial. In a matter of minutes, a confident speaker can read a page of text and digitally record the pronunciation.

Existing vocalizations are easily revocalized. Commonly vocalized segments are typically repeated in a variety of vocalization contexts. Larger text segments, such as sentences, lyric lines and are easily vocalized and synchronized as described below. Revocalization of previously recorded segments and texts avails to learners variable vocalizations which are compared. The comparison of variable vocalization effectively helps a user to learn the language vocalized.

Multiple vocalizations are compared. FIG. 89L shows an example text segment located above 5 representative user names. The user names represent links to synchronous vocal text presentations of the example text segment specified in the first line. If played in sequence, a listener is presented with five repetitions of the segment variably rendered in variably timed synchronous vocal text.

Segments in compared vocalization are limited in size. For a beginning advanced language learner, the length of a vocalized segment is preferably shorter. Thus, the beginner regulates the volumetric rate of new information and thereby experience and understand the new sounds with less confusion. For an advanced language learners, segments are preferably of a longer length, containing a greater number of syllables and characters Thus, the advanced learner obtains new aural information at a challenging but not overwhelming pace. By regulating the general number of syllables in a segment, both beginners and advanced learners are better served.

Pauses between compared vocalizations are controlled. Segmentations are made in variable lengths, depending on a learner's level, as explained above. A vocalization or list of vocalizations may be looped or repeated. Between the reproductions of each vocalization, a pause is optionally inserted. The length of the pause is optionally controlled. The default length of the pause is 120% of time used in the previously vocalized segment. Thus, a listener is provided with time required to mentally process the sound of the language vocalized. Importantly, the listener is also provided with time required to physical produce the language sounds heard by the listener.

Imitation of the vocalizations is supported. While merely listening to sounds in a new language is helpful to a learner, actual physical imitation of the sounds involves the learner in a very direct experience. Rather than merely listening to the sounds, the learner actively attempts to produce the sounds. The actual sounds of the language thus begin to resonate within the user's body. Mimicry and imitation is a vital practice for a language learner. Within the preferred embodiments of the present invention, mimicry is facilitated by providing a learner with an increasing supply of synchronous vocalizations, which can be gathered, experienced, compared, imitated and mimicked.

Any number of recorded vocalizations are compared with user imitated vocalization. Where only a single recording of synchronous vocal text is available or selected, and where a user imitates the selection, a comparison is made between vocalizations. Thus, the term “compared vocalization” is also interpreted to include a single instance of recorded vocalization synchronized with text; the comparison is achieved in the active practice of mimicry.

Comparison of novice and expert vocalizations is facilitated. While a learner is not required to record their imitations and mimicry of properly pronounced vocalizations, such a practice is usefully applied by a language learner. Where one experiences their own performance apart from the actual performance, details are studied and lessons are learned; future imitations are more informed. Recording of imitation is optionally shared. Thus, an increasing supply of vocalizations in text segments requires implementation of an essential feature: the sorting of variable vocalizations.

Vocalizations are sorted by vocalizer. “Vocalizer” is here used to signify the username who introduces the vocalization into the present system. FIG. 98L shows a text segment which forms a sentence with the words “we can compare many ways to say something.” Separately upon each line below there is a username, or the unique name of a user using the present system. The user names show are used as examples. The user names show represent links to vocalizations recordings and synchronous vocal texts of the text segment shown in the first line. FIG. 98M represents the same text segment and usernames linked as seen in FIG. 98L, however the sequential order of the usernames is different. For example the first user listed in FIG. 98L is “usr3”, while the first user listed in FIG. 98M is “usr5”. FIG. 98M represents the FIG. 98L list after it has been alternatively prioritized sorted.

Vocalizations are sorted by time. As the supply of known, recorded and vocally synchronous text segments increases, so does the likelihood of duplicate vocalization created by a single user. Thus, where a timestamp is saved as a required data attribute of the any saved vocalization, the conflicting vocalizations are differentiated. While a vocalizer may repeat a vocalization, it is not possible to repeat the vocalization at the same time. Thus, FIG. 98N represents a list similar to the FIG. 98L and FIG. 98M examples, but with an important difference: a timestamp has been added to each username. For example, in the first two user names listed, the user name is the same “usr4”, but the timestamp which follows the repeated username is different. The first timestamp in the list is “110512.210556”, while the second timestamp in the list is “110613.130100”. The timestamp formatting guidelines are not specified, and the timestamps are shown in a representative style of timestamp formatting. As with the immediately previous figures, the list items represent links to specific vocalizations of the text segment show on the first line. Thus, the system controls sorting of repeated vocalizations by the same user.

Vocalizations are sorted by context. Typically, a vocalized text segment is found within the context of a larger vocalized text segment. Syllables are found within words; words are found within phrases; phrases are found within lines or sentences. Full texts with multiple paragraphs or lyric lines contain a vast number of variably segmentable texts. Text surrounding a vocalized text segment can be used as context, as can metadata such as when the text was introduced, who has vocalized it, and other such metrics of context.

Pictures are associated with vocalizations. FIG. 98P represents an array of usernames, timestamps and pictures associated with a text segment. Where the vocalization is recorded by the user in video format, a single picture within the video is associated with the precise timing start point of the segment selected. Thus, where vocalizations are videotaped, a specific picture is easily found and is, by default, used as a visual representation of the vocalizer vocalizing the vocalization of the specific segment. Optionally, a user may customize the picture associated with a specific recorded vocalization.

Pictures are used to sort vocalizations. It is impractical to identify variable vocalizations by filename. For example, in common practice, digital pictures are rarely named individually. Typically they are “tagged” with text segments used to associate pictures with people, places and things. Rarely are the actual filenames manipulated. Similarly, it is impractical to create unique names for unique vocalizations. It is magnitudes of order easier to represent the unique data with a unique picture. As explained above, where the audio vocalization is accompanied by recorded video, a unique picture is by default associated with each synchronous segment of text.

Vocalizations represented by pictures are sorted in lists. FIG. 98Q represents a list of vocalizations, vocalizers, a brief text segment vocalized, and the variable context within which the text segment is vocalized. FIG. 98Q represents the result of a search query for known vocalizations of a specific text segment. The search query text string is repeated for every result displayed; multiple impressions of the text string are made. The representative example text segment query show in FIG. 98Q is the phrase “many ways”. Variable context words surrounding the segments searched are also presented; a quickly user sees the segment used in variable contexts. Each repeated text string which copies the search query text is equipped with a hyperlink, which access the data required to reproduce the vocalization and also, in a preferred embodiment of the present invention, synchronous vocal text which is precisely timed to appear in sync with the vocalization. The vocalization reproduction is configured to repeat the search query at least two or three times: once before the context sentence is reproduction, once while the context sentence is reproduced and optionally once after the context sentence is reproduced. Thus, a user experiences the word or phrase by itself, then again as used in an example context, and optionally then again after the context example is presented. FIG. 98Q shows ten visible links to synchronous vocal text presentations portraying separate speakers use the queried phrase in a variety of contexts. FIG. 98Q represents an unlimited number of pictured audio recordings within a list.

FIG. 98Q represents video recordings of many people saying the same words. The meanings of the same words may vary, depending on the variable words surrounding these same words, the intonations of voice, the gestures and facial expressions. However, and this is of paramount importance, the user experiences multiple speakers apply the words in various contexts. The user enters a textual phrase as a search query, and is delivered a list links to video records of people saying the phrase. In the ages before mass video recording and sharing, this was simply impossible. Now, as the body of synchronous vocal text data increases, instant access to vocalizations used in context is increasingly easy.

FIG. 98Q represents a sortable list. Each item in the list is easily moved up or down, according to user preference. Where the number of items within the lists grows to an unmanageable amount, the sorting interface described above and also represented in FIG. 98R is used to sort and organized the pictured synchronous vocal texts.

The disclosed sorting interface is used to organize vocalizations. Recorded vocalizations, preferably accompanied with synchronous timed text are associated with thumbnail pictures, and represented in tiered carousels. As described above, the tiered carousels are used to sort vocalizations in a preferred order of groups. The above described linear method of sorting the pictures, which link to specific recordings, may also be used to precisely define the linear, numeric sequence of the recording included.

The supply of repeated vocalizations is rapidly increasing. As computer, electronic and communications technologies deliver increasing processing powers to an increasing number of users at decreasing costs, more and more digitally recorded vocalizations are recorded in networked computer memory and thus available to synchronize with text. The process of synchronizing vocalization with variable segments of text will increasingly be automated.

The supply of vocalizations which express similar messages is rapidly increasing. FIG. 98Q includes same language restatements of a similar message. For a language learner, the experience of variable ways to say a similar message is very useful. Where the intention of the message is known, then attention is focused into the variable valid expressions which are used to convey the known message. Comparison of the variable expressions enables a learner to experience the grammatical structures directly, rather than analytically or theoretically.

Human and computer knowledge is applied. While current computing technology can store and access vast quantities of vocalization and synchronous text, and while current computing technology allows a human to gather and sort a list of the vocalizations which share a common text segment, current computing technology is unable to easily recognize the intended messages conveyed by the various contexts in which the text segment is used. Knowledgeable human language users, on the other hand, can with relative ease effectively interpret the intended meaning of a text segment as it used in context.

Knowledgeable agents sort vocalizations into groups of similar messages. Where humans can easily access and sort vocalizations, humans can assign variable vocalizations and expressions with common attributes, such as tags. For example, a message can be interpreted as an expression of agreement and approval. Computing systems record an increasing supply of vocalizations. Humans sort vocalizations. Useful messages are sorted. Entertaining expressions of useful messages are sorted. Responsive agents sort vocalizations into groups of entertaining expressions of messages. Engaging vocalizations of useful messages are sorted. Language instruction materials are typically boring. The Internet is more interested. Creative people on the Internet make language interesting. Emotion is involved. Pleasurable sensations are elicited. Language is joy, not drudgery.

The alignment of alternating vocalizations in a text is controlled. As with the alignment of timing points with syllabic segments, and as with the alignment of context words with phrasal segments, and as with the alignment of structural codes with meaning segments, and as with alignment of sets of pictures with visual text segments, variable vocalizations are now aligned with text segments as they are used in context.

Constant alignment is controlled. As with other form of aligned content disclosed, plain monospace text is used, textarea columns are counted, and the spaces between aligned texts are managed to insure that their alignment is maintained; sets of rows are wrapped in variable widths of page display, and horizontal scrolling of the textarea input is controlled.

Various aligned rows are optionally combined. Sets of pictures are used to illustrate words. Used in specific contexts or used generally, variable sets of pictures are associated with words. The words may optionally also be aligned with context segments. The words may optionally also be aligned with structural segments. The words may optionally also be syllabified and aligned with timing points. Views of various alignments are optionally combined, so that the words can be both analyzed and directly experienced.

Synchronous vocal text is optionally reproduced while a picture is viewed. While the word linked in FIG. 89A is “see”, the context in which the word is used is clearly defined in the sentence “I see what you did there”. Where synchronous vocal text definitions are aligned, reproduction of both the linked word, as seen in FIG. 89B, followed by the context sentence, as seen in FIG. 89C, is optionally arranged. When so arranged, a language learner who clicks upon a picture link can easily see what the word means, hear how it sounds, hear the word used in an example context while seeing each syllable respond to each vocal modulations.

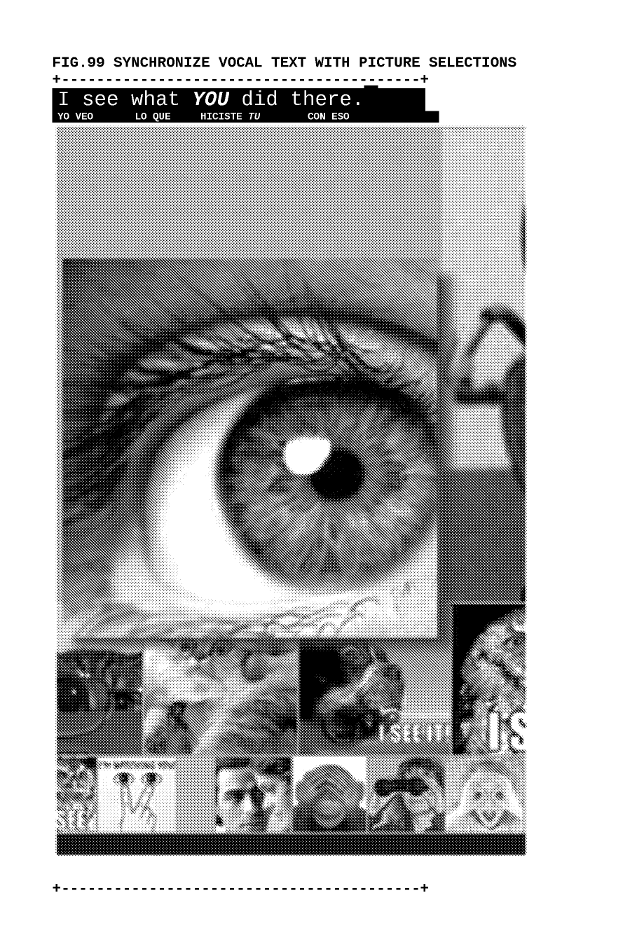

Synchronous vocal text reproduction is optionally made while a picture is sorted. FIG. 99 represents a set of pictures in the disclosed sorting interface, while one picture is being sorted. If preferred by a user, for every sorting action made by the user, synchronous vocal text of the linked word is reproduced, followed by synchronous vocal text reproduction of the context sentence “I see what you did there”. When so arranged, a language learner who sorts of set of pictures gathers repetitive experience with textual, audible and visual forms of the words and their meaning.

Volume of synchronous vocal text playback during picture sorts is controlled. When the user drags a picture up to thereby increase its relevance in association with a text string, the synchronous vocal text appears in larger scale and is heard with a louder volume of audio to enhance the emphasis. When a user drags a picture down the thereby decrease its relevance in association with a text string, the synchronous vocal text appears in a smaller scale with a more quiet volume of audio. When a user drags a picture into the garbage collection area, a negation is vocalized.

Synchronous vocal negations are controlled. For example, if a user is learning English, and if the text string being defined is “I see” and the user removes a picture from the assortment of pictures able to illustrate the words “I see”, then a simple negation, such as the word “not”, is vocalized. A variety of negations can be vocalized. Negations may include utterances such as “that's not it”, “nope”, “uh-uh”, “no way”, “wrong” and such. The negations are selected and vocalized by native speakers. The user can refer to a provided translation alignment to understand the synchronous text being vocalized. Thus, the user comprehends the meaning of the words, while repeated hearing the sounds and seeing the synchronous text, and while executing a meaningful action in association with the text and sound. Where an image is selected as an appropriate illustration of a text string being visually defined, the confirmation is invoked as described above. For example, if the string being visually defined is “I see”, and a picture is prioritized within the interface, a synchronous vocal text of the words “I see” is presented to the user.

Pictures are quickly sorted and prioritized. When executed in the context of language learning, the sorting process engages the learner in mental processing of the meaning represented by the language being visually defined. Where synchronous vocal text is reproduced during the sorting process, the meaning of the sounds and words is reinforced. Where the synchronous vocal text is provided in new language that a user wants to learn, the meaning in the pictures is associated with the sounds heard and text seen.

Pictures are validated by groups. Where multiple users prioritize the same picture or picture as an effective description of a text segment, records of agreement are made. With a sufficient amount of recorded agreements, valid associations between text segments and pictures are found. The best pictures are found.

Pictures illustrate text segments. The methods described are applied by users to find preferred visual illustrations used to visually define segments of text. Pictures may also include video illustrations of how to pronounce text segments. Sorting pictures has other uses in the context of this disclosure.

Vocalizations are represented in pictures. Pictures can be used to symbolize specific vocalizations. For example, a thumbnail image produced from a frame of video recording where a vocalization begins may be used. Alternatively, a user may represent a vocalization with any image the user likes. Where multiple users agree to the image representing the vocalization, a common agreement is made.

Vocalizers are represented in pictures. Pictures of users can be sorted using the picture sorting interface. One user may choose to represent themselves with one picture, while another user may choose to replace that picture with a separate picture. The process of selecting pictures is effectively controlled using the presently defined picture sorting interface. As users apply the methods to learn each other's language, friendships are made; pictures are used to represent friends.

Performers and authors of texts are represented in pictures. For example, related text segments such as “poètes français” and “French poets” are associated with portraits of French poets contained within the picture sorting interface. One user may prefer Balzac, while another user may prefer Baudelaire. As users sort pictures, their individual preferences are defined, while agreement among multiple users forms records of commonly held opinion.

Sorting pictures is not restricted to language learning. The method of sorting pictures is widely applicable in many contexts other than language learning. Pictures can represent things personally people care about, such as family and friends, or celebrated persons which a person cares about. Such portrait pictures can be sorted into sets of pictures defined by the personal preference of an individual user.

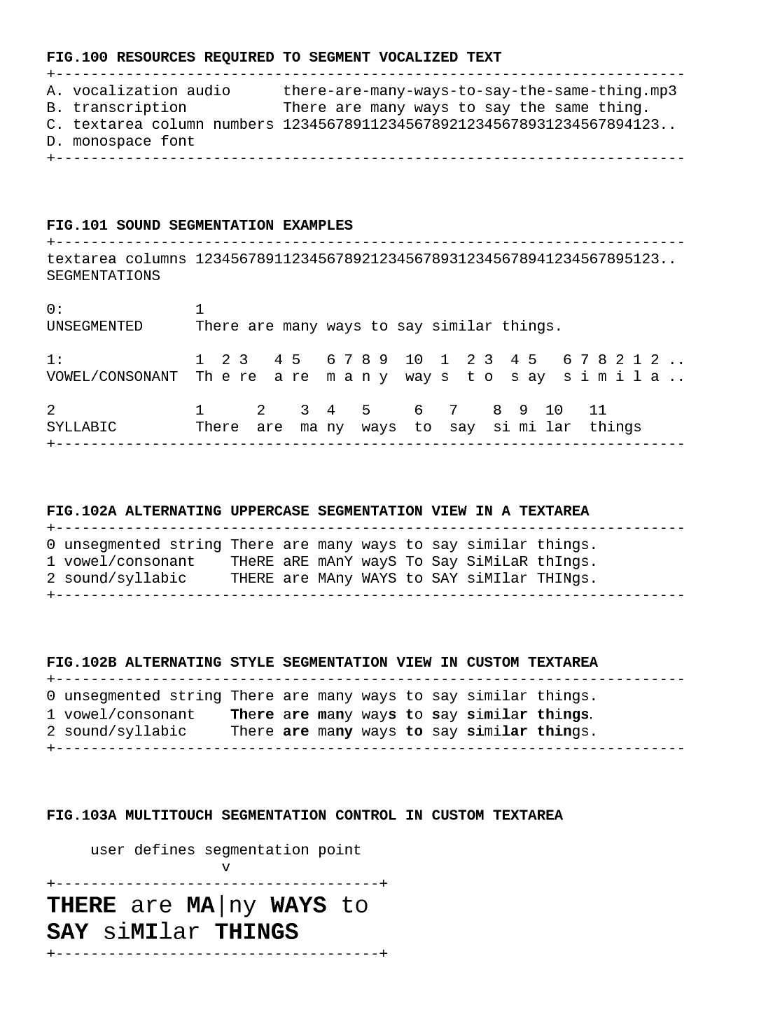

FIG. 100 shows the minimum resources needed to synchronize plain text with audio vocalization, in accordance with the present method. A recorded vocalization is required. A transcription of the vocalization is required. Knowledge of the textarea column numbers is required, so the segments of text may be aligned with other text segments. The use of a monospace font is required, so that the alignment of text segments is precisely predictable.

Multiple segmentations of a constant text are controlled. Separate segmentations can be arranged for auditory vowel/consonant sets and auditory syllabic sets; precise timing definitions for any character of vocalized text are made by applying the present method. Upon separate rows, chunk translations in various languages, same language restatements, comments or other context words are aligned. Question and grammar classifications are aligned on separate rows, as are pictures, vocalizers, stressed syllables and precise parts of speech alignments. Each separately aligned row can be separately aligned with specific syllables in the original text. Multiple alignments are controlled in a single source text.

A textarea is provided. Monospace text is controlled within the textarea. Textarea column numbers are applied to find alignment row segments which aligned with the timed sound segments. Text input into textarea may be controlled simply, without added segmentation controls. FIG. 101 represents two forms of sound segmentations controlled simply in the textarea.

Alignment segments are separated by two spaces or more spaces; transcription segments may be separated by one empty space. The representation in FIG. 101 includes pre-syllabic or “vowel/consonant” sound segmentations and syllabic sound segmentations. In both cases, words are separated by more than one space, while segments within words are separated by a single space. Using spaces instead of special characters simplifies the user's control of the segmentations in multiple input environments, including mobile smart phone use cases.

The amount of text input may be large or small. A single line of text, such as a pithy saying may be used; multiple paragraphs maybe used; lyrics with multiple refrains and choruses may be used.

Initial segmentation is based in sound. FIG. 104B shows syllabic segments aligned with timing definitions. As described within the present disclosure, the timings and segments are presented in a horizontal sequence which, in comparison to know caption formats, facilitates control of syllabic timing points and alignments. Timing points are represented upon one plain text row, while syllabic segments are placed upon an adjacent plain text row. The number of empty spaces between syllabic segments is controlled to align the syllables with the timing points. Upon this base of aligned segmentations, more rows may optionally be included and aligned independently with variable segments of the original text transcription.

Context and other data is then aligned. As described below, a user can optionally include and exclude rows from view. Multiple alignments are controlled from within the variable views. Multiple segmentations within the original text transcription are aligned. Independent alignments with the transcription are made within each alignment row. Multiple rows are aligned using plain text. RowSet wrapping is controlled, so that the segmentations and alignments are controlled in common textareas. Before aligning any of these variable rows and segmentations, however, the foundation alignments are defined between timing points and syllables.

Timed segments are viewed. In a common textarea, the user can select parts of a timing row and apply commands to quickly adjust the timings. Optional sonorous segmentations may be viewed and controlled. As shown in FIG. 104A, pre-syllabic segments may optionally be viewed. Pre-syllabic timings are estimated from syllabic timings as described in this disclosure. As desired by users, corrections are made. Pre-syllabic or “consonant/vowel” segmentation is useful for absolute beginners to isolate the most basic sounds in a text. The preferred method to control alignments of context and other information is segmentation is syllabic sounds, as illustrated in FIG. 104B. After timing errors are corrected and verified timings are defined, additional rows may optionally be viewed; contents on each of the rows can be aligned with the syllables, words, chunks, phrases and sentences.

Aligned context rows are optionally viewed. FIG. 105 shows an example of a single row of information aligned with specific segmentations of the original text. The row included in the examples is the “picture” row. The information aligned is representative and contemplated: two periods may be used to exclude the association of any picture with a segment; two periods in the picture row are aligned with the phrase “there are”; commonly used words may be represented in a numeric code, to thus easily apply common pictures to multiple languages. In the example, the number “6.29” in the picture row is aligned with the text row phrase “many ways”. Two dashes may be used to refer to a default picture, for example a template video of a vocalizer saying the original text; in the example, two dashes in the picture row are aligned with the original text phrase “to say”. The final text string in the example, “similar things”, is aligned with a user name, to refer to a particular user's assortment of pictures associated with the text string. Various methods may be used to associate pictures with information in the picture row. What is clearly illustrated in FIG. 105 is the method to align segments in an alignment row with a clearly defined set of segments in the original text.

The user includes and excludes rows from view. Methods applying a single key to toggle through views or menu controls with links to views are known in the art. As one of many possible examples, links to various alignment rows may optionally be provided. FIG. 104A, FIG. 104B, FIG. 105, FIG. 106, and FIG. 107 each show a representative list of links to alignment rows. The links are used to view specific rows or hide specific rows from view. For example, FIG. 105 shows the “picture” link capitalized, to confirm that the picture row is currently being viewed and controlled.

Multiple context alignment rows can be controlled. In FIG. 106, three alignment rows are concurrently viewed: the “stress” row identifies individually stressed syllables; the question row represents a method to colorize segments of text according to classifications based in questions; the picture row aligns pictures with specific segments, as described above. It should be noted that each row in the example that segments in each separate alignment rows may be independently aligned with separate segments in the text transcription row. For example, the word “to” in the text transcription row is aligned with nothing in the stress row, “do?” in the question row, and “—” in the picture row.

Multiple segmentations are additionally defined in the transcription. Where at least two empty spaces separate text strings in an alignment row, a segmentation is defined; where the beginning of such a segment aligns with a syllable in the transcription row, a segmentation of the transcription row is defined. The aligned segmentations may be controlled as multidimensional arrays. For example, the phrase used in the illustration, “there are many ways to say similar things” has eleven (11) syllables. Syllable numbers 3, 5, 7 and 8 are aligned with stress row information; syllable numbers 1, 6 and 8 are aligned with question row information; syllable numbers 1, 3, 6 and 8 are aligned with picture information.

Independent alignments are made in each alignment row. FIG. 107 shows another example of independent row alignments with separate segments of transcription text. The FIG. 107 example excludes views of other alignments and includes a variety of rows named by the language of their contents. In the example, French and Spanish are included as “context” rows. English is also included, to enable same language restatements to be made. (It should be noted that multiple rows can be included for each language.) Of the 11 transcriptions syllables used in the illustration, the first is aligned with the first segment in each context row. Chunks of French numbers 1, 2, 3, and 4 are aligned with transcription text syllable numbers 1, 3, 6, 8; chunks of Spanish numbers 1, 2, 3 and 4 are aligned with syllable numbers 1, 5, 6, 8; chunks of English numbers 1, 2 and 3 are aligned with syllable numbers 1, 7 and 8.

Multiple rows are aligned using plain text. A user associates variable text transcription segments with variable rows of aligned information. Syllabic stress, parts of speech linguistic alignments, pictures including video segments, structures of form and meaning, and variable vocalizers are aligned with specific and independent segments of the transcription text. Chunks of translation in multiple languages are independently aligned with segments of the transcription text. While sophisticated graphical user interfaces may facilitate manipulation of the data, the present method is applied to control the segmentations and alignments functionally simply using a monospace font within a plain text file.

Wrapping of multiple rowSets is controlled. As specified within this disclosure, multiple methods are applied to control the presentation of the aligned segments and rows in a series of multiple lines. As specified in the algorithms, two or more rows within a defined rowSet are wrapped, returns which control the entire rowSet are applied, backspaces affecting an entire rowSet are applied. Thus, the aligned segments in few or many rows are controlled in the most common and basic text editing environments. The data is controlled in a common textarea. Where no additional graphical user interface is layered above the presently disclosed file format, the data is controlled in a common text area. Thus, with minimal intervention and user interface complexity, text is made comprehensible with chunk translations, restatements, form and meaning structures, stress points, parts of speech alignments and multiple vocalizations.

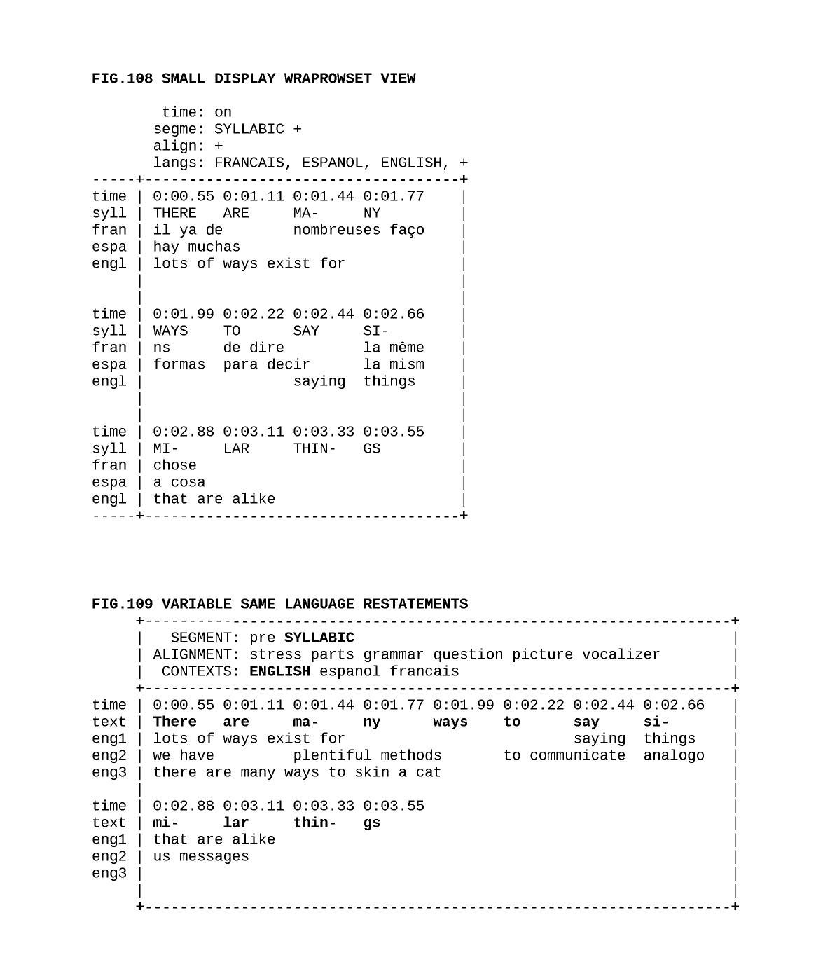

The textarea may be relatively small. FIG. 108 shows narrowly wrapped view of the rowSet contents seen in FIG. 107. The illustration demonstrates that the disclosed methods to control multiple rows with segments aligning independently with various transcription text segments can be applied within small display areas, such as the 320×480 pixels format commonly used on smart phones.

Smart phones on mobile devices can apply the methods. Segmentation controls, alignment controls, rowSet wrapping controls and other methods disclosed can be implemented using relatively large computers, such as laptops and workstations; the methods can also, in almost all cases, be effectively applied on smaller scale computers such as mobile devices.

Aligned context segments are listed in multilingual menus. FIG. 42 shows the previous example text introduced in FIG. 7, now styled to suppress the aligned context information and vocal text timing specifications. In FIG. 42, the aligned text and timing texts appear to be smaller than the original source text; further, they appear in a faintly colored grey style, in comparison with the normal black styling of the original source text. FIG. 42 is a representation which, like FIG. 40, serves to illustrate an example of how a customized text editing environment enables the appearance of each row to be distinguished, which makes it easier for a user to see the related rows continued in a sequential series. Where the information is easier to see and understand, it is easier to control and manipulate the contents of the rows. In accordance with the intention of the present invention, the steps a user is required to perform to control the information is minimized.

FIG. 42 also shows a drop down option menu activated in the final segment alignment, which within the original text contains the word “oratorically”, and is styled to appear in a special blue color, in contrast with the rest of the original text, which is styled with a black color. The context alignment, in this case synonymous words expressed in the same language, the selected item in the option menu is shown in red, while optional translations are shown in grey. If the provided translations and/or synonyms do not contain the desired text string, a user can enter the suggested text.

Graphical user interface enhancements, such as including and making accessible lists of possible synonyms and/or translations for a segment in a drop down option menu format, enable application of the invention on smaller computers, such as mobile cellular smart phones. Coupled with the modular sliding graphical segment timing units represented in FIG. 12, both the aligned context data for larger segments as well as the timing data for smaller segments are controlled manually using the touch interface and the smaller screen.

Multitouch segmentation control also serves in chunk translations. When viewing chunk translations, aligned same language restatements or other aligned contexts, the multitouch segmentation controls are also highly applicable when adapted and implemented to control segmentations of an original text transcription. FIG. 103M represents a text with context words aligned. As can be seen by counting the aligned segments, there are three phrasal segmentations in the original text. The final chunk segment in the text is “similar things”; the aligned context is “things that are alike”. A cursor position is defined between the words “similar” and “things”.

Chunks are divided from a central cursor position. FIG. 103N shows the 103M representation after the “similar things” chunk has been further segmented into two chunks: “similar” and “things”. User input required to achieve the segmentation is minimal: the cursor position is established and two opposing fingers on either side of the cursor are drawn away. FIG. 104N shows now shows four segmentations in the original text, and four aligned segments. The newly separated segment “similar” is now aligned with “alike” while the segment “things” is aligned with “stuff”. New translations are fetched according to the newly defined text chunking or segmentations.

Two input points squeezed together join separated chunks. Modification of the multitouch segmentation method is required to effectively join previously separated segments. As seen in FIG. 103Q, there are three separate text segments aligned with contexts. One finger or thumb is placed upon a word, such as the first word “There”, while another finger or thumb is placed upon another word, such as the last word “things”. The entire string between the two selected words is selected. As seen in FIG. 103R, after the fingers are squeezed together, the segmentations between the selected strings are removed. The selected and desegmented string now shows a single translation, which is fetched from an online source or produced upon the client.

Chunks translations are more dynamic. The controls specified in the present invention allow more dynamic performance of chunk translations. As described above, segmentation controls allow a user to select variable segmentations. While alternative segmentation translations may be fetched, they can also be included with a source text. Multiple segmentations in the source text are defined by target segmentations and alignments. A text can be aligned with multiple chunk translations, to provide a user with plentiful context in both known and new language. FIG. 109 illustrates a method to align multiple same language contexts with varying segments and segmentations in an original source text.

Language learner are empowered with precisely defined information, in the form of variable and repeated vocalizations of constant syllables, morphemes and other such core linguistic blocks. There is no theory, abstraction, nor complex set of rules to remember when levering the present system to learn quickly: the learning happens with repeated experience of constant text variably segmented, assembled and vocalized within in a plurality of larger texts and contexts. In each instance of syllabically synchronized aural text, the sound of a syllable is precisely aligned and synchronized with the corresponding syllable or morpheme of text. Repeated experiences of the precise synchronizations in variable contexts removes doubt from the learner. The learner learns while experiencing the wanted feeling of confidence.

The experiences are not constructed in some abstract theory, which may at some later date be proven wrong and held to ridicule, but rather quite the opposite: they are simple visual and aural experiences which enter the mind through the eye and the ear. Due to the precision with which the present method is used to accurately time and synchronize visual syllables of text with vocal syllables of sound, the mind can more easily associate symbols and sounds; the timings of text and sound are precisely synchronous; their synchronism are repeatedly experienced quickly through reference to other instances where voice and text are synchronized in timing data.

The learning is based in experience. Little room is left for doubt; where before there may have been nagging doubts about the sounds of assembled syllables, for example by attempting to guess at a pronunciation by referring to textual clues, now easily available repeatable experiences of specific sounds synchronized with specific syllables create certainty. Freed from doubt about the sounds of language, the mind has more resources to attend to the meanings carried by the words.

The process of synchronizing vocalized text components is instructive. The above described process to synchronize syllables of text with corresponding vocalization in audio recording is by no means limited to experts in a language. Initial testing is confirming that a novice apprentice of a language gains enormous benefit from paying careful attention to nuanced sounds reproduced at a reduced rate of speed, while assigning timing in-points and out-points to slowly vocalized syllables. The problem of too much information too quickly is effectively mitigated in this process; the learner has sufficient time to mentally process the sounds while relating them to precise components of text. The process requires action from the learner and thus involves the learners to far greater degree than passive listening and observation.

The process of synchronizing vocalized text is considerably simplified. Where prior methods used to synchronize text with vocalization required direct manipulation of the timing numbers in text form, or were restricted to cumbersome single touch timings, the present methods allow text segments to be easily and precisely timed. The use of two fingers with common input mechanisms doubles the efficiency of text segment timing assignments. The efficient method allows the timing of syllabic segmentations, including accented syllables, while concurrently producing a vocalization recording live. Previously recorded vocalizations are optionally reproduced at variable rates of speed, allowing users with variable levels of skill in a language to synchronize vocal text at faster or slower rates.

The process of synchronizing text with vocalization requires full attention. Auditory, visual and kinesthetic attentions are equally engaged. A user listens carefully to the sounds of syllables modulating while reproduced at one of several variable rates of playback speed; the user controls two or more fingers to input timing assignments for each syllabic segment the user hears, while the user watches the text segments react instantly to the sounds the user hears and the physical input mechanisms the user commands. Increasing the rate of playback speed increases the challenge, while decreasing the playback speed enables easier production of accurate synchronization.

A previously synchronized text is easily synchronized again. To test the comprehension of a language learner, for example, a vocalization which is previously synchronized with text may be synchronized again. In this example, the language learner compares the results of their attempt at synchronization with a precise and validated model of accurate synchronization in that same vocalization and text.

Multiple synchronizations of the same recorded vocalization corrects errors. Where multiple synchronizations of a vocalization are synchronized, they are compared. With a sufficient number of synchronizations to compare, the average of each timing value is found. The resulting average results in a validated model of precise timings. Multiple synchronizations may optionally be produced, for example, in a separate context such as user authentication. While sophisticated software robots are unlikely to be configured to match the syllabic timing of a recorded vocalization, for a human the task is trivial.

Errors in repeated synchronizations are measured. With validated timings defined, an apprentice effort is easily compared with the accurate and objective synchronization. Each significant error is reported to the apprentice user and tallied to provide an overall score, which may range from 0% accuracy to 100% accuracy. Thus, the method is optionally applied to assess the skills of an apprentice language learner. Scenarios where such assessment is applied included classrooms in educational institutions and schools.

Synchronization of vocalization with text segments is made into a game. Skill is required to synchronously tap while syllables are vocalized. Errors while timing are made visible immediately, for example by showing the incorrectly timed segments in a red color, while showing the correctly timed segments in a green color. Thus, a user is provided with instant feedback regarding there performance. A user of the game practices with a selected text at slower rates of playback speed, to develop confident control of synchronous syllabic timing. At faster and normal playback speeds, the game is more challenging.

A language apprentice effectively synchronizes new vocalizations. When an apprentice user masters the simple skill of using two or more fingers to tap in sync with the rhythm of language parts, the apprentice can apply the skill to produce entirely new synchronizations. Where a transcription is known and a vocalization of the transcription is known, a language apprentice does not require a pre-existing synchronization. For example, if the apprentice is learning English and likes the music of The Rolling Stones, and likes their song “She's a Rainbow”, but cannot find an existing example of a recorded performance of the song which has audio vocalizations synchronized with segmented syllabic text, the apprentice can easily locate a copy of the lyrics, segment the syllabic text parts and synchronize them with the recording, especially while the recording is reproduced at a reduced playback speed.

Learners apply the methods to create new learning products. In the past, language learning methods have been generally packaged, dictated and/or prescribed by teaching authorities. Learners are expected to meaningfully engage with pre-produced, “canned” products which attempt to be applicable to everyone. Now, in accordance with the preferred embodiments of the present invention, apprentice language learners are empowered to direct their own learning. As described above, new synchronizations of segmented texts are made independently by an apprentice. The result benefits not only the apprentice, but other apprentices who can then use and improve to product of the first apprentices efforts. In another example, where language instruction product formerly controlled a very limited set of pictures used to associate text segments with meaning, the present invention allows a user to independently control visualizations of the text segment. In this example, the visual symbols are uniquely tailored for the individual learner, and may then be effectively applied to learn yet another language. The learner is taking control of the learning.

Text is made comprehensible. Text segments are used as building block for meaningful audio and visual presentations. Existing audio visual presentations associated with a text segment are found and adjusted according to the current context within which the segment is used. The timings for each segment of vocal text are known. The timed segments are aligned with emphasis and stress guides, restatements, translations, parts of speech codes, formal grammar codes, meaningful question codes, variable vocalizers and pictures. The methods can be applied with any text to make it amply comprehensible, analytically, kinesthetically, visually and above all, aurally.

Language is experienced. The experiences remove doubt. Letters are seen repeatedly while sounds are heard. Words are seen repeatedly while vocalizations are heard. Phrases use words and letters repeatedly, while vocalizations are heard. Contextual meanings are aligned with words and phrases, so the intention of the vocalizations is better understood. Vocalization often non-verbal cues laden with meaning; hearing how a verbal message is expressed often communicates more meaning than the words used. Where visual contexts including facial expressions and gestures are included with audio visual presentation, the non-verbal cues and contexts are amplified. The language is experienced.

Doubt is reduced. Readers experience the sounds, pictures, meanings of language represented in written words. Repeated experience with meanings, words and vocalized sounds validate the associations made. Repeated experience with words recombined and used in various contexts constantly reconfirms the associations as valid. Repeated experience makes the words known, in sound and meaning, without doubt.

Methods described make new text meaningful to a language user. To be meaningful to the user, the text must first be made comprehensible. A computer is used to make new text comprehensible. The text is made comprehensible, to the greatest extent possible, through direct experience of the language. Direct experience is known directly through the senses and feelings experienced by a user. The knowledge learned directly in experience is applied to learn new language.

Segmentation of text allows variable parts of the language to be experienced. Methods to segment text and control text segmentations, both in common textareas and also in customized segmentation interfaces, are defined. User attention is focused on smaller parts of the new language being learned. Made comprehensible, the smaller parts are assembled into larger parts. Each level of assembly is controlled and directly experienced by the user.

Hearing and seeing words as they are used are direct experiences of language. Methods to synchronize language sounds with text are defined. The sounds represented by the text are heard synchronously while the text symbols are seen. Each variable segment of the text is heard vocalized, precisely while the corresponding segment within the text is seen actively animated; the form of the animated segment visibly changes from lowercase to uppercase format. The text syllables appear to dance in response to their synchronous vocalization.

Experience of the language is controlled by the user. Methods allow the user to select variable amounts speeds for “synchronous vocal text” reproduction. The user selects a limited part of the text to review. The user controls the speed of playback in the selected part. The user accesses and compares separate vocalizations of the selected part. The user sorts preferred vocalizations of the selected part. The user repeats synchronous vocalizations, as needed, to fully comprehend the sounds represented in the selected part of the text.

Vocalizing words while seeing and touching text is direct experience. The user applies her own voice to mimic the sounds of the text. Vocal muscles are trained and the language sounds resonate within the body; directly physical sensations are experienced. While recording the vocalization, the user touches and taps upon the tactile input mechanism, which actively animates the text segment being vocalized by the user. Multiple finger input enables rapid syllabic synchronization. Synchronous vocal text is produced live. The user compares her imitated synchronous vocal text recording with validated models.

Social feedback is direct experience. After practice hearing, seeing, comparing, saying, touching and synchronizing the selected text part, the user can share their own recorded synchronization with peers. To limit potential fear of rejection by peers, the user may digitally mask their voice. If video is recorded, the user may also digitally mask their face, as desired. While it is may be an unpleasant experience, rejection motivates the user to improve. The user earns basic approval from peers when peers comprehend what the user is says. With earned approval, the user experiences confidence.

Meaning, where possible, is directly experienced. While directly knowing the rhythms, sounds and text in the language is key to learning of new words, sounds alone are not useful unless truth is expressed with intended meaning. Methods are used to align comprehensible text segments with the less comprehensible text segments. As needed, the user refers to and aligned and comprehensible text segment to reduce doubt about the intended meaning of the original text segment. These aligned segments, and also the general context found in the original text is used to form an understanding of the meaning of the new text.

Translation segments are aligned. Within a single segment of text and translation, variable word order is made clearly visible. The user can see which parts of speech in an original source text segment correspond with parts of speech in the translation segment. Within the formatting source text, corresponding parts of speech are numbered, so they may be displayed and associated concurrently, even while not naturally aligned in linear sequence.

Restatement segments are aligned. With a separate segmentation of the text, restatements of phrases are aligned. The restatements are made in the same language as the original text, but using other words. The knowledgeable user clarifies the meaning by aligning restatements, while the apprentice user reading the restatements gains more immersion into the new language. The restatements are synchronized in vocal text, and made comprehensible with translation alignments.

Pictures are directly experienced. Methods to assort sets of pictures with text segments are defined. A sorting interface is defined, wherein multiple pictures are associated with multiple text segments. Pictures include motion pictures, video, charts and diagrams as well as photographs, drawings and paintings. The user can align specific assortments pictures with text segments for personal reference. The user can also experience commonly sorted and validated representations of text segments in pictures. Each experience sorting the pictures invokes synchronous vocal text reproduction of the word or words illustrated. The user experiences the selected language in text, vocalization, tactile sensation, translation, restatement and in pictures.

The language is also experienced analytically. Methods are provided to segment the text by metrics other than sound, pictures, touch, translation, restatement and speech. Codes are aligned with these separate segmentations and classifications. The classes are optionally viewed separately, together as a whole, or not at all. Colorization of the classes ranges from explicit through subtle to undetectable. The user controls views of variable analytic metrics.

Questions implied by the text meanings are analyzed. Segmentation and classification of text parts includes correlation with question words. Each assertion within a text answers an implicit question. The questions are classified, coded in color and aligned with separately defined segmentations of the text. The colors suggest which questions the text segment answers. The user controls the visibility of the classifications. Classes may be viewed together in full colors, viewed separately in single colors, or not viewed. Other classification metrics, segmentations, aligned codes and colors are applied as directed by the user.

Grammar structures used in the text are made visible. Grammatical segmentation and classification is applied. Grammatical codes are aligned with separate segmentations. The grammatical classes are color coded and aligned with separately defined and controlled segmentations of the text. The colors make grammatical forms, such as nouns, verbs and modifiers visible to the user. Grammar classes are viewed together in full colors, separately in single colors, or not at all.

Direct experience of the language is supported. Analytic methods listed above support direct experience of the language. Where a user has questions regarding the format structure of the language used, linguistic alignment and grammatical forms are defined. Where a user wants to comprehend the meanings in the text by applying questions to assertions in the, question classifications are made. Classes, codes and colors are definable by the user; segmentations are aligned using the present method.

Learning materials are produced. The methods allow users who know segments of language to make such segments more comprehensible and meaningful to users learning the language. Vocal explanations are produced live, while synchronized with text. Where multiple explanations exist, a means to sort preferred instances is provided.

Learners produce their own materials. Authentic texts are used. Apprentices of a language effectively synchronize recorded vocalizations with textual representations. Very slow playback rates enable the apprentice to hear the syllabic parts of the new language. The user sees the corresponding text segment and physically reacts by timing the synchronization. The process requires complete auditory, visual and kinesthetic involvement of the learner. Robust associations are forged between sound and text. Methods to correct apprentice errors are defined.

Questions are asked and answered. A learner can request from peers explanation of a non-comprehended text segment. Answers are provided with synchronous vocal text, pictures and analytic alignments. Questions and answers are recorded in network accessible computer memory. Previously answered questions are aligned with segments and accessed by the user.

Language is made comprehensible to learners. Text is variably segmented and aligned with timings which correspond to vocalizations. Separate segmentations are used to align assorted pictures. Contextual references, including translations and restatements, are aligned with separate segmentations. Structural classifications are aligned separate segmentations. Questions and answers are aligned with separate segments. Segmentations and alignments are controlled using the present methods.

The system is used to learn language. Sounds which form vocalizations are related to text and meanings. Repeated experiences with related sounds, sights and meanings form and reinforce mental associations between vocalizations, texts and intended meanings. Comparison of constant words used in variable contexts tests and confirms the validity of believed associations which relate sounds, sights and meanings. Validation of the believed associations is made in commonly held agreements between language users. Habitual expectations form, which are used to accurately predict sounds and meanings of language represented in text. Through use of the system, language is experienced and known.

Humans and machines can both use the system to learn language. Simplified control of synchronous timing points in text and vocalization, in accordance with the various embodiments of the present invention, enables knowledgeable human language users to correct errors produced by novice machines or novice language users. Thus, both forms of novice can use the present apparatus and method to get more accurate synchronous timing information, and thereby learn to define synchronous timing points more accurately in the future.

The method and apparatus form a system to serve language learners. Easily and precisely synchronized segments of text and vocalization, in accordance with the preferred embodiments of the present invention, enable quick knowledge transfer between humans and machines. Individual machines can adapt to serve individual humans with specialized sets of language information, in symbiosis with individual humans using the system to inform machines as to specifically which languages and language components the human knows, wants to learn and is prepared to learn.

While potential future uses may vary, synchronous vocal text is useful now. In accordance with the preferred embodiments of the present invention, language learners can now easily view precisely timed segments of text synchronized with audio vocalization in a plurality of presentations, including plain text presentations with existing captioning systems. Full page HTML assemblies and outputs are provided. Control of synchronous timing points is applied within a simplified file and data format, manipulated in both in common textarea inputs and with a graphical user interface. Human knowledge defined in easily controlled and corrected synchronous timing definitions is stored as data and made available to machines for automatic vocal language interpretations and productions. Any recorded vocalization of human language can be synchronized in vocal text. Variable vocalizations of the same text can easily be made, accessed, compared, imitated and used by language learners. Novice language learners can initiate and participate in the productions of synchronous vocal texts. Authentic materials are made more comprehensible. Language is made easier to experience, know, learn and use. The system in accordance with in the present invention can be, used to produce language learning.

In conclusion, what is described here is a system and method to make vocalization more comprehensible to language learners; to precisely synchronize segments of text with corresponding segments of vocalization in recorded audio; to experience the synchronizations repeated in variable contexts, including existing caption systems and full page HTML presentations; to control synchronization playback speeds to enhance comprehension of quickly modulating vocalizations; to align contextual segments which communicate meanings intended by the words, in accordance with the U.S. Pat. No. 6,438,515 and US-2011-0097693-A1 disclosures; to simply control, correct and validate precisely synchronous segment timing points with a specified file format and graphical user interface; to transfer human knowledge to mechanical language interpretation and production systems; to improve automatic production of synchronous vocal text; and to synchronize vocal text for language learners.

What is claimed is:

1. A text aligning system to align segments of one or more text contexts with corresponding segments of a text, to provide a reader with ample experiences and definitions of the text segments, the system comprising:
a computer text editing environment which, within a single text input area, enables the control of numbers or text in one or more human languages, while also allowing inclusion of one or more empty spaces between words or numbers;
a text which is segmented into word parts, single words, phrases of multiple words, or sentences, wherein the text may include language that is unknown to a person reading the text;
a number of context texts, each of which is segmented into word parts, single words, phrases, sentences, classifications, timing numbers, or links to images, and where each context text segment corresponds to an associated text segment;
a single combined text containing a select number of segmented context texts, and also the correspondingly segmented text;
a computer program to gather both text and context text inputs, then output context text segments in alignment with text segments, while aligning consistently in one or more display formats, including at least one of a) directly editable text and bitext formats and b) captions synchronized with audio/visual formats;
whereby a person can optionally access one or more context texts, each aligned with corresponding segmentations in the text, so the person can read translations or restatements of the text, identify structures within the text, define synchronous timings for segments of text, touch phonetic segments while hearing their vocalization, hear vocalization segments while seeing synchronous phonetic segmentations in the text, or see images which visually depict select segments of the text, and so experience, know and learn new language found in the text.
